SEQUENCE LISTING (82 sequences)

SEQ ID NO: 1 - protein, 145 aa, Kocuria halotolerans
MDIRLENVGIAVRDLEAAIAFFTDLGLAVLGRDTVSGEWADTAVGLDGNHARIAMLQTPDGTGRLELFEYLHPEAIETEPTLPNEIGMHRVAFAVEDLDAALEIAAKHGCRPLRGVATYQDVYRLTYLRGPSGIIVMLAEELKKG

SEQ ID NO: 2 - protein, 186 aa, Kocuria halotolerans
MSRHPIADDAAPSAGIPGLRGSDHIGFTVPDMEEAHDFLIRVLGCVHVYTLGPYPTGAEIAARLDIGQDALMEQIRFYRCRTGVNFEVFQYADPGQRADPPRNSDIGGHHVAFYVDDLDAAVLWLQENAVEVLAGPNLSSGPSEGQRWIYFRAPWGMYFELVSFPGGKAYEREAGTLLWDCRTPQD

SEQ ID NO: 3 - protein, 464 aa, Kocuria halotolerans
MTRPMLLNAFDMLVPVHQSPGLWRHPESGVAGFDRLDYWVELAETLEEGGFASLFLADIPGIYDVYGGDGAATARGGVQYPLLDPLVVVPAMARATRTLGFGVTASVTYEQPYLLARTLSTLDHFTEGRVAWNIVTSYQDSAARNLGMSGQIPHDERYDRADEYMEVMYKLFEGSVDDDAVRADPEANVFVDPERVRPIEHEGRWFSVPGAALTHPGPQRTPLLFQAGASKRGQQFATDHAEAIFFSGGTPELVRGWVEGVRDSVEAAGRPRDAVKIFSLATVIVAETDDQAQRRLEEYRELVDTESALALFGGWTGVDLSGADPDSTLEYVATDANQSALASFTTLAGGRKWTVRDLAEFVAIGGRGPVIVGSPQTVADELERWQEEAGVDGFNVSAAVRPADLERFSRLVSPELRRRGLLPEADAVPAATLRERLTGSGPHLPAEHRGASYRRTSAVAAGRG

SEQ ID NO: 4 - protein, 324 aa, Kocuria halotolerans
MDLPLSLLDRSRTRAGSPDAQALRNTVERAEAAEEAGYSRFWVAEHHAVPGIASGSPPLLMQAVAQATRRIRVGSGGIMLPNHRPILVAEQLAVLTALHGPRFDLGVGRSLGFTRPVREALGALSARPEEFLADIRSLRDHLEGGAAVTVRPAGVPAPPIHVLGTGAGLRFAAELGLPAVVGGPALRGGPEPFERYRRDFRPSERFPEPHLIASADILVADSQAEADELALPEAWAMAEARSAGAFPPLVPPGRVPEDPGPRRRRTVEETLEGTIAGTEDRVLTELAELLERTGADEVMSTASTFDLDALRASDRRLAVAVRAA

SEQ ID NO: 5 - protein, 508 aa, Kocuria halotolerans
MPEHAAHSPETAPARTAARNGAAVRVRLNAFDMNCVGHQSPGLWRHPEDRSASYKDLGYWTGLAQTLERGLFDGIFIADVLGTYDVYGGSNEATLRAGTQVPVNDPLLLVSGMAAVTEHLGFGVTAGTAYEHPYSFARRLSTLDHATRGRLGWNIVTGYLPSAARNFGNADQLEHDERYEHAEDYLQVVYKLLEGSWEDDAVVRDAGSATFTDPSRVHEIDHRGEYFTVPGIHLCEPSPQRTPVLFQAGASKRGTRFAAENAECVFVASPNRTHLRETVTRLRDAVEAAGRPRDSIRVYTLLTVVTGPTDEAAHAKHRELQGYVDHEGALTLISGWMGLDLSGFDLDEPLGNVKSNAIHSAIETFQKVNEDGRPWTVRDIAEFVGIGGFGPRIVGSGESVARELVEWVEETGVDGFNLAYAITPGTFEDVVEYVVPELRRLGAYPEQYEEGTLRHKLFGAGDRLPEGHPGRVAGEAVRAAASAGAATDERREPAHAGAGAASGPGGRA

SEQ ID NO: 6 - protein, 377 aa, Kocuria halotolerans
MSALRFHWFLPTGGDSRGIVSGGHGAEVGFTAAGRPPELSYLRQVAQAAETNGFEAVLTPTGLWCQDSWLMTSALAQHTERLKFLVAFRPGSLTPTLGAQMAETFQNVTGGRLALNIVTGGESAEQRAFGDFLDKTGRYERTGEFLDILSRLWDGGDPFDYRGRHLSVEGAQLAHLPEPRPEIYFGGSSAPAGEVAARHSDVYLTWGEPPAQAREKIEWIRGLAAEQGRRPRFGIRLHTISRDTSAEAWAVAERLLRDVPEELIARQQSALAASESTGQRRMLDLHGGRTADLEIHPGLWAGVGLLRGGAGTSLVGSHEEVAALIEEYAEAGFEEFVLSGYPCLEEAYWFGEGVRPVLERKGLLGTRQDDALVPAAG

SEQ ID NO: 7 - protein, 334 aa, Kocuria halotolerans
VLPLSLIDFATVYQGETPRESFIRSVAMAQRAERLGFSRIWYAEHHNMPTISSAAPAVLISHIASQTESIRLGSGGVMLPNHSPLTVAEQFGTLAELYPGRIDLGLGRAPGTDMKTLQALRREPQDAERFPSDVVELQGYLRGASRIQGVEAIPGRNTDVPLYILGSSLFGAQLAAQLGLPYSFASHFAPAALEQAVTTYREHFQPSEQLSEPYVIAAVNVTAAEAKEEAEEQSAQVRKARVAAMIGRGRELSDAEVEMLMHSPAGQQVLEMLRYSAVGTGDEVRQYLERFAEKAKADELMISLQSPSTEESARSMEILADAWGLEASGDRSVS

SEQ ID NO: 8 - protein, 406 aa, Kocuria halotolerans
MNREHIMQIGIFSVGDVTQDPTDGTTPTEHERIKATVEIARKAEEIGLDVFAVGQHHNPPFATSSPTTTLAYIAAQTERIMLSTSTTLITTTDPVRIAEDYGMLQHLADGRTDLMLGRGNTGPVYPWFGKDIRQGVPLAIENYNLLHRLWHEEVVNWSGKFRTPLQSFTLSPQPMDGVAPFVWHGSIRTPEIAEQAAYYGDGFFHNNIFWNKEFTGQMIDLYRERYEHYGHGAADQAIVGLGGQFFMRRNAQEARREFRPYFDNAPVYGHGPTMEDFTDQTPLTVGSPQEVIEKTLSFREYAGDYQRQLFLVDHAGLPLKTVLEQLDLFGEEVLPTLRREFDAARPAHVPEAPTHASLVERRRAGADPVPGGREDSPAGEARRAERGSRAPGAEREHGTARTEDAR

SEQ ID NO: 9 - protein, 342 aa, Kocuria halotolerans
MHVSKKIGFLSFGHWTPHPTSSTQSASDALLQSIDLAVAAEEVGADGAYFRVHHFARQLGSPFPLLAAAGARTSRIEIGTGVVDMRYSNPLTFAEDAGAADLIAGGRLQLGISRGSPEQVIDGWRHFGFEPAEGESDADMARRHTETALEAISGRQFARPNPHPMFPNPPGLLRIEPHSEGLRRRIWWGAGSDATARWAAQRGMNLMSSTLKDDESGEPFHVQQRKQIEAFREEWARHEHGFEPRVSVSRSIFPIVSDLDRRYFLGSGERSDQVGYIDSTRSVFGRTYADEPEALVEQLRGDEAIQAADTLLLTVPNQLGVAYCASVMENFIRYIAPALGWR

SEQ ID NO: 10 - protein, 461 aa, Kocuria halotolerans
MTQQMRVFAFDFSGPAHLSAGLWRHRDDRGPQYTSIRYWVDYARMLEQACFDGIFFADNVGYHDVYRGSVADALKDAAQIPANDPAYAIPAMAAATTHLGFGVTSSTAYDQPYATARKFTTLDHLTDGRIGWNVVTSYSDSAAKNLGTGTQLAHDDRYGRAEEFLDVALKLWEGSWEDGAVRVDAESCTYVDPERVHEINHSGEHFDVPGIFLCEPSPQRTPVIFQAGGSSRGVALAARTAEAVFMNATSKAGLKKQVDNLRQQAAEAGRAPEHLAVLQMITVISAPTDREAQQKYEEYLKLVSYDGAMARYSGWAGLDMDTFDPDVPLKHVNTNAGQTMVDIFSKMDPTKEWTPRDIAEYIGLGGTAPVIVGGPETVADELQSWMDETGIDGFNVAHAVKYQDIKDFTEYVVPELQHRGLMRTRYEGRTLRENLFGQGQPRLPQDHPGAAYGHRTAIGTA

SEQ ID NO: 11 - protein, 346 aa, Kocuria halotolerans
MTENANTKTLGFFTRLLEEASPAERYRYALEQIDAAERLGFSSAWVAQHHFHEAEGGLPSPFVLLGAAAQRTRRIGLATGVITLPMEDPVRVAEDAAVLDAISGGRVQIGLGSGGNPNSFPAFGADFAERGPAFAAKLETLETLWRGEETAGGNRLYPAAPQLPGKLWQASFGTFGAGIAGSRGDGLMLSRTQPRRDSPEAALSEIQVPVVQAYLERLPEGAAPRIMASRTAIAVEASERAGLVRRTAQKLRQGEADRLVGRDTSGLGDEELLVATDTFLGTPEEIVERLSEDRVVTDHATLVAFQVHSAPVTHEETLRSLELLATEVAPRLGISTADDALAVSRG

SEQ ID NO: 12 - protein, 455 aa, Kocuria halotolerans
MSRDGHSPRSASPGARRSAPARKQARLNLFAYGCGHHKAAWRAPDSAVERLGEIEYYEELARTAERGLLDAVFLADGQSLDPPSLADSPGWFLEPITALSAMARATERIGLVSTVSSTFYTPYHAARLLGSLDHVSRGRAGWNVVTSMSDAEARNHGMPGMPPHERRYGRAAEFIEAVQALWSSWPRASLEADRGGRYVDPGRIRGVAHAGEHFRVAGPLNVPEPPQGRPVLFQAGASEQGRELAARYAEGVYAVAYDLEQGARYRRDVRRRVREAGRDPDDVVVMPGLVAYVASTEAEARRRQAELDALLPAEASLRQLGRFTGRDCSGWELDAPVPELAPLEEFTGPQGRYATILRIVASERPTVRQLLGRLAAGGGHCTMVGTPESIADRIEQWLDDGAADGFNLMPPTLPGGIEDFVEQVVPELQRRGRFRREYRGTTLREHLTGSPRVPV

SEQ ID NO: 13 - protein, 479 aa, Kocuria halotolerans
MTEKKRIAVNAFDMTCVGHQSFGLWRHPRSRATEYNTIEYWTGLARTLEKGLFDGLFLADVVGIYDVYRNSAAPALRDGAQVPVNDPFMQVSAMAAVTSHLGFGVTSAVTYEQPYTLARKYATLDHLTRGRVGFNVVTSYLPSAAENQGLPRQIEHDERYEIAEEFLDVTYKLWEGSWEDGAVREDREAGVYADPSLIHPIGHRGRHFTVPGAGLTAPSPQRTPVIFQAGASSRGQAFAGRHAEAVFIGALRPDLTRSMTDAIRDRAEAEGRGREEVKIFAMLSVVVAETDEAARAKYEDYLSYADLESSQAIIGGWSGLDLSRFGEDEVLNYVKTDSIQSFLTPFTLQSEGKEWTRAEIARHCALGGMGDVVVGSPQTVADQLERWIDEGGLDGINLAYHVSPGSFEDFVEYVVPELQRRGRYRTQYEGSTFRENLFGAGRTRVSESHPAARYRGAFADGPSCAEAPARELQDDVAPR

SEQ ID NO: 14 - protein, 288 aa, Kocuria halotolerans
MSSTTETFEDRRREHDAVPATPPPGLPPEAAASSDAAADSQAQLSEEMERVQRGYEASGEREDGPRLDYAPYRSSVLRHPTKDPHHVDPELIELSSPAFGHRDVGDLESDLTIQGGGEPIGERIKVRGRILDSAGRPVRGQLVEVWQANAAGRYIHKRDQHPAPIDPNFTGVGRCLTGQDGSYEFTTIKPGPYPWKNHRNAWRPAHIHFSLFGTDFTQRLITQMYFPGDPLFSLDPIYRSIVDEGARGRLVAEYDHEISEHEWLLGYRWDIVLGGSNRTWTEPEEDDR

SEQ ID NO: 15 - protein, 212 aa, Kocuria halotolerans
MSREPQQTPVSRGRPVADPPADLTPTPGQTIGPFYGYALPYEGGERLVDRSDPRAVRLHGTVYDGAGDPVPDCLLEIWQPDEQGRVPEEPGSLLRDGYTFTGFGRAPADRVGHYDFTTLEPGPTAPGRAPYLLLTVFARGLLDRLFTRIYLPEDAEALAADPVLSGLPEQRRSTLIAEREPSGALRFDVRLQGEDETVFLTYPGQSSYGFGR

SEQ ID NO: 16 - protein, 288 aa, Kocuria halotolerans; identical to SEQ ID NO: 14

SEQ ID NO: 17 - protein, 477 aa, Kocuria halotolerans
MTATSDLRIPARADDDLATGRGPRAEDAAARPGGPDAGSPARTASPGSGPAGPASGGGEERYDIVGVGFGPSNMALAAACSEDPDAQRAVFFDAAQGPSWHAGMLLPDAGLQVSFAKDLVTFRNPTSPLSFLSFLVERGRIHDFFNRGSSAPLRVEFFAYLRWAAERLAEYVRYRHRVTAVQPQRSGGTITGYRVTVEGPEGTSTVLARHVVVAAGLQPNVPEGLPEDERVLHTSRYLHRVEGLGEVRSAVVLGGGQSAAEVALDLRSRFPEARVHLVHSRFGIVPADSTPFANRIFDNTSIDRLYRAPEEVRERLDRIHANTNNSVVDESTIQALYDAWYADSWAGRERIVFHDASRLAGVEPAEDGLDVAVRNDLDGDVEHLRSDVLALGTGYRPLDLRALLGEDADLLARDAEGRVIAERDYSVRWQSPAEGRLVAIGITQHQHGVSATLLSNIALRAGEILASLTGERAGAAR

SEQ ID NO: 18 - protein, 682 aa, Kocuria halotolerans
MRTSIATVCLSGTLRQKLRAAASAGFDGVEIFEQDLVVAPESPEQIRDYAAELGLTLDLYQPFRDVEGTTEEEFRDSLRRAEAKFALMGRLGMDLMLVCSNVGTASVGEDAVMAEQLGRLADVAAGYGVRLAYEALAWGRYVNDFEHSWRLVEAADRPNLGICLDTFHILSRDWPTDAVARIPGEKVFFVQLADAPLMSLDVLSWSRHFRVFPGEGGFDLEGFMVRLLAGGYSGPLSLEVFNDSFRQTNVYRTAVDALRSLRWLQDRTARQIEGTGAEAGRPSSGAPAAGSGENAVARRAAARLGELTRLPEAEQPSSITWAEVRGQRTEQVEALLDHLGFSYRGRHASKPVQLWEQGGARVVINEEPRAADAPSIASLGFELPDAAAAAARADALRVPAVPRLTGRGEQEFAAYLAPDGTEVFLCPPEAGGGDRWVEEFSAPGRGGRSAAGAAALGGLDAVGEAGQPAGVGGAPGGGGTGEGMAGASAGEDGAGGSGPALITGIDHVNLAQPRHHYPESVLFFRAALGLRVLPSQDVPGPTGLVSSQVVHNSTGTVRLPLNVAPDLRVEPEVEHVAFACDDVVALARRVRASGLRPLSVPGNYYDDLRARFDLEEGFIARLAELDLLYDRDERGEFLHFYTQTVGSVFFEVVQRLGGYAGYGAPNAPVRMASQYTRRTELG

SEQ ID NO: 19 - protein, 459 aa, Corynebacterium variabile
MSTQHTPDNLSVENAQTTPAGAPRSIAVIGAGLAGAGAALVLARAGYRVDLYSDRTREALRDEVPATGTAILFGASRTADAKIIDDLYAGSPAAHFGASAAGLANPDNPSGVDSFPARYTYEAQSVDARLRADDRLAAFLDLTGDTASAFHVTRVTPADLDRIAAEHDLTLVATGKGGLADAFTTDHERTPYPGPQRRVLTVTAAGLSSDHLFSGRAEVPGVNNALLSLHGEGEVFVGPYLHKDGIDAWVILAWAKPGTATEKAFAEATDAESSLRILQDLHHRVLPDVADDLDRLRPIDADPHSWLAGAVTPRVRRPVGYTDGGNLVAALGDTAIAVDPIAGQGAQLGDFQVAALVEGLTAAEASGQPWDADLLTDLFETHWAGHGAAGVAVTSLFLGDPLYAEVAGAFFGNAGTDPAYATALFSLFSEPAPALTLRTAEDVAALAASFRNSTAKVTA

SEQ ID NO: 20 - protein, 355 aa, Corynebacterium variabile
MVQTTTPTDNATVTDTNAELTLESTMGGIGTETTDRSVPVIDLDNWDLTDEQWDAKAEEFWDAATTIGFFQLKNFGITRAEIEDAFATSARFFALPKETLETVAKPKGRNVGFEHKSQIRPSTGTPDEKESYQITRPLMDGLWLDEDANPSIDGFKDASLAFEAKCHEVAMRVLEFFAVKLGFERDYFRKVHNPASDLHQCTLRMIHYMALDAKDNVADPNGNPVWRAGAHTDFNLLTLLFQTDGQSGLQVMPGADAGQDVQAWTPVPAFTDVLTCNIGDMLMRWSDDRLKSNFHRVKAADIGVDIPERYSMPYFAQADRDAVIAGPEGRYEPMTAGEYLDMRIQANFGKAESTK

SEQ ID NO: 21 - protein, 356 aa, Corynebacterium variabile
MTGFHVPVIDITAYVTGGTDPEKAAVAAAVDAAAREVGFIQLTGHGIDPQVWDGLASALDAFFLRDLEVKKEVTTPPSVNRGYSPPKSERLSLSLGVESATGMNDFFEAFNIGVQASAFPELDLPVSDYPENVWPAESGAGAEGMVGFRSQLEAWFGAAQGVAETLVDIFEDALGQPRGTIGSLADHSIDVLRTINYALEPGVTVELDGELNGMGEHTDYGIVTVLWADRVAGLQVLGSDGSWNDVLPEPGALLVNLGDVTARLTNDQWRSTLHRVKPPVVDGTILRRRSAAFFHDGNVDAIVGPLPGMVDSDHPARYEPVTVGEHVARKLAGSRSLELNASDTARESERVLSSRR

SEQ ID NO: 22 - protein, 760 aa, Corynebacterium variabile
MTDPMSGCPVAHGGGHTPQGGHAPQESQAERGEAQGSRLPLPTEGNANQRWWPKRLNVRLLAHNPQEVRPTPADFNYAEAFSQLDLPQVKKDIEDVLTTSQSWWPADFGHYGPLIIRMAWHSAGTYRSHDGRGGGGAGQQRFAPLNSWPDNVGLDKARRVLWPVKKKYGQNLSWGDLMILAGNVALESMGFETFGYSGGREDVWEPEDVYWGSETDWLGTDARYSGTNDTSRDLQKPFGATTMGLIYVNPEGPEGNPDPAAAAHDIRETFGRMGMNDEETVALIAGGHTFGKTHGAAPDNEENVGPDPEEASLDRQGLGWQNHHGEGKGDDQITSGLEVTWTYHPTRWDNEFFHILFAYEWELTTGEGGHFHWRPKDGGGADMVPMAHSAGRREPRMLTTDISLRVDPSYEKISRRFKDDQNALNDAFARAWFKLTHRDMGPKSRYLGPEVPAEDLIWQDPLPDAEGDPVTPQDVEALKKTVLDSGLSVSQLVKTAWASASSFRGTDFRGGANGARIRLEPQRSWEANEPARLAEVLTALEAIRTEFNENNAPRHLSLADLIILAGNAAIEKAAADAGTDVSVPFTPGRVDATQEQTDVDGFSYLEPQADGFRNYQNADLDIPAEHLLIDKADLLGLTAPQMTVLVGGLRVLGATYGSTGHGVLTDRPGVLSTDFFVNLLELGNDWVATDDNATVFRCTDGETGEEKWTGTRADLVFASNSELRAQAEVYASDDAAEKFIADFVAAWTKVTEADRFDLHG

SEQ ID NO: 23 - protein, 170 aa, Corynebacterium variabile
MTENTPDTTDIKSIPATTLDGDPLDLHDFDGPLLIVNVASKCGLTPQYTALEQLQKTYSTTDGTGLTFLGVPCNQFAGQEPGSAAEIQTFCSTTYGVTFPLLAKTDVNGDDRDPLYQALTTTQDAEGEAGDIQWNFEKFLVSADGRVLNRFRPQTTPDDPAVIDAIEAAL

SEQ ID NO: 24 - protein, 456 aa, Corynebacterium variabile
MSNDKRQVHLAAHFPGVNNTTVWADPGSGSHIEFAGFGHFARTAERGLFDFLFLAEGLRLREHKGQIFDQDVVGRPETATVLSALAAVTTHIGLTGTFNSTFNEPYDLARTLATLDRVSAGRAAWNVVTSHNAFTGANFRRGGYLDGADRYRRAADVVSLARTLWESHSGSEGHTGDGSFDWHSDFVDVHGIFPVPESPQISPVIFQAGDSEEGRDFAARHAEVIFSAHSEAEDGKAFRTDIDRRLAAVGRRPDSLRIYPGISVVLGDTEAEAQERYREVRHAQVHGPGAIAFLEQVWGRDLSDYDPDGPLPEVGPDLDNADITRGRVRHEKDYGAVARRWRALAEEKNLSIRELVTEVSGRGGTLIGTPAQVAARFDELTQQRAADGFIVVPHITPGGLDEIVDRVVPELQDRGVYRTGYPGSHGRTTLRDNLDLPAYVPGAFPTAVPTSQEVSA

SEQ ID NO: 25 - protein, 229 aa, Corynebacterium variabile
MTTAIHVSPTAALDLDALSATARALDAASGRGADDYLLVLGDDYISGQNAVTLAAWLAPQTTRLRIVPEVPVTHTEPFHVATSTATLDYAATGRAGWSPVAQTSDAAADAIGRRPAAPVDAAWGEVPDVVAAVRALWTSWEPDAEIRDEVTHRFIDRDKVHYVDATGTDSVGQPWSVKGPSIVPRPPQGELPTVTVVGDRFHTSDGVAGEVRHITDVIGLLALAAQVSA

SEQ ID NO: 26 - protein, 356 aa, Corynebacterium variabile
VKAFGFLSFGHYDLSTSGRMPGAKENLKNALEIAVGADELGVNGAYFRVHHFAPQHSAPMPLLSAIAARTSNIEVGTGVIDIRYENPLQLAEEAAQLDLLSDGRVALGVSRGSPEPVDRGYEAFGYHPAADDPKGAAMAREKFERFMAAVDGEGMATSLPLEEQYPRMCHPNVPVPVMPHSMSLRKHVWWGAGSRDTAVRAAHDGVNLMSSTLLTEANGDRFEDLQAEQIRAYRAAWKEAGHQWTPRVSVSRSIIPVTSEEDMRMFGIGGDEGGIGYIDDGQATFGRTYTDEPDKLVEQLKKDAALTEADTLMITIPSQLGVDANLRILQSFAEHVAPELGWEPNTAGTVTGYPLV

SEQ ID NO: 27 - protein, 369 aa, Corynebacterium variabile
MYLGVLPSSPWQHQRIWPASPDFTAHSMEPALYTRLARACDRAGIDVLFLPDKQVANASPPDPSVADSWFDPLTMFAYLAAVTDRIGLVPTLSTTWFEPYPLARQILSLDHLSGGRAGWNAVSSHPGLEDANFGHRPVLTREQMKARHAEAVSLVKDLWTSWDSDAVTHDAATGQWFRPGSVHPVDHHGRFFDVTGPLTLCRSPQDSPVLFMAGASENFLHTAAKDADVVFTALNDVDAARTMARTLASFADQEGRQDASPRLMPGFFVSASGFPEYGTDAQSWVPGMHFHSPAGPEPATGAEVAAEMVRIVEESGIDGFIVMPRQIPEDITFLCDEVVPALVELGARPEPSGNPEAAPSTLRANLGFV

SEQ ID NO: 28 - protein, 322 aa, Corynebacterium variabile
VRELPEIMRLSEDPPTTLPGWRRTFAPGELTLGLSPVTPDGDLARQVALTQAAEDAGFAAVWCRDIPLNVETFGDVGQIHDPFMYLTWLASQTSTIALGTAALVLPLAHPLLLAKRSAGLDRLSGGRFLMGVASGDRPEEFAAFGMDKGTRGEDFRENLSVLRKAWETRMRPVTWSRGRMGGAEVVPKPTAAGVPVLAVGSCLQTTEFNAAHADGWLTYHRNLHDQKVMVDRWRASCEEQGVGFRPVGESLWIDLAEDPSYPAEGRDFGFRLGRNALLELLHSQQELGLNHIMISLRHGNRPVEDALAELAEHVVPEFRALG

SEQ ID NO: 29 - protein, 368 aa, Corynebacterium variabile
MSTAQITDNLQFAYWVPNVSGGLVVSDIGQTTDWGIDYNRRLAQTAEQVGFDYALSQVRYLGSYGAESQHESVSFSLALLEATEKLKVIAAVHPGFWQPAVLANLATTASELYDGRFALNVVSGWLKDEFRKFGEPWLEHDERYRRSGEFLQVLRAIFAGDHAEFNGDFYRLHDYSISPHPTVAPELFQGGNSSAAQFNGGHFADWYFLNGAPVDELKLQIDQVRRHAEDAGREVKIGVNGFVILEDTEQQAHDKLRDIIAQADQGAVEGFAASVKQAGQSTADGKGMWANSSLEDLVQYNDGFRTGLIGTADQISDRIDELRNIGADLVLTGHLNFQEEVERFGKEVITPLRSDSTAPAVAPAHVNA

SEQ ID NO: 30 - protein, 476 aa, Corynebacterium variabile
MTRIRFNAFDMNCVVHQSPGLWRHPEDHSREYTDLRYWTDLAQLLETGYFDGLFLADVLGLYDLYGASPDAALRAATQTPVNDPLPLVSAMAAVTDNLGFGLTTGTAFEHPFPFARRISTLDHLTDGRLGWNVVTGYLPSAAENTQSRGQLDTFEHDARYDHADEYLEVLYKLWEGSWEDDAVLADPVSGVYTDPTKVRPVNHTGTHYTVPGIHVSEPSPQRTPVIFQAGASSRGSTFAATHAEAVFVAAPTQEALASTVRTLTDKLADAGRSREDVVIYALLTVITDATEDAARAKAAEYRSYIDHEGALALMSGWMGVDFSTFDLDDPVAGIESNAIQSAVAAFQRSAGEEGREWTVRELAEFGGIGGLGPVVVGSGESVADQLEEWVEATGIDGFNLAYAVTPGTFRDVIDHVVPVLQARGEYPTAYAPGTLREKLFADRTGAGPHVPHNHSAARYRPALTASPTSVPTGAHP

SEQ ID NO: 31 - protein, 336 aa, Corynebacterium variabile
MKYSLVELAPVTPGHTKHEALTRALDAAVEAEQLGYHRIWFAEHHNATGYASQVPEQLIALAAERTDRIRVGSGAVLLNHYSPYSVAERFLQLEALFPGRIDLGLGRATGGPVADAALQRDRSSARRDDYGDQVQEILAYYHHAFGEKHPFATLDPTHGIDSVPEVFTLGSSGSSAGFAGQLGIGYAFAGFINPRAAKAALRAYRENFTATPFGPGTPQIILALNIVAAPTEEEALTLTWPNRAMWADLRAGRPGPVPLLADAGDHLTTEEKDAPAHVEGLMLPQCLAGTPDSLRDQLRPFVEEFGVTEIMVQDALNDPELRSRSRALIAEALADL

SEQ ID NO: 32 - protein, 415 aa, Corynebacterium variabile
MHLNLFAYGCGHHSAAWRAPDSAFDRLGDVTWWEDLARTAERGRFDAVFLADGQSLNPVPGPSWFLEPVTALTALARATTRLGLVSTISSTFWDPFHAARLSASLDHISGGRAGINVVTSMTDAEARNHGMDRLPDHAERYARAAEFISTVTALWGSWPAGSSPAEAVPVDHHGRYFDVDGPLNIPATSQGHPVLFQAGASEPGRDLAARYAEGVYAVAWDLDSARDYRLDLRRRAAGYGRDPDDLVIMPGLVTFVGKTEEEAREKQRELNELLPVEDSLRQLSFFVGQDTSGWDLDAPVPELPPLAEFSGPAGRYATILRILASSPGGRPTVRDLLGYLAAGGGHATFVGTPERIAGEMERWIVNGAADGFNLMPPTLPGGLDDVVDLVVPVLQERGLFRREYTADTLRGHLVG

SEQ ID NO: 33 - protein, 348 aa, Corynebacterium variabile
MRFSLFIHMERWDNSISHEEHWNNLVELVQLAEAGGFGTVWTGEHHSMEYTVAPNPMVSLAALAGKTSTIRLGAGTIIAPFWNPVRAAGETALLDVISGGRAEIGVARGAYQFEFDRLAGGLSAKDGGTYLRELIPAMKKLWAGDYAHDGEHWSFPTSTSVPKPVQDDGPTVWVAARTAETHDFAVAEGCNVQVTPLMKDDAEVRDLKDKFDGAVANHPEIGRKPEIMVLRHTFVHSPDEPEAWRPAAEAVSRYYRTFSSWAFGRKEPVNGFLDPQPLETVAERPEFDLDSLHRSAMIGTPEEVTTRLKDYENMGYDEYSYWIDNSMTFEEKKASLQLFIDQVIPNFR

SEQ ID NO: 34 - protein, 451 aa, Corynebacterium variabile
MTENGEPDNPAQVHLNLFVSGCGHHAAAWRAADSAVDRLGDISWWEGLAQTAERGRFDAIFFPDGQAARTEALTAGPTWFLEPMTSLAAISQVTEHIGLVSSVSSTFWDPFHAARVIASLDHISGGRAGLNIVTSQLDAEARNHGMDALPNHAVRYARAGEFAETIKELWGSWPAESIVADRGGRYTETSQLKKISHRDRWFRVDGPLNIPTPPQKQPVIFQAGVSEPGRDLAASHAEGVFTVAWDSQGARGFRKDVRARTAAMGRNPDHVRVMPGLVAYVGSTEEEARRHQQELNELLPIEAALHDLSAFLGVDATAWDPDAEFPVLPPVSECDAAPGRATLVRHIVEHAGRRGGSSSGQDDLRRPTVREVLGYLAAGGGHATLVGTPEQVADEIIRWIDCGAADGFNIMPPSMPHGLDTFVDQVVPVLQERGRFRREYEGATLRENLLG

SEQ ID NO: 35 - protein, 358 aa, Corynebacterium variabile
MNSDRTLDLSVLDLVPVRTGQTSAQAVAATLEVAATADKLGYRRYWFAEHHNMPAVASTTPPVLAAAVAARTGQIRVGSGGVMLPNHSTLIVAEQFAALAAIAPGRIDLGLGRAPGSDPVISQLLHQSGTAPGAESFPQQVREITALLDPDGAGVRLRGGEGYAVRSTPVAVAGEIPQVWLLGSSDFSAKLAAELGLPYVFANHFGGPGLQDALTTYRDTYQPSEAFPEPRTILTVNASVAPTAEEAAERMLPQRRTMARLRTGLPMAAQETVEEAQATPLPGPAESYASKTGSTDPDRLKEVVDTPDNALEQLTVFAGRHGVDEVMIAPVGGAYDGEPLDRAPGAEQTVRLLGEALG

SEQ ID NO: 36 - protein, 422 aa, Corynebacterium variabile
MKRTDCSVCFDHREWISGFVTDRVVYSMAMTLPTPSDVTLHWFLPTNGDSRGIVGGGHGADAQLGTRFPDLRYLTQLAQAAEYNGFESVLTPTGRWCQDSWLATAALLSATERLKFLVAYRPSLVPATLLAQQAQTYQELSGNRLLLNVVVGGEDAEQRAYGDYSTKEERYGAADESLDLVQRLWTESEPVDVRGEHISVDGASLARRPSVTPPVFFGGSSPAGIETAAKRADVYLTWGEHPDDVAEKLETVAARAAAYGRTLDYGIRLHVISRDTEEEAWAVAQKIYDSIDPADVARAQAGLKTSQSVGQRRMSEIHGRGSGFVPGGDARALEFSPGLWSGIGLLRGGAGTALVGSHDQVAATIDAFRRSGIRHFILSGYPHIEESFQVGEGTVPALRRLGVTVTNHEAPVGNQESARNLA

SEQ ID NO: 37 - protein, 464 aa, Corynebacterium variabile
MTDHTHRTSYTDRTDQLVLNAFVYPEGHHEAAWRHPATTPERLLDPEYFVDIAGTAERGRLDAIFFADSPAVTGNVELRPGAGFEPLTLLSAIAARTEHIGLVATASTTYNDPYTLARAFASLDLISGGRAGWNIVTTAADVASANFGLTGHPSAEERYARATEFVEAVVALWDSFEEDALLVDPVAGRWADPSRVHPADYRGRYVSTKGPLNVPRSPQGHPVLVQAGSSNAGRALGGRFAEAIFTAHQRLEDAVDFAADIRARAVAAGRSEKDVKILPGLSPFIAATQKEAKELEAGFTELINPAFNLPTLNGLFDLDFTEDDLDTVIPLSAVRATGQTLDNNHSRSQVVAGIIERERPTVRQLLGRLAGARGHRVFTGTPVQVADTIEDWLRAGAADGFNIMPPYYPGGLEVFVDEVVPILQERGLFRTEYPGTTLRSSYGLDVPENRWTVQRAGKAGRVPA

SEQ ID NO: 38 - protein, 373 aa, Corynebacterium variabile
MIGAMEFGIFTIGDVTTDPTTGRTPTEHERIRSTVRYARKAEEVGLDIFATGEHHNPPFAAPANPPILLSHLAAQTERLRFSTATTLITTNDPVRLAEDYAYAQHLTEGRLDLMLGRGNTGPVYPWFGADIRQGIPLAVEKYHLLRRLWREENVSWSGEFRTSLQNFTSTPRPLDGTPPFVWHGSIRSPEIAEQAAYYGDGFFHNHIFWNIEHTRKMVRLYRQRYEHYGHGAREEAIVGLGGQVFIGETEAAAKKTFRPYFDNAPVYGHGPSMEDFTQMTPLTVGTVDQVIERYLGYADEVGDYQRQLFLVDHAGLPESAVLEQIEILGTEVVPVLRREFEARRPANVPSDPPRGGLAAVEPATKHNHAATDK

SEQ ID NO: 39 - protein, 332 aa, Corynebacterium variabile
MSAAESHAPLSLLDFATVYRGETPRDAFRRSVDLAQKAEELGYTRVWYSEHHNMTSIASSSPAVLIAHVAAKTERIRLGAGGVMLPNHAPLVIAEQFGTLAELYPDRIDLGLGRAPGTDARTVAALRRSPQNAENFPEDVLELQGYLAGRSKVQGVEAIPGADTNVPLYILGSSMFGATLAAQLGLPYSFASHFAPDSLVPAVKAYREYFQPSELCPEPYVIAAVNVTAAATEAEAVRQSEIVRRRRVESMALRGRQVGEEDLDLLMSSPAAEMILSMLRYHAVGTGEQVAEYLEGFTRHADADELMISLQSPTTAESLESMSILADAWGMR

SEQ ID NO: 40 - protein, 386 aa, Corynebacterium variabile
MGDVPGIRSGKTECHPIHTGLTAGLTVREPRPQGVTSMSTSNSPEPTQTPEGPAFEGRLLDRPDEDVVDQGPAFDIRTLMTRRTVLGVGAAGVGAVALAACSDNSSSSAATTSASSSASSSASVTDLPDAEIPDETAGPYPADGSNGPDVLEESGIVRADIRSSIGADDPVDGVPLEFSITVTDMANDDVPFENVAVYAWHCNAEGLYSMYSEGVEDETWLRGVQVADADGTVSFTSIVPACYTGRWPHIHFEVYPSVDDITDSENAIATSQIAIPEDVCNTVFALDAYEGSSENLSQVTLESDNVFGDDSGVSQLATMSGDVDSGYIASLTARVDTTTEPTGGAAPEGGPGEGGPGGEGGPGGEGGEPPAGEPPAGSPGAIASTN

SEQ ID NO: 41 - protein, 217 aa, Corynebacterium variabile
MIDSDPNGPFRYPVSDIRDQDEATPGIMPSQTVGPYVHIGLTWPGAENMVEEGTDGAVEVTFQVTDGAGHLIKDAMIEIWQAGSDGVYPSPLDPRAGEDAGREGFRGLGRGMCDSETGLVTFRTVRPGAVPAPDGGTEAPHLKVGVFARGMLERLYTRLYFPEQSEANDADPVLNAVPEERRDLLVASTVDGDADSYRMDIVMQHEDATRETPFFAL

SEQ ID NO: 42 - protein, 230 aa, Corynebacterium variabile
MIPISNATVDGSFAPLHFPEYRTTVLRNPSNDLLMVPQRLGELSGPVFGAADLRGEDNDLTKVNGGEAIGQRIFVHGRVTGEDGRPVPETLIEVWQANSAGRYRHKNDSWPAPLDPHFNGVGRTLTDKDGNYSFYTVQPGCYPWGNHHNAWRPAHIHFSLFGRQFTERLVTQMYFPGDPMFFQDPIYNSVPAGARERMISVFDYDETRENYAMGFRFDIALRGRNATPFE

SEQ ID NO: 43 - protein, 107 aa, Corynebacterium variabile
MILINVRFRPLPEYVENFREHVADYTAACRAEEGCLFFEWYRNTDDSDEYLLVEAYKDGADVAHVQSDHFKASCELFPTLLSETPQIINDHIDGKTEWDRMAEFSVD

SEQ ID NO: 44 - protein, 108 aa, Corynebacterium variabile
MSVVKINAISVPEGAGPELEKRFAARAHTVDSSPGFEGFQMLRPTKGDDRYFIVTTWASEEDFKAWAEGPARAAHSGPHSGEGKKPVATGADLLEFEVVDLDAIAKQQ

SEQ ID NO: 45 - protein, 96 aa, Corynebacterium variabile
MIILNVYFDVKQEHEAEFIKLLNHMVIESNKEHGCSMYQLFRKSYDPYLYTLIEHWDTQEDLDAHGKTPHWINFNDTVNNYLKSDYEEHHYVEIDF

SEQ ID NO: 46 - protein, 415 aa, Corynebacterium variabile
MDTNFRVTRRGFLAGLGLVSATAAVGATTACAGDSDPDPVSNTDTTVPFDGPHQAGIATPLQRHNTTVAFTLRDGVDATGIRRLLRIWTGDARRLTQGEPVLADLEPELASDPGRLTVTCGFGRGLFEKARLTDKSPDWLEPLPGFAGDRLEARWGDRDLVLQICGEDRTTVSHALRVLVRGGADYARPSWTQTGFLDIPQDADGTPGTPRNLFGFKDGTVNPRTDAEFDDQVWISGEAATHPSQIGGTCMIIRRIAFDMPLWESADRPTREVSMGRTIVEGNPLSGEKEHDDPDTAAVGADGLPVIDRNAHIALAGVHDGDTRQRMLRRAYNYDLPVTPSSADALVDADPVALSDTGLIFICFQPDPRTSFIPVQRRLAAGDRLNEWITHVGSAVFLVPAGTTEEEYWGEALLG

SEQ ID NO: 47 - protein, 72 aa, Corynebacterium variabile
MSVGDAEFGTYFIGYAKDPAVTEQMLRNMFIGVPEGNHDRILDFFTAVTGSLYFVPSAAFLNGLGADRVGRP

SEQ ID NO: 48 - protein, 425 aa, Corynebacterium variabile
MSDRPVSRRHFLTGLGVTGLGAAALGTAGVAGVGTLAACSTDDDSQVVPFRGVHQAGVTTAQQEHLHIVAFTVLTEDRDELRDMLSTWTSMAERLTTGEQTTEGGALTDSDADITDDPDNLLNQVPEDTGEALDLASGNLTVTVGFGPSLFDDRFGLKDRKPEELEPLPKFPGDQLQDALCDGDIVIQACADDPQVAVHAVRNLTRAGTGVVAVKWSQLGYGAASKTTKEEDTPRNLFGFKDGTRNITADETDDIEKMVWVSDDGWMTGGTYMCVRRIRMLLEVWDRQILDDQQHTFARYKGSGAPIGTDDENADVPFDLYLGTGGPAIPEDSHVFLAHPDQNDGQRMLRRAYNFIEGSDSMGHLSAGLFFIAYVSAPSVNFTPIQMRLSHSDKMNEYVRYESKAIFACPPGLAEGEDWGTALFG

SEQ ID NO: 49 - protein, 230 aa, Corynebacterium variabile; identical to SEQ ID NO: 42

SEQ ID NO: 50 - protein, 281 aa, Staphylococcus lentus
LKYGLLLPNIKGNEIFTIIENLNSITQDSIDSVWLRDIPVALNEDKDEGNWYDPIILATILNRHLKNPDIFIGTAVINTLYRRKESVLRSAINLQYLCNNKFILGIGNGEKEGIYNILDADWNDKYKYMRNYLEYFSKIKIDTVNRRLINQLENQSFFSIPSNVSLPLIYLATSNRKVITQYKNHIHGILTWMKSPKDLSSLQKSLSPYNIKISNVINIMFTHENKIYYKEINGLTYIVTNHSNIHSIVDSYDKVGINRLIFNVYKNDYNFLKKLKEQSYD

SEQ ID NO: 51 - protein, 434 aa, Staphylococcus lentus
MTKNTHIKLGLFLAGYGHHVASWRHENVNEQGPMDLNHLIRTAQLAEKGLFDLVFLADSLFVSESSHPNILSRFEPLTLLSVLSTHTTNIGLAATASTTYSEPFHIARQFSSLDHISNGRAAWNIVTSSIPSTAENFNGTKLMEHELRYERANEFVDVTNKLWNSWEKDTLIRNKETGEFIDGKKLHTINHVGKHFKVRGPLNIERSPQGRPLLIQAGSSPTGTDLAAKVADVIFTAQSQLTDAKDFYQKLKNKAINENRNPNDIFIMPGLFPILGETVEEAEQNYQEIQDLILPHVGLNILSPYVGNIDLSQYPLDKKFSELDLTVGDGVQSRFEVIHKEAIAKDLTLEEVYKKVAGSRGHHIFVGTPNQLADKMEKWFNSSGADGFNIMPPILPSQFELFIEKVIPILQKRGLYKTSYNKGTLREKLGLNNE

SEQ ID NO: 52 - protein, 335 aa, Staphylococcus lentus
MQSHFPISALNLVPLRKGESEQEAIQNMVQLAQHVEKLGYERYWIAEHHNAPNLVSSATALLIQHTLEHTDSIMVGSGGIMLPNHAPLVVAEQFGTMATMFPNRLNLGLGRAPGTDMMTASALRRDSHKGVYTFGDDIKQLLKYFGPEEDQSYVRPYPGVDTNIPIYVLGSSTDPAHLAARLGLPYVFAAHFAPQQMAQAIEIYRDLFEPSEYLDKPRVTVCLNVIIGETDEEATYLSSTMHLMFLGIVRNSRLPLQPPTDQLENIWSPQEKYMAQDKTNTSFIGSEETVKKQFLAFQEKYNVDEIMAVSYIYDLDKQYKSFESFKKVVDEIYSE

SEQ ID NO: 53 - protein, 349 aa, Staphylococcus lentus
MKFELGLSSFAELSPVDGTDKPFTASERINQIVEEIILADKVGLDIYGLGEHHREDYAVSDPVSVLAAAAPQTNQIRLSSAVTVLSSDDPVRVYQRFATLDALSNGRAEIMAGRGSFIESFPLFGYDLKDYDILYKEKLDLLLNINENKTVNWQGSTRPSINGLDVYPRAVQEKLPIWLATGGNPESSMRAGELGLPITYAIIGGAPSRFKRNVAMYKAIAESKGHDVSKLPIATHSWGYVAESDEIAKQEYYPSSAYVINQLGIERGWPMYSIEKFEQEIVHGALFVGSPETVAAKIIKLHEDLGITRFMLHLPVGSMPHEKVMKSIKLLGEKVKPIVDDYMKNKEEI

SEQ ID NO: 54 - protein, 331 aa, Staphylococcus lentus
MKLSVLDQAPISKGDTPEETLRKTIELAKWTESLGYHRYWVAEHHNTSGLASSSPEILMTNIAASTNQIRVGSGGILLPQYSPYKIAENAKTLSAFFPNRIDIGFGNSPGGSPSTQKALTDNHIKPIDDFPRQVSDLQGFLYNSLPRDHKFRLVKAGPRIDNPPPMWLLGLTENGAKNAANLGIGFVFGHFINPKYGKIAMERYYNDFKSSVSQQSPSSIVCIFVVCAETDEKAEELALSQDKWLINVSKGRGTKVLSSEEINFEDFTDEEQDLIKKNRKRCIIGSPETVVAKLKELETYYQTDEFMIITNIYNFKDKKKSYKLLAEAITE

SEQ ID NO: 55 - protein, 331 aa, Staphylococcus lentus
MRLSILDQSPVSSNQTSREALNHSLKLAQIGESLGYTRYWLTEHHDLQHLASSTPEVLLGYIGGHTETIRIGAGAILLPHYRPYKVAEIFNTLATLFPNRIDLGIGRAPGGSAEATNALSTNYLQKVFALPELLEELLNFLDGSFPDGHEFKSLSALPKPEKSATPWLLGTSEKSAKLAAKNGLPYTFGYFMSDNKGTEIIQTYKDNFVKRYENQEPEVILTVSVVCAETNKKAEEIALSSLIWSIQKEKLEDENGVPSIEAAKQYKLTDKEKEKIENMKRQMIIGDQKTVKTQLKALEKEYECDEIMINTVTYSPDDKFNSYCLIAEVLL

SEQ ID NO: 56 - protein, 354 aa, Staphylococcus lentus
MHNIVEHDFSSDVSNLGDDGLVELSVLDYAVIDEGKSAEEALQDTVKLAKLADKLNFKRFWLTEHHDVPAFACSSPELMMMHLLSETKRIKLGSGGVMLPHYSPYKIAENFRLLEGLFPNRTDLGIGSNLGTAIVKRALNEGKTDFLDYEQSIKDIRHYITNQDESQRYKGLIAQPHLSHHSDMWLLCTSAESAQIAAEQGIGLTLGTFLLPNQAQIDSAKESVDTYRKAFNRTSLNMSSTVMITTFVIVTDTEQEAEDLLQSLDVWLLGKKQFAEFSRFPSIETAKSYKLSERDQHLIEQHRARVIAGTKEQVKLKIDRLVEDFQANEVLLVPLHPGIKQRCRTLELLSEIYL

SEQ ID NO: 57 - protein, 435 aa, Staphylococcus lentus
MKRMKLGYFLTGFGHHVASSRHPESVERGGMNLKKTIEQAKSLEQAKFDFLFVSDSLYVDNKTHPDMVTMFEPISLMSIIAMETKHLGLIITGSTTYSEPFNLSRIFSSLDHYSDGRAGWNIVTSGINDTAKNFSGVNNVDHDLRYDQANEFVEISKKLWNSWRDVDSQSIHKAGKFLKNQQPEPINYEGDFYNVKGPLNIDQSPQGYPLLVQAGSSKKGTDFASKHAEVIFTAQNDIDAAINFAQKLRRQVEEKRGPEQEVVIMPGIFPFIGETREEAQANYKELQDLIDPEMGLELLSSYLGDTDLSGYDLNTPFEDVEVDKGNNIQSRVDLIKETAKRNNSTLEDVMKHVAGARGHHIIVGTPEDVADRMEEWFKRGAADGFNIMPPLNPTQFELFVNKVVPILKERGLVQTDYNEGTLREKLGLSNVKTHS

SEQ ID NO: 58 - protein, 132 aa, Staphylococcus lentus
MNGSLHHIEIYVEDIQKSRAFYEWLLNKLGYKLYQEWDLGFSFKLGETYIVFVEVEEKYKDYGYHRKRIGLNHLAFNVETKAMVDEITNDLINQDIGILYVDRHPFAGGNDHYAVYFEDPDRIKLEIVSNGN

SEQ ID NO: 59 - protein, 321 aa, Staphylococcus lentus
MSNNELIGIHHVTAITDDAVRNYEFFTEVLGMRLVKKTVNQDDIYTYHTFFADDQGSPGTDMTFFDFPNSPKGQRGTNSISRAGFRVPNDAALEYYLERFEEFGVKNDGIQELFGKKVLPFEEKDGQRYQLFSDELNKGVEPGLPWKNGPVPEDKAIYGLGPIEITVSYYDDFKSVLKQIYGMKPIIEEEDVTLFEVGEGGNGGQVILRKDDKTPEARQGYGEVHHVSFRVKDHEAIKAWEEKYKELRIGNSGNVNRFYFEALYARIGHILIEISTDGPGFMGDEPYETLGESLALPPFLESQREYIESEIKHFDTTRKHD

SEQ ID NO: 60 - protein, 126 aa, Staphylococcus lentus
MKLNHINIAVKDVVTTKEFLEKYFGLKCIASAGNMFTALNDDDGLLFNLIKDENASYPDTFHIGFPQEDEESVDKIYETLKEDGFEVWEPALAHGSYTFYFKSPGEFTIEIYAQAEEKTKTVVHPY

SEQ ID NO: 61 - protein, 139 aa, Staphylococcus lentus
MIQSINHICYSVSDLKNSIRFYKNILCGELLVSGKTTAYFNIGGLWVALNEEKDIPRNEVQYSYTHVAFTIDESEFNDWYQWFKENDVNILEGRTRDVRDKQSIYFTDPDGHKLELHTGTLENRLNYYKETKPHMVFYK

SEQ ID NO: 62 - protein, 309 aa, Staphylococcus lentus
MVEILRHHHISMLTKDAKLNKDFYVNKLGLRLYLKTVNQDDTSMYHLFYGDEVGTPGTSLTFFELKPMGQTYKGTNSISRIGLLVPSEESLSYWKERFEEMDVDHDAIGIYNGLMALHFRDHEGLEMVLLPNGDRRTPQDWRNNSYSDVPKEHQIMGMGPIEFKMDQVTDMKNFLENDLNFDVADSESELLYTRDQEGLYSDIVLVEEQGKREKPGKGSIHHLALSVADEEELKKVKELLDSKNVVHSGIIDRDFFKSLYYRHSHILIEFATEGPGVPYDDIDQLGEKLDLPNFLESKREEIESNLEPI

SEQ ID NO: 63 - protein, 280 aa, Staphylococcus lentus
MNNFQDDSIKGESVKTDFTEDMTYSEYLGLDKVLSAQHTLTDSHDEKLFIIVHQVSELWMNLIIHEINSACDDVKNDQFKQAFKKLARVGNIQKQLIQVWEVLSTMTPSDYLTFRDDLGSSSGFQSYQNRMLEYSLGYKTTHALKIYEKDANIYNLLKTQLEKPSIYDETIKAINRAGFKIDESVLNRKVTDNHVSNESVKEAFKEIYLNAETYFELYELLEKLTDVEDRYSQWRFRHMKTVQRIIGFKVGTGGSSGVNYLKRVIDHSFFPELWELRTEL

SEQ ID NO: 64 - protein, 174 aa, Staphylococcus lentus
MLDISRGINHIGLTVPNIEDATKFFKEGLDGKIAYDSQKKDESPRDGEHVEHILGLEEGAKIIKKRMMVFGNGPNIEMFEFQDAKQAKPDSLQDIGFTHISFYVDDFEKAFEQIQKAGGEPISQPHDNTKYEDTAGNKTVYVKAPWGSLIELQTVPEGFYYPSDSEAEVFIPKK

SEQ ID NO: 65 - protein, 396 aa, Brevibacterium epidermidis
MEFGIFTIGDVTTDPTDGTTVSENQRIKNTVEIAKKAEEVGLDVFATGQHHNPPFVAPANPPVLLANIAAQTEKLELSTATTLITTTDPVRIAEDYSYAQHLSDGRISLIMGRGNTGPVYPWFGKDIRAGIPLAVENYNLLYRLWREKNLDWEGKFRTPLGGFTVTPTPLDEVPPFVWHGSIRSPEIAEQAAYYGDGFFHNNIFWPTSHTARMVQLYRQRYEYYGHGKASQAIVGLGGQVFMRKNSQDAVREFRPYFDNAPVYGHGPSLEDFSTQTPLTVGSPQQVIERTLSFRDWAGDYQRQLFLIDHAGLPQKTVLEQLDLLGEEVIPVLREEFAKGRPADVPDAPTHESLVIRHREGRDPIPGGGEGSRAFEDRQARAAEAAQNATQEGANRS

SEQ ID NO: 66 - protein, 344 aa, Brevibacterium epidermidis
LTVVHLSSHPKDPTTLPVPLNILDLVSIRDGSTAREAIANSMSAAKFADEAGYKRLWFAEHHNTMGLAASATALLISQAATVTKRIRVGSGGVMLPNHAPLMVAEQYGTLANIHGERIDLGLGRAPGTDGMTAQALSRSSAEPQSFAQNIYDMQGWFSERGQAHTAPIKSAVSAGMDVPIWVLGSTMNGASIAGQLGLPFSIASHFAPDQIDAAIKVYRDSFTADAPTAQIDKPYVMAGINVMVAETDAEAQREFTPVRQMFADIGRGRNRQLQPPVDPAELAAQGAGENPMLQISAVGSPDTATAQMAEFVERTGADELITVTYAFDPEVGQRSLRLLADAWF

SEQ ID NO: 67 - protein, 415 aa, Brevibacterium epidermidis
MTESAQLHTTPQQHSGAPESQPSQQPNYMHEFGFYHGQGLQFGIYSLGDHLPDPHDGSRVDAGQRIHEFIGYAQAAEAAGLDFFSLGESHQEFFASQAHAVILGAIAQATDTIRIGSSSTILSTSDPVRVFENFATIDLISGGRAELVAGRASRVGLFELLGYDLRDYEELYEEKLDLLLTINREKQVTWSGQFRAPLNDAEVLPRPTGQALRIWRAVGGAPASAVKAGLAGVPMVMAHLGGTTSVFKGTVDAYRRAAAHAGFDPGTLPIATAGFFHAAPTSQEALAGMYPHINEGMKRTNGQGMPKQHFAQSVHPASIANIGSPQQIVEKILHQHEVFGHQRYLAQVDFGGMAYADVMKQIEIIGTEILPAVKKYTATAPADSQTESAGSASGPAGSASGSTGSAFDSAEEALA

SEQ ID NO: 68 - protein, 361 aa, Brevibacterium epidermidis
MKLSILDLVPVRTGQTTADSFAASKQIIDTADKLGFTRYWVAEHHNMPSIASTMPGPELMHLGQGTQQIRLGSGGVMLPNHAPLAVAELFALLSAVFGDRIDLGIGRAPGTDPITSAAMRGHLGEGRMVDREGRAIDPVEQFPRHVIDTLSLMQPEGMRVPLHGGREHVLKATPAAAPGTQPLPWLLGSSGYSARLAAELGMPYVFANHFASGATTGMKIYRDNFTPGAYGDKPQTFVTANLVVAPTEEEAQLRSEPFMLQMARMRTGGPMEKLHLAGDDIRSVMTDQERMVGEELSNNWIIGDPKSAAAQLEELAERFDVDEIMIQPIAGAMKGEDVREDPGRIQTIELLAAEFLGGVNV

SEQ ID NO: 69 - protein, 459 aa, Brevibacterium epidermidis
MTKPILLNAFDMMTPVHQSPGLWRHPESRVDEFTQLSFWTDLAKTLEDGGFSSLFLADILGVYDVYGGNADVTNRGGVQFPLLDPLVAVPAMAAATKTLGFGVTASVTYEKPYLLARTLTTLDHFTNGRVAWNIVTSYVDSAARNLGLKGQIPHDERYDRADEFMEVMYKLFEGSITPDALKADADANVFVDPGEVHDIGHEGKFFNVPGQALAVPGPQGTPLLFQAGASKRGQEFALDHAEAIFFSGPTPEILRSWVDKVRDGLEERGRARDSVKIFALATVIVDDTDEAAEARLADYRRYVDTESALSLFGGWTGVDLSGASPDDTLEYVSTDANQSALASFTTMAGDKPWTIRDLAEFVALGGRGPVITGSPETIVDEFQRWMDEADIDGFNIAAAVRPADAERFAKYVSPELRRRGLLPEPVDGATVREQLTGSGPRLADDHKGARYRLGEDARV

SEQ ID NO: 70 - protein, 396 aa, Brevibacterium epidermidis
MEFGIFTIGDVTTDPTDGTTVSENQRIKNTVEIAKKAEEVGLDVFATGQHHNPPFVAPANPPILLANIAAQTQTLELSTATTLITTTDPVRIAEDYSYAQHLSDGRISLIMGRGNTGPVYPWFGKDIRAGIPLAVENYNLLYRLWREKNLDWEGKFRTPLGGFTVTPTPLDEVPPFVWHGSIRSPEIAEQAAYYGDGFFHNNIFWPTSHTARMVQLYRQRYEYYGHGTASQAIVGLGGQVFMRKNSQDAVREFRPYFDNAPVYGHGPSLEDFSTQTPLTVGSPQQVIERTLSFREWAGDYQRQLFLIDHAGLPQKTVLEQLDLLGEEVIPVLREEFAKGRPADVPDAPTHESLVIRHREGRDPIPGGGEGSRAFEDRQARAAEAAQNATQEGANRS

SEQ ID NO: 71 - protein, 382 aa, Brevibacterium epidermidis
MANIHANPIYTGEPEDLKFAYWVPNVSGGLVVSNIEQRTDWGYDYNVKLAQTAEAVGYEYALSQVRYLSSYGAAQQHESTATSLALALATEKLKVIAAIHPGIWEPAVLAKFILTADQFTKGRTAINVVSGWFRDEYTRLGLPWLEHGERYRRSAEFMDVVRKLFTEENVEYPGNFYTVDDFTLRPGPYPVEGRPHPEIFQGGNSSAARINGGKHADWYFSNGKDFDGFREQYDDVTEVARAHNRKVRFGLNGFAIVRDTEAEAREQLREIIAKADEGAVEGFRKSVQQAGASTHDKKGMWADSSFEDLVQYNDGFRTQLIGTPEQVADRIIEYKKIGVDLILTGFLHFQEELEAFGKTVIPIVREKEVELVNRGLLTPAGV

SEQ ID NO: 72 - protein, 350 aa, Brevibacterium epidermidis
MTPQPTDTQATGPKLGFFTRLLEDAPAAQRYRFALEQIETAEEFGFHSAWVAQHHFSAAEGGLPSPLVFLSHAAARTSRIDLGTAIITLPMENAVRVAEDAAVLDELSAGRLQIGLGSGGNPKSFPAFGTSFDDRREVFADNLATLRTLFSGDRLPTDHSLYPVPDAERPSLERRLWQATFSAGGAGAAGAAGDGLMLSRTQPRPQDNPAARLDEVQLPVIDTYLSQLPDGVEPRILASRTAVVADAEDLPRLREITEPALRAEADRLVGYDTSGLSLDELLIATDTYLGTPEQVIERLHHDRVLDRVTDVSFQVHSVPATNETALRSIELLATEVAPALGFAVTTERVH

SEQ ID NO: 73 - protein, 225 aa, Brevibacterium epidermidis
MDVVRKLFTEENVEYRGNFYTVDDFMLRPGPYSVESRPHPEIFQGGNSTAARINGGKHADWYFSNGKDFDGFREQYDDVTEVARAHNRKVRFGLNGFAIVRDTEAEAREQLREIIAKADEGAVEGFRKSVQEAGASTADKKGMWADSSFEDLVQYNDGFRTQLIGTPEQVADRIIEYKKLGVDLILTGFLHFQEELEAFGKTVIPIVREKEAELVDKGLLIPAGV

SEQ ID NO: 74 - protein, 188 aa, Brevibacterium epidermidis
MTELTPTPGQTVGPFYGYALPFDHDNELVPPGSARAVQLTGTVYDGAGDPVPDAILEIWQPDEHGAVPRETGTLRRNGFTFTGFGRAAVDPEGEFSFSTVNPGPTEAGKVPFISVVIFARGLLNRLFTRIYLPEDTAALAADPLLSSLDEDERSRLIATRGADGSLHFDIRLQGEEETPFLRFPSHED

SEQ ID NO: 75 - protein, 272 aa, Brevibacterium epidermidis
MSAQQNSDADELKGPDDAAESQATLSAEIDGIEAQYKQDVAGGKKPETQPRLDYRPYRSSILRHPTKDPRHTDPETIELFSPAFGHRDIGTLESDLTIQADGEPIGERIRVTGRVLDGEGRPVRNQLVEIWQANSAGRYIHKRDQHPAPIDPNFTGVGRTLTGDDGSYSFTTIKPGPYPWKNHHNAWRPAHIHFSLFGSEFTQRMITQMYFPGDPLFALDPIYQSITDQKARDRLVATYDHNITEHEFLMGYNWDIVLTGANRTWMEEEDDD

SEQ ID NO: 76 - protein, 325 aa, Brevibacterium epidermidis
MARVPEPDQTPEGPAYEGRLLDRPDEEVVDQGASFDLRTLFSRRGVLGLIGAGVGAAALTACSSGTSGSASSSSGSVTEIPDETAGPYPADGSNGPDILEQSGIVRSDIRSNIDGSDTVDGVPLTFTLKVTDMANDNAPFEGVAVYAWHCDAQGRYSMYSEGAEDATWLRGVQVADSNGEVTFTSIFPGCYTGRWTHIHFEVYPDVDSITDAENAIATSQMALPEDACNAVFELDAYDGSAKNLSAITLDDDNVFGDDGGEHQLATISGDTDSGYVASLDVPVDTETEPSGGAAPAGGGGGEGGEPPEGGGGPEGGTPPDESADQ

SEQ ID NO: 77 - protein, 343 aa, Brevibacterium epidermidis
VTIAFVKTTLPIIGAPMAGGTTTPELTEAVDRAGGFPFVAGGYLTAEALAPLITRMRETTSNFGVNLFAPNPVPVDRMAFDDFVTALEPAAAARGITLDPEPVEDDDHFDAKLDWLTEHPVPLVSLTFNLPTAETVDRLHAVGTQVVATVTSVPEARAAAEVGVDGLIVQGPRAGGHSGTADPTRIIEDRATVDLVRDILAELALPVAAGGGVDGEAMVGDLLGAGASSVVVGTLLLRSDEAGTASTHRAALAADEFTDTQLTRAFTGRPARALVNDFVRKFDPVAVDAYPAVHHLTKEFRAAAKKADDPHGLHLWAGTGYRSAQDGSAETIVKDLGSRFARE

SEQ ID NO: 78 - protein, 332 aa, Brevibacterium epidermidis
MHSSTQGGTVSTFTDLRSQLRLPVVGSPMFIASGPELVKAQCQAGIIGSFPTLNARPASQLTDWLDEISASNAAHTAANPQQPAAPFAVNLIVHRSNNRLEQDLAEVVRHQVPIVITSLGAREEVNEAVHSYGGIVLHDVINNRFAHKAVEKGADGVIAVAAGAGGHAGAQSPFALVQEIRSWFDGPLLLSGAIAHGRSILAALAAGADLAYVGSAFLSTPEANVVDDYRKMIVESGADDVVYSNYFTGVNGNYLRGSIVASGLDPDNLPESDPSKMSFASDPDSDAKAWKDIWGSGQGIGALGQQRTTAELVETFATQFDEAKQRLLAQLR

SEQ ID NO: 79 - protein, 266 aa, Brevibacterium epidermidis
VNNLYRELAPITGAAWAEIEEEARRTFKRNIAGRRIVDVEGPSGFETSSVTTGHIREVQSYSSGLHIRQRIVQEFVELRAPFTVTRQAIDDVARGSGDSDWQPVKDAATTMALAEDRVILHGLDSAGIGGIVPNSSNVAVTLPDSVEDYADAVAQALSSLRTAGVDGPYSLLLSEAEYTKVSESTDHGFPVRDHLSRQLGAGEIVWAPALEGALLVSTRGGDYELHLGQDLSIGYRGHDGETVDLYLQETFGFLALTDESSVPLHP

SEQ ID NO: 80 - protein, 335 aa, Brevibacterium epidermidis
MALTQLPVLDLSLADDPATAEAFRADLRRITHEIGFFYLKGHGIPDADFTRIIDVAERFFALPEEEKLAIENTNSPHFRGYTRTGGERTQGRVDWREQIDIGPERLPVAEPVNDFDHLTGPNQYPAALPELREATESWHTRLSEVGARLLEQWALSLGQTGDHFASAFAEDAESFIKIVRYPEAESESVTQGVGEHRDAGTLTLLYPQPGTTGLQVLTDDGWIDADPIENTFVVNIGKLLEVATNGYLKATVHRVLPTGPGQDRISIPFFFNPALNARLPEVELPAEIAADARGVTQDERDALHAVYGENAFLSRLRSHPNVAEKFYPELVGAQV

SEQ ID NO: 81 - protein, 337 aa, Brevibacterium epidermidis
MTLTQLPILDLSQADDPATAEQFRADLRRITHEIGFFYLKGHGIPDADFARIIDVSQRFFELSDEDKLEIENSNSPHFRGYTRTGGERTQGIIDWREQIDLGPEREAVAEPAHDFENLIGPNQYPSALPELREATEDWHSRLSEVGTRLLREWALSLGQPADHFDSAFAENADSLMKIIHYPAPDTEVEDITQGVGEHRDPGTLTLLYPQPGTTGLQVQTDDGFIDAEPIENTFIVNIGRLLEVATNGYLKATVHRVLPTAPGEDRISVPFFFNPALDAHLPEVELPADLAAEARGVTEDEREILHTVYGKNIFDARLRSHPNVTEKFYPEFLSAQS

SEQ ID NO: 82 - protein, 603 aa, Corynebacterium variabile
MGDVPGIRSGKTECHPIHTGLTAGLTVREPRPQGVTSMSTSNSPEPTQTPMIDSDPNGPFRYPVSDIRDQDEATPGIMPSQTVGPYVHIGLTWPGAENMVEEGTDGAVEVTFQVTDGAGHLIKDAMIEIWQAGSDGVYPSPLDPRAGEDAGREGFRGLGRGMCDSETGLVTFRTVRPGAVPAPDGGTEAPHLKVGVFARGMLERLYTRLYFPEQSEANDADPVLNAVPEERRDLLVASTVDGDADSYRMDIVMQHEDATRETPFFALEGPAFEGRLLDRPDEDVVDQGPAFDIRTLMTRRTVLGVGAAGVGAVALAACSDNSSSSAATTSASSSASSSASVTDLPDAEIPDETAGPYPADGSNGPDVLEESGIVRADIRSSIGADDPVDGVPLEFSITVTDMANDDVPFENVAVYAWHCNAEGLYSMYSEGVEDETWLRGVQVADADGTVSFTSIVPACYTGRWPHIHFEVYPSVDDITDSENAIATSQIAIPEDVCNTVFALDAYEGSSENLSQVTLESDNVFGDDSGVSQLATMSGDVDSGYIASLTARVDTTTEPTGGAAPEGGPGEGGPGGEGGPGGEGGEPPAGEPPAGSPGAIASTN

(19) United States
(12) Patent Application Publication
(10) Pub. No.: US 2025/0289043 A1
(43) Pub. Date: Sep. 18, 2025

(54) IMPROVED PLASTIC DEGRADATION BY DARKLING BEETLE LARVAE, MICROBES, AND ENZYMES

(71) Applicants: Mark BLENNER, Newark, DE (US); Kevin SOLOMON, Newark, DE (US); Lummy MONTEIRO, Newark, DE (US); Jyoti SINGH, Newark, DE (US); Ross KLAUER, Newark, DE (US)

(72) Inventors: Mark BLENNER, Newark, DE (US); Kevin SOLOMON, Newark, DE (US); Lummy MONTEIRO, Newark, DE (US); Jyoti SINGH, Newark, DE (US); Ross KLAUER, Newark, DE (US)

(73) Assignee: University of Delaware, Newark, DE (US)

(21) Appl. No.: 18/861,356

(22) PCT Filed: Apr. 28, 2023
(86) PCT No.: PCT/US2023/066382

§ 371 Date: Oct. 29, 2024

Related U.S. Application Data
(60) Provisional application No. 63/336,657, filed on Apr. 29, 2022.

(51) Int. Cl. B09B 3/60; B09B 101/75

(52) U.S. Cl. CPC B09B 3/60; B09B 2101/75

(57) ABSTRACT

The invention provides a method for improving degradation of a plastic substrate. The improvement method comprises treating darkling beetle larvae (e.g., mealworms) with a feed supplemented with one or more dietary supplements, for example, oats, and exposing a plastic substrate to an effective amount of the darkling beetle larvae. Also provided are methods for degrading a plastic substrate using a microorganism isolated from the darkling beetle larvae (e.g., mealworms) or an enzyme, for example, a peroxidase.

### CROSS-REFERENCE TO RELATED APPLICATION

This application claims priority to U.S. Provisional Application No. 63/336,657, filed Apr. 29, 2022, and the contents of which are incorporated herein by reference in their entireties for all purposes.

### REFERENCE TO U.S. GOVERNMENT SUPPORT

This invention was made with government support under Grant Nos. DE-SC0022018 and DE-SC0021166 from the Department of Energy. The United States has certain rights in the invention.

### FIELD OF THE INVENTION

This invention relates generally to plastic degradation by darkling beetle larvae and its microbiomes.

### BACKGROUND OF THE INVENTION

Mealworms, larvae of T. molitor Linnaeus have been observed to consume plastics such as polystyrene (PS), polyethylene (PE), and polypropylene (PP). Plastic consumption and digestion have been reported to be linked to processes in the salivary and gut microbiomes; however, the identity of important microbes and the identity of the enzymes responsible for plastic degradation have not been elucidated.

Furthermore, diet is known to influence the composition of the microbiome but how it influences the microbiome, and how it influences the rate of plastic consumption and degradation are not known.

There remains a need for a method to improve plastic degradation by mealworm, to enrich the mealworm gut for plastic degrading microbes, and to identify the enzymes that are responsible for plastic degradation.

### SUMMARY OF THE INVENTION

The present invention relates to methods for improving plastic degradation by darkling beetle larvae and methods for plastic degradation with microorganism isolated from the darkling beetle larvae or enzymes isolated from the microorganisms.

The present invention provides a method for improving degradation of a plastic substrate. This improvement method comprises treating darkling beetle larvae with a feed supplemented with oats, and exposing a plastic substrate to an effective amount of the darkling beetle larvae so that the plastic substrate is degraded by the darkling beetle larvae at a rate higher than that by darkling beetle larvae treated with the feed not supplemented with the oats.

The darkling beetle larvae may be mealworms. The mealworms may have a gut comprising a microorganism selected from the group consisting of Staphylococcus, Peptoniphilus, Brevibacterium, Helcococcus, Mannheimia, Trueperella, Pseudomonas, Corynebacterium, Mangrovibacterm Clostridia, Enterococcus, Allobaculum, Romboutsia, Turicibacter, Lactobacillus, Muribaculacear, Pediococcus, Staphylococcus and Pseudomonas. The mealworms may have a gut comprising a microorganism selected from the group consisting of Kluyvera cryocresens, Staphylococcus lentus, Enterococcus termitis, Listeria fleischmannii, Mangrovibacter yixingensis, Corynebacterium variabile, Enterococcus faecalis, Brachybacterium nesterenkovii, Brevibacterium epidermidis, Lactococcus garvieae, Kocuria halotolerans, Staphylococcus gallinarum, Intestinirhabdus alba, Enterococcus sp. Enterococcaceae, and Enterococcus faecium.

The plastic substrate may be selected from the group consisting of polystyrene (PS), polyethylene (PE), polypropylene (PP) and a combination thereof.

According to the improvement method, wherein the darkling beetle larvae may be mealworms and the plastic substrate may be PS. The PS may be degraded at 60-80 mg per 100 mealworms per day. The mealworms may have a gut comprising a microorganism selected from the group consisting of Staphylococcus, Peptoniphilus, Brevibacterium, Helcococcus, Mannheimia, Trueperella, Pseudomonas, Corynebacterium, and Mangrovibacter.

According to the improvement method, the darkling beetle larvae may be mealworms and the plastic substrate may be PE. The PE may be degraded at 5-25 mg per 100 mealworms per day. The mealworms may have a gut comprising a microorganism selected from the group consisting of Clostridia, Enterococcus, Allobaculum, Romboutsia, Turicibacter, Lactobacillus, Muribaculacear, Pediococcus, Staphylococcus and Pseudomonas.

The improvement method may further comprise forming a C═O group, a C—OH group or a O=C—OH group on the plastic substrate. The plastic substrate may be PE, and the mealworms may have a gut comprising a microorganism selected from the group consisting of Staphylococcus lentus, Corynebacterium variable and Kocuria halorolerans.

The improvement method may further comprise modifying a surface of the plastic substrate. The plastic substrate may be PE, and the microorganism may be selected from the group consisting of Stapyhloccus lentus, Corynebacterium variabile and Kocuria halotolerans. The present invention also provides a method for degrading a plastic substrate by an microorganism. This microorganism degradation method comprises exposing a plastic substrate to an effective amount of an isolated microorganism such that the plastic substrate is degraded. This microorganism may be isolated from mealworms treated with a feed supplemented with oats. The feed may be supplemented with oats at 0.1-10 g per 100 mealworms every 1-10 days. The microorganism may be selected from the group consisting of Staphylococcus, Peptoniphilus, Brevibacterium, Helcococcus, Mannheimia, Trueperella, Pseudomonas, Corynebacterium, Mangrovibacterm Clostridia, Enterococcus, Allobaculum, Romboutsia, Turicibacter, Lactobacillus, Muribaculacear, Pediococcus, Staphylococcus and Pseudomonas. The microorganism may be selected from the group consisting of Kluyvera cryocresens, Staphylococcus lentus, Enterococcus termitis, Listeria fleischmannii, Mangrovibacter yixingensis, Corynebacterium variabile, Enterococcus faecalis, Brachybacterium nesterenkovii, Brevibacterium epidermidis, Lactococcus garvieae, Kocuria halotolerans, Staphylococcus gallinarum, Intestinirhabdus alba, Enterococcus sp. Enterococcaceae, and Enterococcus faecium. The plastic substrate may be selected from the group consisting of polystyrene (PS), polyethylene (PE), polypropylene (PP) and a combination thereof. The plastic substrate may be PS, and the microorganism may be selected from the group consisting of Staphylococcus, Peptoniphilus, Brevibacterium, Helcococcus, Mannheimia, Trueperella, Pseudomonas, Corynebacterium, and Mangrovibacter. The plastic substrate may be PE, and the microorganism may be selected from the group consisting of Clostridia, Enterococcus, Allobaculum, Romboutsia, Turicibacter, Lactobacillus, Muribaculacear, Pediococcus, Staphylococcus and Pseudomonas.

The microorganism degradation method may further comprise forming a C═O group on the plastic substrate. The plastic substrate may be PE, and the microorganism may be selected from the group consisting of Staphylococcus lentus, Corynebacterium variable and Kocuria halorolerans.

The microorganism degradation method may further comprise modifying a surface of the plastic substrate. The plastic substrate may be PE, and the microorganism may be selected from the group consisting of Stapyhloccus lentus, Corynebacterium variabile and Kocuria halotolerans. The present invention may further comprise a method for degradation of a plastic substrate by a peroxidase. This peroxidase degradation method comprises treating a plastic substrate with an effective amount of a peroxidase consisting of an amino acid sequence having at least 90% identity to the amino acid sequence of SEQ ID NO: 46 such that the plastic substrate is degraded. The peroxidase consists of the amino acid sequence of SEQ ID NO: 46. The peroxidase may be expressed recombinantly. The plastic substrate may be selected from the group consisting of polystyrene (PS), polyethylene (PE), polypropylene (PP) and a combination thereof. The peroxidase degradation method may further comprise forming a C═O bond on the plastic substrate. The peroxidase degradation method may further comprise incorporating a O=C—OH group into the plastic substrate. The peroxidase degradation method may further comprise forming a C—OH bond on the plastic substrate.

### BRIEF DESCRIPTION OF THE DRAWINGS

FIGS. 1A-C show impact of co-diet supplementation on mealworm polystyrene and polyethylene consumption. A) The effect of oats supplementation on mealworms fed with polystyrene on day 0 and day 7; B) The impact of oats supplementation on mealworms fed with polyethylene on day 0 and day 20. C) The graphical representation of the effect of four co-diet factors (Bran, Oats, Apple peels, and Banana peels) on the polystyrene consumption rate in red and polyethylene consumption rate in blue by the mealworms. The (+) and (−) symbolize the presence (+) or absence (−) of supplement source.

FIG. 2 shows improved growth of isolates on LDPE and UHMWPE powder relative to Mineral medium after 7 days of growth.

FIGS. 3A-D show scanning electron microscope (SEM) images of (A) UHWMPE particle control in mineral medium, (B) Biofilm formed by Staphylococcus lentus on the UHWMPE particle, (C) surface changes to UHMWPE after inoculation with Corynebacterium variable, (D) growth of Kocuria halorolerans on a UHMWPE particle.

FIG. 4 shows FTIR-ATR measurement of LDPE films after (7) 24 hour treatments of microbial culture onto the surface of the plastic film.

FIGS. 5A-B show degradation of LDPE film by Fourier transform infrared spectroscopy (FTIR) through the incorporation of (A) C═O bonds after activity by Dyp-type peroxidase from Corynebacterium variabile relative to a control of denatured peroxidase after direct inoculation of protein to the film, or (B) carboxylic acids after activity by Dyp-type peroxidase from Corynebacterium variabile relative to a control of denatured peroxidase at pH4, 30C in 1 mL of 50 mM buffer.

FIGS. 6A-B show (A) degradation of LDPE film by differential scanning calorimetry (DSC) through an increase in crystallinity after treatment with Dyp-type peroxidase from Corynebacterium variabile (P2) relative to a control of E. coli BL21 lysate without peroxidase (CTRL), and (B) inactivity of other tested enzymes (SEQ ID NOS: 23, 22, 20, 42, 40, 50, 26, 19 and 43) on the LDPE film via no observed change in crystallinity to the plastic film.

FIG. 7 shows degradation of LDPE film by Fourier transform infrared spectroscopy (FTIR) through the incorporation of C═O and O—H bonds after activity by saliva extracted from the yellow mealworm (Tenebrio molitor) relative to a control of denatured saliva.

FIG. 8 shows degradation of LDPE film by gel permeation chromatography through a decrease in molecular weight via the formation of a new peak around 1000 g/mol average molecular weight after treatment by saliva extracted from the yellow mealworm (Tenebrio molitor) relative to a control of denatured saliva.

### DETAILED DESCRIPTION OF THE INVENTION

The present invention relates to improvement of plastic degradation by darkling beetle larvae and plastic degradation with microorganism isolated from the darkling beetle larvae or enzymes isolated from the microorganisms. The present invention is based on the inventors' surprising discoveries of novel feed strategies for shaping the mealworm gut microbiome to more effectively eat and degrade plastics, novel enriched anaerobic and fungal species, including genera and species not previously associated with plastic degradation, and a peroxidase from C. variabile (SEQ ID NO: 46) active in plastic degradation. The present invention provides evidence for (1) methodology to improve plastic degradation by mealworms, (2) methodology for the discovery of microorganisms and enzymes capable of plastics degradation, (3) microorganisms from the mealworm gut capable of plastics degradation, and enzymes from the mealworm gut that degrade plastics.

The inventors have developed novel feed strategies to shape the mealworm gut microbiome to more effectively eat and degrade plastics. The feed strategies include supplementing feeds with oats, bran, apple peels and banana peels, cornmeal, wheat, milo, cereal, rice, corn, barley, sorghum, other grains, various vegetable wastes, oil wastes, and/or pre-treated polymer wastes, including polymers oxidized by various chemical means. The plastic substrates include PET in various forms, other polyesters, PVC, PE in various forms, PP in various forms, PS in various forms, co-polymers and polymer blends of the above. The success of these feed strategies may be measured using plastic mass lost, FT-IR, TGA, GPC or NMR. The inventors have discovered changes in the composition of the microbiome shaped by the feeding strategies based on evaluation using 16S and ITS profiling, and metagenomics. The inventors have identified a prebiotic, the feed (oats, bran, etc.), in particularly beneficial feeds, and performed cultivated microbiome on plastic degradation. In particular, the inventors have discovered novel anaerobic and fungal species enriched, including novel genera and species not previously associated with plastic degradation.

The inventors have improved consumption rate of plastics by co-feeding. The inventors have also isolated microorganisms from the mealworm gut capable of degrading low density polyethylene (LDPE) and develop a protocol for demonstrating microbial degradation of plastic films. The inventors have further identified enzyme families that are expected to be active on plastic substrates, and proved the methodology through the identification of an enzyme, Dyp-type peroxidase from Corynebacterium variable, that is active on LDPE films.

In particular, the inventors have improved the consumption rate by co-feeding plastic substrates with dietary supplements, namely oats. The consumption rate of PS beads and LDPE beads by the yellow mealworm was improved by supplementing 1 g of oats per 100 mealworms every 3 days to obtain degradation rates of 71.4 and 15.2 mg plastic per 100 larvae per day, respectively. Feeding mealworms plastic beads, supplemented every 3 days with 1 g of oats, led to an optimized gut microbiome for plastic consumption rate.

The inventors have identified microorganisms from the gut of the yellow mealworm that are able to degrade plastics after inoculation on plastic films. Demonstrated by Fourier transform infrared spectroscopy (FTIR) and scanning electron microscopy (SEM), inoculating worm gut isolates onto plastic (LDPE) films daily led to the degradation of plastic films observed by the formation of C═O groups on the plastic films, and inoculating worm gut isolates in MM with plastic (LDPE or UHMWPE) powder for 7 days led to surface modification of plastic.

The inventors have discovered that oxygenases (e.g., monooxygenases and dioxygenases) and peroxidases from the mealworm gut or salivary microbiomes are useful for degrading plastic substrates, and may be expressed by recombinant cells (e.g., E. coli).

The term “plastic degradation” as used herein refers to degradation of a plastic substrate such as polystyrene (PS), polyethylene (PE), and polypropylene (PP). The plastic degradation may involve chemical modifications and depolymerization. Chemical modifications may be measured by methods such as Fourier Transform Infrared Spectroscopy (FTIR), x-ray photoelectron spectroscopy, NMR, differential scanning calorimetry. Depolymerization may be measured by methods such as Gel Permeation Chromatography.

The term “effective amount” as used herein refers to an amount sufficient to achieve a specific goal, for example, plastic degradation.

The term “darkling beetle larvae” as used herein refers to an active immature form of a member of the beetle family Tenebrionidae. Examples of the darkling beetle larvae include all species of Tenebrio molitor, Zophobas morio, and Plesiophthalmus davidis.

The term “mealworm” as used herein refers the larval form of the yellow mealworm beetle, Tenebrio molitor, a species of darkling beetle.

The present invention provides a method for improving degradation of a plastic substrate. The improvement method comprises treating darkling beetle larvae with a feed supplemented with one or more dietary supplements, and exposing a plastic substrate to an effective amount of the darkling beetle larvae. As a result, the plastic substrate may be degraded by the darkling beetle larvae at a rate higher than that by darkling beetle larvae treated with the feed not supplemented with the oats.

The dietary supplement may be selected from the group consisting of oats, bran, apple peels and banana peels, cornmeal, wheat, milo, cereal, rice, corn, barley, sorghum, other grains, various vegetable wastes, oil wastes, pre-treated polymer wastes, and a combination thereof. The pre-treated polymer wastes include polymers oxidized by various chemical means. The feed may be supplemented with the dietary supplement at, example 0.1-10 g per 100 mealworms every 1-10, 1-5, 1-4, 1-3 or 1-2 days.

The dietary supplement may be oats. The feed may be supplemented with oats, example, 0.1-10 g per 100 mealworms every 1-10, 1-5, 1-4, 1-3 or 1-2 days.

The darkling beetle larvae may be treated with the feed supplemented with oats on the plastic substrate. The plastic substrate may be exposed to the darkling beetle larvae for 1-180, 1-90, 1-60, 1-30, 1-20, 1-10 or 1-5 days.

The plastic degradation rate may be improved by about 2-100, 2-50, 2-10 or 2-5 folds, or at least about 2, 5, 10, 50 or 100 folds. Where the plastic substrate is polystyrene (PS), the PS degradation rate may be improved by about 2-100, 2-50, 2-10 or 2-5 folds, or at least about 2, 5, 10, 50 or 100 folds. Where the plastic substrate is LDPE, the LDPE degradation rate may be improved by about 2-100, 2-50, 2-10 or 2-5 folds, or at least about 2, 5, 10, 50 or 100 folds.

The darkling beetle larvae may be larvae of a darkling beetle selected from the group consisting of Zophobas species (e.g., Zophobas moire), Tenebrio species (e.g., Tenebrio obscurus), and Plesiophthalmus species (e.g., Plesiophthalmus davidis). The darkling beetle larvae may be mealworms, the larval form of the yellow mealworm beetle, Tenebrio molitor, a species of darkling beetle.

An effective amount of the darkling beetle larvae is an amount of the darkling beetle larvae sufficient for degradation of a plastic substrate by, for example, 1-100%, 1-90%, 1-80%, 1-50%, 1-20%, 1-10%, 1-5%, 10-100%, 10-90%, 10-80%, 10-50%, 10-20%, 10-10%, 50-100%, 50-90%, 50-80%, 80-100%, 80-90%, or 90-100%, or at least 10%, 20%, 30%, 40%, 50%, 60%, 70%, 80%, 90%, 95%, 99% or 100%, based on the weight of the plastic substrate after exposing the plastic substrate to the darkling beetle larvae for a predetermined time, for example, about 1-90, 1-60, 1-30, 1-20, 1-10 or 1-5 days, or within about 90, 60, 30, 20, 10 or 5 days. The effective amount of the darkling beetle larvae may vary depending on the amount and nature of the plastic substrate to degrade.

An effective amount of the mealworm is an amount of the darkling beetle larvae sufficient for degradation of a plastic substrate by, for example, 1-100%, 1-90%, 1-80%, 1-50%, 1-20%, 1-10%, 1-5%, 10-100%, 10-90%, 10-80%, 10-50%, 10-20%, 10-10%, 50-100%, 50-90%, 50-80%, 80-100%, 80-90%, or 90-100%, or at least 10%, 20%, 30%, 40%, 50%, 60%, 70%, 80%, 90%, 95%, 99% or 100%, based on the weight of the plastic substrate after exposing the plastic substrate to the mealworm for a predetermined time, for example, about 1-90, 1-60, 1-30, 1-20, 1-10 or 1-5 days, or within about 90, 60, 30, 20, 10 or 5 days. The effective amount of the mealworms may vary depending on the amount and nature of the plastic substrate to degrade.

The darkling beetle larvae, for example, mealworms, may have a gut comprising a microorganism selected from the group consisting of Staphylococcus, Peptoniphilus, Brevibacterium, Helcococcus, Mannheimia, Trueperella, Pseudomonas, Corynebacterium, Mangrovibacterm Clostridia, Enterococcus, Allobaculum, Romboutsia, Turicibacter, Lactobacillus, Muribaculacear, Pediococcus, Staphylococcus and Pseudomonas. The darkling beetle larvae, for example, mealworms, may have a gut comprising a microorganism selected from the group consisting of Kluyvera cryocresens, Staphylococcus lentus, Enterococcus termitis, Listeria fleischmannii, Mangrovibacter yixingensis, Corynebacterium variabile, Enterococcus faecalis, Brachybacterium nesterenkovii, Brevibacterium epidermidis, Lactococcus garvieae, Kocuria halotolerans, Staphylococcus gallinarum, Intestinirhabdus alba, Enterococcus sp. Enterococcaceae, and Enterococcus faecium. The mealworms may have a gut comprising a microorganism selected from the group consisting of Staphylococcus, Peptoniphilus, Brevibacterium, Helcococcus, Mannheimia, Trueperella, Pseudomonas, Corynebacterium, and Mangrovibacter. The mealworms may have a gut comprising a microorganism selected from the group consisting of Staphylococcus lentus, Corynebacterium variable and Kocuria halorolerans.

The darkling beetle larvae, for example, mealworms, may have saliva comprising a microorganism selected from the group consisting of Staphylococcus, Peptoniphilus, Brevibacterium, Helcococcus, Mannheimia, Trueperella, Pseudomonas, Corynebacterium, Mangrovibacterm Clostridia, Enterococcus, Allobaculum, Romboutsia, Turicibacter, Lactobacillus, Muribaculacear, Pediococcus, Staphylococcus and Pseudomonas. The darkling beetle larvae, for example, mealworms, may have a saliva comprising a microorganism selected from the group consisting of Kluyvera cryocresens, Staphylococcus lentus, Enterococcus termitis, Listeria fleischmannii,Mangrovibacter yixingensis, Corynebacterium variabile, Enterococcus faecalis, Brachybacterium nesterenkovii, Brevibacterium epidermidis, Lactococcus garvieae, Kocuria halotolerans, Staphylococcus gallinarum, Intestinirhabdus alba, Enterococcus sp. Enterococcaceae, and Enterococcus faecium. The mealworms may have a saliva comprising a microorganism selected from the group consisting of Staphylococcus, Peptoniphilus, Brevibacterium, Helcococcus, Mannheimia, Trueperella, Pseudomonas, Corynebacterium, and Mangrovibacter. The mealworms may have a saliva comprising a microorganism selected from the group consisting of Staphylococcus lentus, Corynebacterium variable and Kocuria halorolerans.

The plastic substrate may be selected from the group consisting of polystyrene (PS), polyethylene (PE), polypropylene (PP) and a combination thereof. The PE may be low density polyethylene (LDPE), high density polyethylene (HDPE) or Ultra-High Molecular Weight PE (UHMWPE).

Where the darkling beetle larvae are mealworms and the plastic substrate is PS, the PS may be degraded at 60-80 mg per 100 mealworms per day.

The darkling beetle larvae may be mealworms and the plastic substrate may be PE. The PE may be LDPE or UHMWPE. The PE (e.g., LDPE) may be degraded at 5-25mg per 100 mealworms per day. The mealworms may a gut comprising a microorganism selected from the group consisting of Clostridia, Enterococcus, Allobaculum, Romboutsia, Turicibacter, Lactobacillus, Muribaculacear, Pediococcus, Staphylococcus and Pseudomonas.

The improvement method may further comprise forming a C═O group, a C—OH group and/or a O=C—OH group on the plastic substrate. The plastic substrate may be PE (e.g., LDPE), and the mealworms may have a gut comprising a microorganism selected from the group consisting of Staphylococcus lentus, Corynebacterium variable and Kocuria halorolerans.

The improvement method may further comprise modifying a surface of the plastic substrate. The plastic substrate may be PE (e.g., LDPE or UHMWPE), and the microorganism may be selected from the group consisting ofStapyhloccus lentus, Corynebacterium variabile and Kocuria halotolerans.

The present invention also provides a microorganism degradation method for degrading a plastic substrate. The microorganism degradation method comprises exposing a plastic substrate to an effective amount of an isolated microorganism so that the plastic substrate is degraded.

The microorganism may be isolated from the darkling beetle larvae, for example, mealworms, treated with a feed supplemented with one or more dietary supplement according to the present invention. The microorganism may be selected from the group consisting of Staphylococcus, Peptoniphilus, Brevibacterium, Helcococcus, Mannheimia, Trueperella, Pseudomonas, Corynebacterium, Mangrovibacterm Clostridia, Enterococcus, Allobaculum, Romboutsia, Turicibacter, Lactobacillus, Muribaculacear, Pediococcus, Staphylococcus and Pseudomonas. The microorganism may be selected from the group consisting of Kluyvera cryocresens, Staphylococcus lentus, Enterococcus termitis, Listeria fleischmannii, Mangrovibacter yixingensis, Corynebacterium variabile, Enterococcus faecalis, Brachybacterium nesterenkovii, Brevibacterium epidermidis, Lactococcus garvieae, Kocuria halotolerans, Staphylococcus gallinarum, Intestinirhabdus alba, Enterococcus sp. Enterococcaceae, and Enterococcus faecium.

According to the microorganism degradation method, the plastic substrate may be selected from the group consisting of polystyrene (PS), polyethylene (PE), polypropylene (PP) and a combination thereof. The PE may be low density polyethylene (LDPE), high density polyethylene (HDPE) or Ultra-High Molecular Weight PE (UHMWPE).

An effective amount of the microorganism is an amount of the microorganism sufficient for degradation of a plastic substrate by, for example, 1-100%, 1-90%, 1-80%, 1-50%, 1-20%, 1-10%, 1-5%, 10-100%, 10-90%, 10-80%, 10-50%, 10-20%, 10-10%, 50-100%, 50-90%, 50-80%, 80-100%, 80-90%, or 90-100%, or at least 10%, 20%, 30%, 40%, 50%, 60%, 70%, 80%, 90%, 95%, 99% or 100%, based on the weight of the plastic substrate after exposing the plastic substrate to the microorganism for a predetermined time, for example, about 1-90, 1-60, 1-30, 1-20 , 1-10 or 1-5 days, or within about 90, 60, 30, 20, 10 or 5 days.

According to the microorganism degradation method, the plastic substrate may be PS, and the microorganism may be selected from the group consisting of Staphylococcus, Peptoniphilus, Brevibacterium, Helcococcus, Mannheimia, Trueperella, Pseudomonas, Corynebacterium, and Mangrovibacter.

According to the microorganism degradation method, the plastic substrate is PE, and the microorganism is selected from the group consisting of Clostridia, Enterococcus, Allobaculum, Romboutsia, Turicibacter, Lactobacillus, Muribaculacear, Pediococcus, Staphylococcus and Pseudomonas. The PE may be LDPE or UHMWPE.

The microorganism degradation method may further comprise forming a C═O group on the plastic substrate. The plastic substrate may be PE (e.g., LDPE), and the microorganism may be selected from the group consisting of Staphylococcus lentus, Corynebacterium variable and Kocuria halorolerans.

The microorganism degradation method may further comprise modifying a surface of the plastic substrate. The modification may include formation of an oxygenated species such as alcohols, aldehydes, ketones, esters, and acids. The plastic substrate may be PE (e.g., LDPE or UHMWPE), and the microorganism may be selected from the group consisting of Stapyhloccus lentus, Corynebacterium variabile and Kocuria halotolerans.

The present invention further provides an enzymatic degradation method. The enzymatic degradation method comprises treating a plastic substrate with an effective amount of an isolated enzyme. As a result, the plastic substrate is degraded. The enzyme may be selected from the group consisting of oxygenases and peroxidases. The oxygenase may be a monooxygenase or a dioxygenase.

The enzyme may be a monooxygenase from darkling beetle larvae, for example, mealworms. The enzyme may consist of an amino acid sequence at least 80%, 85%, 90%, 95% or 99% identical to an amino acid sequence selected from SEQ ID NOS: 3-13, 17, 19, 24-39, 43-45, 50-57, 65-73, 77 and 78. The enzyme may consist of the amino acid sequence selected from SEQ ID NOS: 3-13, 17, 19, 24-39, 43-45, 50-57, 65-73, 77 and 78.

The enzyme may be a dioxygenase from darkling beetle larvae, for example, mealworms. The enzyme may consist of an amino acid sequence at least 80%, 85%, 90%, 95% or 99% identical to an amino acid sequence selected from SEQ ID NOS: 1, 2, 14-16, 18, 20, 21, 40-42, 49, 58-64, 74-76, 80 and 81. The enzyme may consist of the amino acid sequence selected from SEQ ID NOS: 1, 2, 14-16, 18, 20, 21, 40-42, 49, 58-64, 74-76, 80 and 81.

The enzyme may be a peroxidase from darkling beetle larvae, for example, mealworms. The enzyme may consist of an amino acid sequence at least 80%, 85%, 90%, 95% or 99% identical to an amino acid sequence selected from SEQ ID NOS: 22, 23, 46-48 and 79. The enzyme may consist of the amino acid sequence selected from SEQ ID NOS: 22, 23, 46-48 and 79.

The enzyme may consist of an amino acid sequence at least 80%, 85%, 90%, 95% or 99% identical to an amino acid sequence selected from SEQ ID NOS: 19, 20, 22, 23, 26, 30, 40, 42, 43, 46. The enzyme may consist of the amino acid sequence selected from SEQ ID NOS: ? , 19, 20, 22, 23, 26, 30, 42, 43 and 46.

The enzyme may consist of an amino acid sequence at least 80%, 85%, 90%, 95% or 99% identical to the amino acid sequence of SEQ ID NO: 46. The enzyme may be Dyp-type peroxidase from Corynebacterium variable (SEQ ID NOS: 46).

The enzyme may be isolated from darkling beetle larvae (e.g., mealworm), for example, the gut or saliva microbiome of the darkling beetle larvae (e.g., mealworm). The enzyme may be expressed recombinantly.

The oxygenase may be isolated from darkling beetle larvae (e.g., mealworm), for example, the gut or saliva microbiome of the darkling beetle larvae (e.g., mealworm). The oxygenase may be expressed recombinantly.

The monooxygenase may be isolated from darkling beetle larvae (e.g., mealworm), for example, the gut or saliva microbiome of the darkling beetle larvae (e.g., mealworm). The monooxygenase may be expressed recombinantly.

The dioxygenase may be isolated from darkling beetle larvae (e.g., mealworm), for example, the gut or saliva microbiome of the darkling beetle larvae (e.g., mealworm). The dioxygenase may be expressed recombinantly.

The peroxidase may be isolated from darkling beetle larvae (e.g., mealworm), for example, the gut or saliva microbiome of the darkling beetle larvae (e.g., mealworm). The peroxidase may be expressed recombinantly.

The plastic substrate may be selected from the group consisting of polystyrene (PS), polyethylene (PE), polypropylene (PP) and a combination thereof. The PE may be low density polyethylene (LDPE), high density polyethylene (HDPE) and Ultra-High Molecular Weight PE (UHMWPE).

The enzymatic degradation method may further comprise forming a C═O group, a C—OH group and/or a O=C—OH group on the plastic substrate.

The enzymatic degradation method may further comprise forming a C═O bond on the plastic substrate. The plastic substrate may be a LDPE film.

The enzymatic degradation method may further comprising incorporating a O=C—OH group into the plastic substrate. The plastic substrate may be a LDPE film. The enzymatic degradation method may further comprising forming a C—OH bond on the plastic substrate. The plastic substrate may be a LDPE film.

According to the enzymatic degradation method, the plastic substrate may be PE (e.g., LDPE film), and the enzyme may be Dyp-type peroxidase from Corynebacterium variable (SEQ ID NO: 46).

The term “about” as used herein when referring to a measurable value such as an amount, a percentage, and the like, is meant to encompass variations of +20% or +10%, more preferably #5%, even more preferably #1%, and still more preferably +0.1% from the specified value, as such variations are appropriate.

### Example 1. Feeding Strategies Improve Plastic Degradation by Mealworms

A study was carried out to develop effective feeding strategies for improving plastic degradation by mealworms.

### A. Materials and Methods

Materials: Mealworms, larvae of T. molitor Linnaeus, (average weight 75-85 mg/worm) were purchased from Rainbow Mealworms (Compton, CA) and shipped overnight to the laboratories at the University of Delaware. Prior to arrival, the mealworms were fed bran; after arrival, they were subject to a 48 h starvation period before initiating experimental diets. PS foam beads (1.0 cm diameter) and LDPE pellets (3 mm) were used as feedstocks and were purchased from Amazon and Sigma Aldrich, respectively (add a correct citation and catalog number). Bran and oats were purchased from Amazon (add the correct citation and catalog number). Apple peels and banana peels were collected from different sources and brought to the lab where they were dried overnight at 50° C. and 50% humidity and crushed manually into pieces smaller than 0.5 centimeters. Apple and Banana peels were immediately used upon crushing.

Mealworm growth/development: Twelve treatments were prepared for each plastic based on feeding conditions generated by the Plackett Burman design as described in Supplementary table 1. Co-diet treatments were initially supplied with PS or LDPE (0.5 g) plus the food supplement (1.0 g) for T. molitor. Afterward, an additional 1.0 g of food source was supplemented every 4 days. The experiment was performed in duplicate.

Plastic consumption and mealworm survival analysis: Based on mass loss over incubation time, PS and LDPE consumption were determined by weighing residual PS foam on the 7th day and LDPE bead on the 20^{th} day. [1] Survival rates (SRs) of T. molitor larvae were determined by counting the number of living larvae every 3 days and the test ended on day 7 for PS and day 20 [2] for LDPE. Dead bodies of larvae were removed immediately to reduce the mass consumed by cannibalism. The PS and LDPE consumption rates were calculated based on the mass of PS and LDPE consumed per 100 larvae per day (mg PS.100 larvae—1.d—1) and the rates were measured on day 7 for PS runs and on day 20 for LDPE runs. At the end of the test, the larvae were cleansed of residual PS and LDPE debris, and frass was collected using sieves. [3] Frass samples were stored at 4° C. for further analysis.

Statistical Analysis: Statistical analyses were performed in Minitab Statistical Software (version to be checked). To assess differences in plastic consumption Plackett-Burman (PB) designs were used for screening experiments, followed by pairwise comparisons using Student's t-test with Tukey's correction to assess differences between diets. All p-values are adjusted p-values and all error values are average +standard deviation.

Microbial community analysis—16s and ITS profiling For DNA analyses, 10 larvae were randomly selected for gut extraction and the material was stored at −80° C. The experiments were conducted in triplicate.

At the end of the 7-day (PS experiment), and 20-day (LDPE experiment), the gut content of each sample (ten mealworms from the same container pooled to eliminate individual variability) was extracted and washed by vertexing the guts with 1000 μL of PBS buffer. Gut walls were removed, and DNA was extracted using the PureLink™ Microbiome DNA Purification Kit (Invitrogen™).

Amplicon sequencing was used to sequence the V4-V3 region of 16S rDNA and ITS2 region of 18S rDNA. Library construction and sequencing (2×250 bp paired end reads, Illumina MiSeq) were sent to a sequencing company (Novogene, China). Sequencing reads were filtered and taxonomically assigned using QIIME 2.

### B. Results

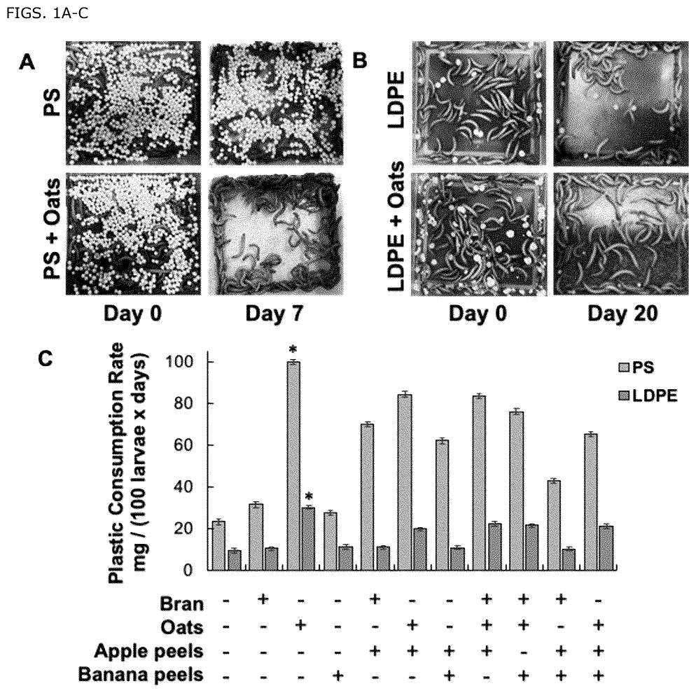

The impact of co-diet supplementation on mealworm polystyrene and polyethylene consumption is shown in FIG. 1. A) The effect of oats supplementation on mealworms fed with polystyrene on day 0 and day 7; B) The impact of oats supplementation on mealworms fed with polyethylene on day 0 and day 20. C) The graphical representation of the effect of four co-diet factors (Bran, Oats, Apple peels, and Banana peels) on the polystyrene consumption rate in light grey and polyethylene consumption rate in dark grey by the mealworms. The (+) and (−) symbolize the presence (+) or absence (−) of supplement source.

### C. Conclusion

The consumption rate of PS beads and LDPE beads by the yellow mealworm was maximized by supplementing 1 g of oats per 100 mealworms every 3 days to obtain degradation rates of 71.4 and 15.2 mg plastic per 100 larvae per day, respectively.

Feeding mealworms plastic beads, supplemented every 3 days with 1 g of oats, led to an optimized gut microbiome for LDPE consumption rate, rich in the following genera per sequencing of the 16s V3-V4 region: Clostridia, Enterococcus, Allobaculum, Romboutsia, Turicibacter, Lactobacillus, Muribaculacear, Pediococcus, Staphylococcus and Pseudomonas.

Feeding mealworms plastic beads, supplemented every 3 days with 1 g of oats, led to an optimized gut microbiome for PS consumption rate, rich in the following genera per sequencing of the 16s V3-V4 region: Staphylococcus, Peptoniphilus, Brevibacterium, Helcococcus, Mannheimia, Trueperella, Pseudomonas, Corynebacterium, and Mangrovibacter.

### Example 2. Newly Identified Microorganisms Capable of Plastic Degradation

Microorganisms were isolated from mealworms and tested for plastic degradation.

### A. Materials and Methods

Microbial isolation: Mealworm guts from communities enriched with LDPE, HDPE, PS, and PP communities were extracted from communities enriched on plastic or plastic cofed with oats after 10, 15, or 20 days of enrichment on each dietary condition. 10 guts were extracted from each mealworm, resuspended in 1 mL of sterile phosphate buffered saline (PBS), vortexed for 10 minutes to break open the guts, and residual liquid was plated onto the following types of bacterial media plates: Blood agar, Tryptic Soy agar, Nutrient agar, LB agar, and Potato Dextrose agar. Unique microbes were selected via colony morphology and color and plated onto fresh agar plates of the media from which they were isolated. Individual colonies of each microorganism were picked and isolated onto fresh agar plates to ensure only one species was captured.

Isolate Identification: Individual isolates were sequenced using the 16S V3-V4 region to taxonomically identify each organism. Sequence alignment was used to reveal unique microbes. Any microorganisms with any base pair mismatches from other isolated strains were considered unique.

Media/growth screening conditions: Each unique isolate was screened on a bacterial mineral medium with LDPE powder (Catalog #needed) or Ultra-High Molecular Weight PE (UHMWPE, Catalog #needed) as the primary carbon source. Media includes 2 g NaH₂PO₄, 0.5 g MgSO₄*7H₂O, 0.2 g KH₂PO₄, and 1 g Yeast Extract per 1 L of media. Mineral medium was supplemented with 0.3% w./v. LDPE powder or UHMWPE powder. Each isolate was grown in MM, in MM with 0.3% with LDPE powder, and in MM with 0.3% UHMWPE powder in triplicate at 30° C. shaking at 250 rpm. Growth was measured via optical density through absorbance measurement at 600 nm using a spectrophotometer. Improved growth on media with plastic powders relative to media without plastic.

SEM Work: Microorganisms isolated from mealworm guts were grown on plastic films in liquid media for 60 days. The films were cleaned with ethanol, dried and platinum coated prior to running SEM. Apreo VolumeScope Scanning Electron Microscope in the University of Delaware Bioimaging center was used to image the films.

FTIR conditions: The functional groups of the extracted residual PS and LDPE polymers from the frass were characterized by Fourier transform infrared spectroscopy (FTIR) (Thermo Scientific Nicolet iS5 FTIR Spectrometer, Pittsburgh, PA, the USA). Spectra were recorded from the residual polymers after treatment in FTIR-ATR absorbance mode. Spectra were recorded in the range of 4000-500 cm⁻¹ with a minimum of 64 scans with a spectral resolution of 0.482 cm⁻¹.

### B. Results

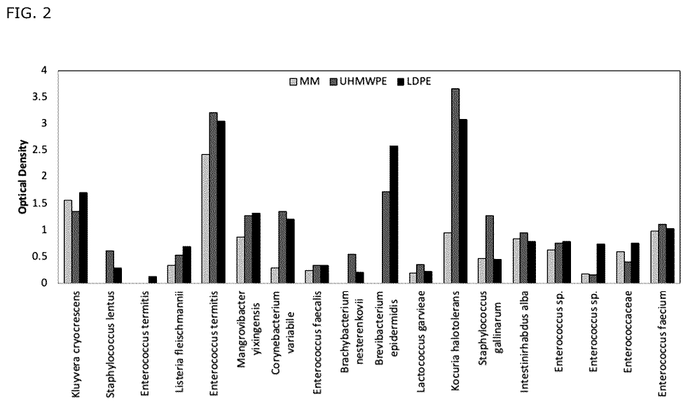

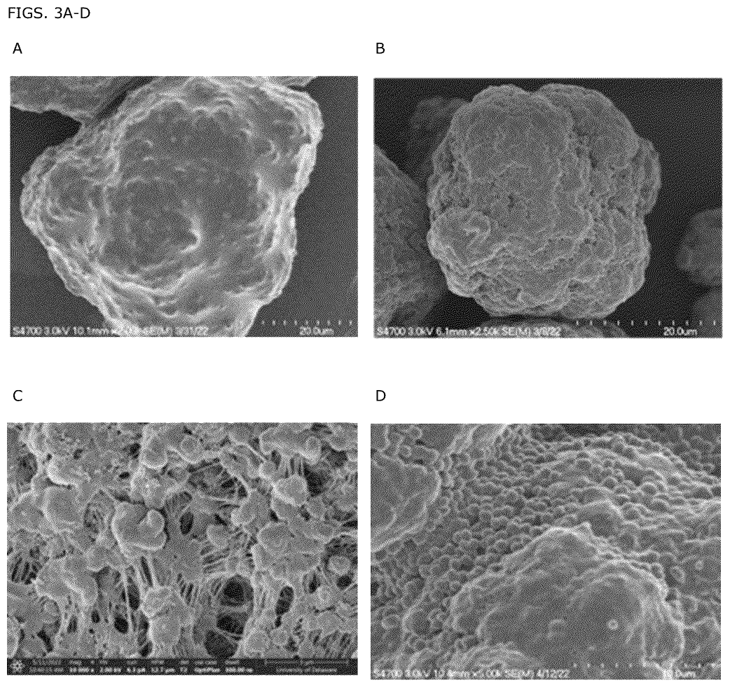

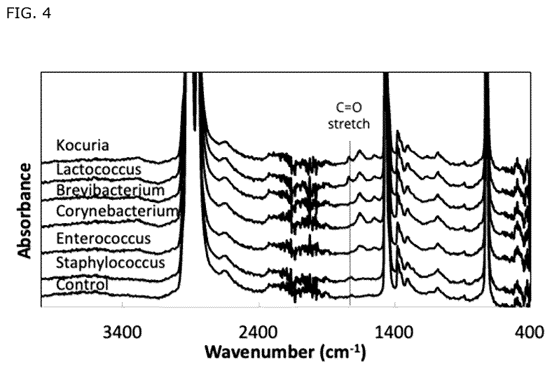

18 isolates obtained from mealworms showed improved growth on LDPE and UHMWPE powder relative to Mineral medium after 7 days of growth (FIG. 2). SEM images show a biofilm formed by Staphylococcus lentus on the UHWMPE particle, surface changes to UHMWPE after inoculation with Corynebacterium variable, and growth of Kocuria halorolerans on a UHMWPE particle (FIGS. 3A-D). The LDPE films were measured by FTIR-ATR after (7) 24 hour treatments of microbial culture onto the surface of the plastic film (FIG. 4).

### C. Conclusion

Inoculating worm gut isolates onto plastic (LDPE) films daily led to the degradation of plastic films observed by the formation of C═O groups on the plastic films. Stapyhloccus lentus, Lactococcus garvieae, and Kocuria halotolerans incorporated C═O bonds onto the LDPE films.

Inoculating worm gut isolates in MM with plastic (LDPE or UHMWPE) powder for 7 days led to surface modification of plastic via scanning electron microscopy. Stapyhloccus lentus, Corynebacterium variabile, and Kocuria halotolerans modified the surface of the UHMWPE particles.

### Example 3. Isolated Enzyme Responsible for Plastic Degradation

Enzymes were isolated from mealworm communities to determine their impact on plastic degradation.

### A. Materials and Methods

Saliva extraction: Saliva was extracted from yellow mealworms by simply inserting a syringe into the mouth of the insect and slowly drawing liquid back into the syringe.

FTIR conditions: The functional groups of the extracted residual PS and LDPE polymers from the frass were characterized by Fourier transform infrared spectroscopy (FTIR) (Thermo Scientific Nicolet iS5 FTIR Spectrometer, Pittsburgh, PA, the USA). Spectra were recorded from the residual polymers after treatment in FTIR-ATR absorbance mode. Spectra were recorded in the range of 4000-500 cm⁻¹ with a minimum of 64 scans with a spectral resolution of 0.482 cm⁻¹.

GPC conditions: Residual polymer was dissolved in 1,2,4-trichlorobenzene (≥99%, Alfa Aesar, Haverhill, MA) to obtain a final concentration of approximately 5 mg/mL. Duplicate analyses for each sample were run at 180° C. with a 100 μL injection volume with an eluent (1,2,4-trichlorobenzene) flow rate of 1.0 mL.min⁻¹ (EcoSEC High-Temperature GPC System, Tosoh Biosciences).

Enzyme denaturation was carried out by adding sodium dodecyl sulfate (SDS) to enzyme solution to a final concentration of 1% v/v and heating the enzyme solution at 95C for 15 minutes.

DSC conditions: LDPE films were treated with purified enzyme on the film surface. Films were cleaned with water and 70% ethanol and allowed to dry. Dried films were weighed and analyzed on the TA instruments Discovery DSC in the Advanced Materials Characterization Lab at the University of Delaware by heating the sample from 30° C. to 250° C., cooling back from 250° C. to 30° C. and subsequently heating back to 250° C. All heating and cooling steps were performed at a rate of 10° C. per minute. Crystallinity was calculated by integrating by simply using a ratio of the enthalpy of melting of the treated film to the value for the enthalpy of melting of a 100% crystalline LDPE, 290 J/g. This ratio is the % crystallinity of the sample.

Enzyme identification: Enzymes were identified by using an annotated genome of each isolate, or microbial community and identifying proteins identified as monooxygenase, dioxygenase, and peroxidase via protein family (pfam) annotation. Gene counts of enzymes in pfam families corresponding to monooxygenase, dioxygenase, and peroxidase families were taken from the genome of each microbial isolate. The gene count in these genomes were then compared to the average gene count in the bacterial order in which the species falls. A Fisher's t-test was used to determine which pfam groups have a statistically significant higher number of genes than the closely related microbes that fall within the taxonomic order. Genes from these pfam groups that passed the Fisher's t-test are those genes included in Table 1.

TABLE 1
Enzymes

| | | | SEQ |
|---|---|---|---|
| Enzyme | | | ID |
| type | Organism | Sequence | NO: |
| Dioxygenase | Kocuria | MDIRLENVGIAVRDLEAAIAFFTDLGLAVLGRDTVSGEWADT | 1 |
| | halotolerans | AVGLDGNHARIAMLQTPDGTGRLELFEYLHPEAIETEPTLPNE | |
| | | IGMHRVAFAVEDLDAALEIAAKHGCRPLRGVATYQDVYRLTY | |
| | | LRGPSGIIVMLAEELKKG | |
| Dioxygenase | Kocuria | MSRHPIADDAAPSAGIPGLRGSDHIGFTVPDMEEAHDFLIRV | 2 |
| | halotolerans | LGCVHVYTLGPYPTGAEIAARLDIGQDALMEQIRFYRCRTGV | |
| | | NFEVFQYADPGQRADPPRNSDIGGHHVAFYVDDLDAAVLWL | |
| | | QENAVEVLAGPNLSSGPSEGQRWIYFRAPWGMYFELVSFPG | |
| | | GKAYEREAGTLLWDCRTPQD | |
| Monooxy- | Kocuria | MTRPMLLNAFDMLVPVHQSPGLWRHPESGVAGFDRLDYWV | 3 |
| genase | halotolerans | ELAETLEEGGFASLFLADIPGIYDVYGGDGAATARGGVQYPLL | |
| | | DPLVVVPAMARATRTLGFGVTASVTYEQPYLLARTLSTLDHFT | |
| | | EGRVAWNIVTSYQDSAARNLGMSGQIPHDERYDRADEYME | |
| | | VMYKLFEGSVDDDAVRADPEANVFVDPERVRPIEHEGRWFS | |
| | | VPGAALTHPGPQRTPLLFQAGASKRGQQFATDHAEAIFFSGG | |
| | | TPELVRGWVEGVRDSVEAAGRPRDAVKIFSLATVIVAETDDQ | |
| | | AQRRLEEYRELVDTESALALFGGWTGVDLSGADPDSTLEYVA | |
| | | TDANQSALASFTTLAGGRKWTVRDLAEFVAIGGRGPVIVGSP | |
| | | QTVADELERWQEEAGVDGFNVSAAVRPADLERFSRLVSPEL | |
| | | RRRGLLPEADAVPAATLRERLTGSGPHLPAEHRGASYRRTSA | |
| | | VAAGRG | |
| Monooxy- | Kocuria | MDLPLSLLDRSRTRAGSPDAQALRNTVERAEAAEEAGYSRF | 4 |
| genase | halotolerans | WVAEHHAVPGIASGSPPLLMQAVAQATRRIRVGSGGIMLPN | |
| | | HRPILVAEQLAVLTALHGPRFDLGVGRSLGFTRPVREALGALS | |
| | | ARPEEFLADIRSLRDHLEGGAAVTVRPAGVPAPPIHVLGTGA | |
| | | GLRFAAELGLPAVVGGPALRGGPEPFERYRRDFRPSERFPEPH | |
| | | LIASADILVADSQAEADELALPEAWAMAEARSAGAFPPLVPP | |
| | | GRVPEDPGPRRRRTVEETLEGTIAGTEDRVLTELAELLERTGA | |
| | | DEVMSTASTFDLDALRASDRRLAVAVRAA | |
| Monooxy- | Kocuria | MPEHAAHSPETAPARTAARNGAAVRVRLNAFDMNCVGHQS | 5 |
| genase | halotolerans | PGLWRHPEDRSASYKDLGYWTGLAQTLERGLFDGIFIADVL | |
| | | GTYDVYGGSNEATLRAGTQVPVNDPLLLVSGMAAVTEHLGF | |
| | | GVTAGTAYEHPYSFARRLSTLDHATRGRLGWNIVTGYLPSAA | |
| | | RNFGNADQLEHDERYEHAEDYLQVVYKLLEGSWEDDAVVR | |
| | | DAGSATFTDPSRVHEIDHRGEYFTVPGIHLCEPSPQRTPVLF | |
| | | QAGASKRGTRFAAENAECVFVASPNRTHLRETVTRLRDAVEA | |
| | | AGRPRDSIRVYTLLTVVTGPTDEAAHAKHRELQGYVDHEGAL | |
| | | TLISGWMGLDLSGFDLDEPLGNVKSNAIHSAIETFQKVNEDG | |
| | | RPWTVRDIAEFVGIGGFGPRIVGSGESVARELVEWVEETGV | |
| | | DGFNLAYAITPGTFEDVVEYVVPELRRLGAYPEQYEEGTLRHK | |
| | | LFGAGDRLPEGHPGRVAGEAVRAAASAGAATDERREPAHAG | |
| | | AGAASGPGGRA | |
| Monooxy- | Kocuria | MSALRFHWFLPTGGDSRGIVSGGHGAEVGFTAAGRPPELSY | 6 |
| genase | halotolerans | LRQVAQAAETNGFEAVLTPTGLWCQDSWLMTSALAQHTERL | |
| | | KFLVAFRPGSLTPTLGAQMAETFQNVTGGRLALNIVTGGESA | |
| | | EQRAFGDFLDKTGRYERTGEFLDILSRLWDGGDPFDYRGRH | |
| | | LSVEGAQLAHLPEPRPEIYFGGSSAPAGEVAARHSDVYLTWG | |
| | | EPPAQAREKIEWIRGLAAEQGRRPRFGIRLHTISRDTSAEAW | |
| | | AVAERLLRDVPEELIARQQSALAASESTGQRRMLDLHGGRTA | |
| | | DLEIHPGLWAGVGLLRGGAGTSLVGSHEEVAALIEEYAEAGF | |
| | | EEFVLSGYPCLEEAYWFGEGVRPVLERKGLLGTRQDDALVPA | |
| | | AG | |
| Monooxy- | Kocuria | VLPLSLIDFATVYQGETPRESFIRSVAMAQRAERLGFSRIWYA | 7 |
| genase | halotolerans | EHHNMPTISSAAPAVLISHIASQTESIRLGSGGVMLPNHSPLT | |
| | | VAEQFGTLAELYPGRIDLGLGRAPGTDMKTLQALRREPQDAE | |
| | | RFPSDVVELQGYLRGASRIQGVEAIPGRNTDVPLYILGSSLFG | |
| | | AQLAAQLGLPYSFASHFAPAALEQAVTTYREHFQPSEQLSEPY | |
| | | VIAAVNVTAAEAKEEAEEQSAQVRKARVAAMIGRGRELSDA | |
| | | EVEMLMHSPAGQQVLEMLRYSAVGTGDEVRQYLERFAEKAK | |
| | | ADELMISLQSPSTEESARSMEILADAWGLEASGDRSVS | |
| Monooxy- | Kocuria | MNREHIMQIGIFSVGDVTQDPTDGTTPTEHERIKATVEIARK | 8 |
| genase | halotolerans | AEEIGLDVFAVGQHHNPPFATSSPTTTLAYIAAQTERIMLSTS | |
| | | TTLITTTDPVRIAEDYGMLQHLADGRTDLMLGRGNTGPVYPW | |
| | | FGKDIRQGVPLAIENYNLLHRLWHEEVVNWSGKFRTPLQSFT | |
| | | LSPQPMDGVAPFVWHGSIRTPEIAEQAAYYGDGFFHNNIFW | |
| | | NKEFTGQMIDLYRERYEHYGHGAADQAIVGLGGQFFMRRNA | |
| | | QEARREFRPYFDNAPVYGHGPTMEDFTDQTPLTVGSPQEVIE | |
| | | KTLSFREYAGDYQRQLFLVDHAGLPLKTVLEQLDLFGEEVLPT | |
| | | LRREFDAARPAHVPEAPTHASLVERRRAGADPVPGGREDSPA | |
| | | GEARRAERGSRAPGAEREHGTARTEDAR | |
| Monooxy- | Kocuria | MHVSKKIGFLSFGHWTPHPTSSTQSASDALLQSIDLAVAAEE | 9 |
| genase | halotolerans | VGADGAYFRVHHFARQLGSPFPLLAAAGARTSRIEIGTGVVD | |
| | | MRYSNPLTFAEDAGAADLIAGGRLQLGISRGSPEQVIDGWR | |
| | | HFGFEPAEGESDADMARRHTETALEAISGRQFARPNPHPMFP | |
| | | NPPGLLRIEPHSEGLRRRIWWGAGSDATARWAAQRGMNLM | |
| | | SSTLKDDESGEPFHVQQRKQIEAFREEWARHEHGFEPRVSV | |
| | | SRSIFPIVSDLDRRYFLGSGERSDQVGYIDSTRSVFGRTYAD | |
| | | EPEALVEQLRGDEAIQAADTLLLTVPNQLGVAYCASVMENFI | |
| | | RYIAPALGWR | |
| Monooxy- | Kocuria | MTQQMRVFAFDFSGPAHLSAGLWRHRDDRGPQYTSIRYWV | 10 |
| genase | halotolerans | DYARMLEQACFDGIFFADNVGYHDVYRGSVADALKDAAQIP | |
| | | ANDPAYAIPAMAAATTHLGFGVTSSTAYDQPYATARKFTTLD | |
| | | HLTDGRIGWNVVTSYSDSAAKNLGTGTQLAHDDRYGRAEEF | |
| | | LDVALKLWEGSWEDGAVRVDAESCTYVDPERVHEINHSGE | |
| | | HFDVPGIFLCEPSPQRTPVIFQAGGSSRGVALAARTAEAVFM | |
| | | NATSKAGLKKQVDNLRQQAAEAGRAPEHLAVLQMITVISAPT | |
| | | DREAQQKYEEYLKLVSYDGAMARYSGWAGLDMDTFDPDVP | |
| | | LKHVNTNAGQTMVDIFSKMDPTKEWTPRDIAEYIGLGGTAP | |
| | | VIVGGPETVADELQSWMDETGIDGFNVAHAVKYQDIKDFTE | |
| | | YVVPELQHRGLMRTRYEGRTLRENLFGQGQPRLPQDHPGAA | |
| | | YGHRTAIGTA | |
| Monooxy- | Kocuria | MTENANTKTLGFFTRLLEEASPAERYRYALEQIDAAERLGFSS | 11 |
| genase | halotolerans | AWVAQHHFHEAEGGLPSPFVLLGAAAQRTRRIGLATGVITLP | |
| | | MEDPVRVAEDAAVLDAISGGRVQIGLGSGGNPNSFPAFGAD | |
| | | FAERGPAFAAKLETLETLWRGEETAGGNRLYPAAPQLPGKLW | |
| | | QASFGTFGAGIAGSRGDGLMLSRTQPRRDSPEAALSEIQVPV | |
| | | VQAYLERLPEGAAPRIMASRTAIAVEASERAGLVRRTAQKLR | |
| | | QGEADRLVGRDTSGLGDEELLVATDTFLGTPEEIVERLSEDR | |
| | | VVTDHATLVAFQVHSAPVTHEETLRSLELLATEVAPRLGISTA | |
| | | DDALAVSRG | |
| Monooxy- | Kocuria | MSRDGHSPRSASPGARRSAPARKQARLNLFAYGCGHHKAA | 12 |
| genase | halotolerans | WRAPDSAVERLGEIEYYEELARTAERGLLDAVFLADGQSLDP | |
| | | PSLADSPGWFLEPITALSAMARATERIGLVSTVSSTFYTPYHA | |
| | | ARLLGSLDHVSRGRAGWNVVTSMSDAEARNHGMPGMPPHE | |
| | | RRYGRAAEFIEAVQALWSSWPRASLEADRGGRYVDPGRIRG | |
| | | VAHAGEHFRVAGPLNVPEPPQGRPVLFQAGASEQGRELAAR | |
| | | YAEGVYAVAYDLEQGARYRRDVRRRVREAGRDPDDVVVMP | |
| | | GLVAYVASTEAEARRRQAELDALLPAEASLRQLGRFTGRDCS | |
| | | GWELDAPVPELAPLEEFTGPQGRYATILRIVASERPTVRQLLG | |
| | | RLAAGGGHCTMVGTPESIADRIEQWLDDGAADGFNLMPPTL | |
| | | PGGIEDFVEQVVPELQRRGRFRREYRGTTLREHLTGSPRVPV | |
| Monooxy- | Kocuria | MTEKKRIAVNAFDMTCVGHQSFGLWRHPRSRATEYNTIEYW | 13 |
| genase | halotolerans | TGLARTLEKGLFDGLFLADVVGIYDVYRNSAAPALRDGAQVP | |
| | | VNDPFMQVSAMAAVTSHLGFGVTSAVTYEQPYTLARKYATL | |
| | | DHLTRGRVGFNVVTSYLPSAAENQGLPRQIEHDERYEIAEEF | |
| | | LDVTYKLWEGSWEDGAVREDREAGVYADPSLIHPIGHRGRH | |
| | | FTVPGAGLTAPSPQRTPVIFQAGASSRGQAFAGRHAEAVFIG | |
| | | ALRPDLTRSMTDAIRDRAEAEGRGREEVKIFAMLSVVVAETD | |
| | | EAARAKYEDYLSYADLESSQAIIGGWSGLDLSRFGEDEVLNY | |
| | | VKTDSIQSFLTPFTLQSEGKEWTRAEIARHCALGGMGDVVV | |
| | | GSPQTVADQLERWIDEGGLDGINLAYHVSPGSFEDFVEYVV | |
| | | PELQRRGRYRTQYEGSTFRENLFGAGRTRVSESHPAARYRG | |
| | | AFADGPSCAEAPARELQDDVAPR | |
| Dioxygenase | Kocuria | MSSTTETFEDRRREHDAVPATPPPGLPPEAAASSDAAADSQA | 14 |
| | halotolerans | QLSEEMERVQRGYEASGEREDGPRLDYAPYRSSVLRHPTKD | |
| | | PHHVDPELIELSSPAFGHRDVGDLESDLTIQGGGEPIGERIKV | |
| | | RGRILDSAGRPVRGQLVEVWQANAAGRYIHKRDQHPAPIDP | |
| | | NFTGVGRCLTGQDGSYEFTTIKPGPYPWKNHRNAWRPAHIH | |
| | | FSLFGTDFTQRLITQMYFPGDPLFSLDPIYRSIVDEGARGRLV | |
| | | AEYDHEISEHEWLLGYRWDIVLGGSNRTWTEPEEDDR | |
| Dioxygenase | Kocuria | MSREPQQTPVSRGRPVADPPADLTPTPGQTIGPFYGYALPYE | 15 |
| | halotolerans | GGERLVDRSDPRAVRLHGTVYDGAGDPVPDCLLEIWQPDEQ | |
| | | GRVPEEPGSLLRDGYTFTGFGRAPADRVGHYDFTTLEPGPTA | |
| | | PGRAPYLLLTVFARGLLDRLFTRIYLPEDAEALAADPVLSGLPE | |
| | | QRRSTLIAEREPSGALRFDVRLQGEDETVFLTYPGQSSYGFG | |
| | | R | |
| Dioxygenase | Kocuria | MSSTTETFEDRRREHDAVPATPPPGLPPEAAASSDAAADSQA | 16 |
| | halotolerans | QLSEEMERVQRGYEASGEREDGPRLDYAPYRSSVLRHPTKD | |
| | | PHHVDPELIELSSPAFGHRDVGDLESDLTIQGGGEPIGERIKV | |
| | | RGRILDSAGRPVRGQLVEVWQANAAGRYIHKRDQHPAPIDP | |
| | | NFTGVGRCLTGQDGSYEFTTIKPGPYPWKNHRNAWRPAHIH | |
| | | FSLFGTDFTQRLITQMYFPGDPLFSLDPIYRSIVDEGARGRLV | |
| | | AEYDHEISEHEWLLGYRWDIVLGGSNRTWTEPEEDDR | |
| Monooxy- | Kocuria | MTATSDLRIPARADDDLATGRGPRAEDAAARPGGPDAGSPA | 17 |
| genase | halotolerans | RTASPGSGPAGPASGGGEERYDIVGVGFGPSNMALAAACSE | |
| | | DPDAQRAVFFDAAQGPSWHAGMLLPDAGLQVSFAKDLVTFR | |
| | | NPTSPLSFLSFLVERGRIHDFFNRGSSAPLRVEFFAYLRWAAE | |
| | | RLAEYVRYRHRVTAVQPQRSGGTITGYRVTVEGPEGTSTVLA | |
| | | RHVVVAAGLQPNVPEGLPEDERVLHTSRYLHRVEGLGEVRSA | |
| | | VVLGGGQSAAEVALDLRSRFPEARVHLVHSRFGIVPADSTPF | |
| | | ANRIFDNTSIDRLYRAPEEVRERLDRIHANTNNSVVDESTIQA | |
| | | LYDAWYADSWAGRERIVFHDASRLAGVEPAEDGLDVAVRN | |
| | | DLDGDVEHLRSDVLALGTGYRPLDLRALLGEDADLLARDAEG | |
| | | RVIAERDYSVRWQSPAEGRLVAIGITQHQHGVSATLLSNIAL | |
| | | RAGEILASLTGERAGAAR | |
| Dioxygenase | Kocuria | MRTSIATVCLSGTLRQKLRAAASAGFDGVEIFEQDLVVAPES | 18 |
| | halotolerans | PEQIRDYAAELGLTLDLYQPFRDVEGTTEEEFRDSLRRAEAKF | |
| | | ALMGRLGMDLMLVCSNVGTASVGEDAVMAEQLGRLADVAA | |
| | | GYGVRLAYEALAWGRYVNDFEHSWRLVEAADRPNLGICLDT | |
| | | FHILSRDWPTDAVARIPGEKVFFVQLADAPLMSLDVLSWSRH | |
| | | FRVFPGEGGFDLEGFMVRLLAGGYSGPLSLEVFNDSFRQTNV | |
| | | YRTAVDALRSLRWLQDRTARQIEGTGAEAGRPSSGAPAAGS | |
| | | GENAVARRAAARLGELTRLPEAEQPSSITWAEVRGQRTEQV | |
| | | EALLDHLGFSYRGRHASKPVQLWEQGGARVVINEEPRAADA | |
| | | PSIASLGFELPDAAAAAARADALRVPAVPRLTGRGEQEFAAYL | |
| | | APDGTEVFLCPPEAGGGDRWVEEFSAPGRGGRSAAGAAALG | |
| | | GLDAVGEAGQPAGVGGAPGGGGTGEGMAGASAGEDGAGG | |
| | | SGPALITGIDHVNLAQPRHHYPESVLFFRAALGLRVLPSQDVP | |
| | | GPTGLVSSQVVHNSTGTVRLPLNVAPDLRVEPEVEHVAFACD | |
| | | DVVALARRVRASGLRPLSVPGNYYDDLRARFDLEEGFIARLA | |
| | | ELDLLYDRDERGEFLHFYTQTVGSVFFEVVQRLGGYAGYGAP | |
| | | NAPVRMASQYTRRTELG | |
| Monooxy- | Coryne- | MSTQHTPDNLSVENAQTTPAGAPRSIAVIGAGLAGAGAALVL | 19 |
| genase | bacterium | ARAGYRVDLYSDRTREALRDEVPATGTAILFGASRTADAKIID | |
| | variabile | DLYAGSPAAHFGASAAGLANPDNPSGVDSFPARYTYEAQSV | |
| | | DARLRADDRLAAFLDLTGDTASAFHVTRVTPADLDRIAAEHD | |
| | | LTLVATGKGGLADAFTTDHERTPYPGPQRRVLTVTAAGLSSD | |
| | | HLFSGRAEVPGVNNALLSLHGEGEVFVGPYLHKDGIDAWVIL | |
| | | AWAKPGTATEKAFAEATDAESSLRILQDLHHRVLPDVADDL | |
| | | DRLRPIDADPHSWLAGAVTPRVRRPVGYTDGGNLVAALGDT | |
| | | AIAVDPIAGQGAQLGDFQVAALVEGLTAAEASGQPWDADLL | |
| | | TDLFETHWAGHGAAGVAVTSLFLGDPLYAEVAGAFFGNAGT | |
| | | DPAYATALFSLFSEPAPALTLRTAEDVAALAASFRNSTAKVTA | |
| Dioxygenase | Coryne- | MVQTTTPTDNATVTDTNAELTLESTMGGIGTETTDRSVPVID | 20 |
| | bacterium | LDNWDLTDEQWDAKAEEFWDAATTIGFFQLKNFGITRAEIE | |
| | variabile | DAFATSARFFALPKETLETVAKPKGRNVGFEHKSQIRPSTGTP | |
| | | DEKESYQITRPLMDGLWLDEDANPSIDGFKDASLAFEAKCH | |
| | | EVAMRVLEFFAVKLGFERDYFRKVHNPASDLHQCTLRMIHYM | |
| | | ALDAKDNVADPNGNPVWRAGAHTDFNLLTLLFQTDGQSGL | |
| | | QVMPGADAGQDVQAWTPVPAFTDVLTCNIGDMLMRWSDD | |
| | | RLKSNFHRVKAADIGVDIPERYSMPYFAQADRDAVIAGPEGR | |
| | | YEPMTAGEYLDMRIQANFGKAESTK | |
| Dioxygenase | Coryne- | MTGFHVPVIDITAYVTGGTDPEKAAVAAAVDAAAREVGFIQL | 21 |
| | cbaterium | TGHGIDPQVWDGLASALDAFFLRDLEVKKEVTTPPSVNRGY | |
| | variabile | SPPKSERLSLSLGVESATGMNDFFEAFNIGVQASAFPELDLPV | |
| | | SDYPENVWPAESGAGAEGMVGFRSQLEAWFGAAQGVAETL | |
| | | VDIFEDALGQPRGTIGSLADHSIDVLRTINYALEPGVTVELDG | |
| | | ELNGMGEHTDYGIVTVLWADRVAGLQVLGSDGSWNDVLPE | |
| | | PGALLVNLGDVTARLTNDQWRSTLHRVKPPVVDGTILRRRS | |
| | | AAFFHDGNVDAIVGPLPGMVDSDHPARYEPVTVGEHVARKL | |
| | | AGSRSLELNASDTARESERVLSSRR | |
| Peroxidase | Coryne- | MTDPMSGCPVAHGGGHTPQGGHAPQESQAERGEAQGSRLP | 22 |
| | bacterium | LPTEGNANQRWWPKRLNVRLLAHNPQEVRPTPADFNYAEAF | |
| | variabile | SQLDLPQVKKDIEDVLTTSQSWWPADFGHYGPLIIRMAWHS | |
| | | AGTYRSHDGRGGGGAGQQRFAPLNSWPDNVGLDKARRVL | |
| | | WPVKKKYGQNLSWGDLMILAGNVALESMGFETFGYSGGRE | |
| | | DVWEPEDVYWGSETDWLGTDARYSGTNDTSRDLQKPFGAT | |
| | | TMGLIYVNPEGPEGNPDPAAAAHDIRETFGRMGMNDEETVA | |
| | | LIAGGHTFGKTHGAAPDNEENVGPDPEEASLDRQGLGWQN | |
| | | HHGEGKGDDQITSGLEVTWTYHPTRWDNEFFHILFAYEWEL | |
| | | TTGEGGHFHWRPKDGGGADMVPMAHSAGRREPRMLTTDIS | |
| | | LRVDPSYEKISRRFKDDQNALNDAFARAWFKLTHRDMGPKS | |
| | | RYLGPEVPAEDLIWQDPLPDAEGDPVTPQDVEALKKTVLDSG | |
| | | LSVSQLVKTAWASASSFRGTDFRGGANGARIRLEPQRSWEA | |
| | | NEPARLAEVLTALEAIRTEFNENNAPRHLSLADLIILAGNAAIE | |
| | | KAAADAGTDVSVPFTPGRVDATQEQTDVDGFSYLEPQADGF | |
| | | RNYQNADLDIPAEHLLIDKADLLGLTAPQMTVLVGGLRVLGA | |
| | | TYGSTGHGVLTDRPGVLSTDFFVNLLELGNDWVATDDNATV | |
| | | FRCTDGETGEEKWTGTRADLVFASNSELRAQAEVYASDDAA | |
| | | EKFIADFVAAWTKVTEADRFDLHG | |
| Peroxidase | Coryne- | MTENTPDTTDIKSIPATTLDGDPLDLHDFDGPLLIVNVASKCG | 23 |
| | bacterium | LTPQYTALEQLQKTYSTTDGTGLTFLGVPCNQFAGQEPGSAA | |
| | variabile | EIQTFCSTTYGVTFPLLAKTDVNGDDRDPLYQALTTTQDAEG | |
| | | EAGDIQWNFEKFLVSADGRVLNRFRPQTTPDDPAVIDAIEAA | |
| | | L | |
| Monooxy- | Coryne- | MSNDKRQVHLAAHFPGVNNTTVWADPGSGSHIEFAGFGHF | 24 |
| genase | bacterium | ARTAERGLFDFLFLAEGLRLREHKGQIFDQDVVGRPETATVL | |
| | variabile | SALAAVTTHIGLTGTFNSTFNEPYDLARTLATLDRVSAGRAA | |
| | | WNVVTSHNAFTGANFRRGGYLDGADRYRRAADVVSLARTL | |
| | | WESHSGSEGHTGDGSFDWHSDFVDVHGIFPVPESPQISPVI | |
| | | FQAGDSEEGRDFAARHAEVIFSAHSEAEDGKAFRTDIDRRLA | |
| | | AVGRRPDSLRIYPGISVVLGDTEAEAQERYREVRHAQVHGPG | |
| | | AIAFLEQVWGRDLSDYDPDGPLPEVGPDLDNADITRGRVRH | |
| | | EKDYGAVARRWRALAEEKNLSIRELVTEVSGRGGTLIGTPAQ | |
| | | VAARFDELTQQRAADGFIVVPHITPGGLDEIVDRVVPELQDR | |
| | | GVYRTGYPGSHGRTTLRDNLDLPAYVPGAFPTAVPTSQEVSA | |
| Monooxy- | Coryne- | MTTAIHVSPTAALDLDALSATARALDAASGRGADDYLLVLGD | 25 |
| genase | bacterium | DYISGQNAVTLAAWLAPQTTRLRIVPEVPVTHTEPFHVATSTA | |
| | variabile | TLDYAATGRAGWSPVAQTSDAAADAIGRRPAAPVDAAWGE | |
| | | VPDVVAAVRALWTSWEPDAEIRDEVTHRFIDRDKVHYVDAT | |
| | | GTDSVGQPWSVKGPSIVPRPPQGELPTVTVVGDRFHTSDGV | |
| | | AGEVRHITDVIGLLALAAQVSA | |
| Monooxy- | Coryne- | VKAFGFLSFGHYDLSTSGRMPGAKENLKNALEIAVGADELGV | 26 |
| genase | bacterium | NGAYFRVHHFAPQHSAPMPLLSAIAARTSNIEVGTGVIDIRYE | |
| | variabile | NPLQLAEEAAQLDLLSDGRVALGVSRGSPEPVDRGYEAFGYH | |
| | | PAADDPKGAAMAREKFERFMAAVDGEGMATSLPLEEQYPRM | |
| | | CHPNVPVPVMPHSMSLRKHVWWGAGSRDTAVRAAHDGVN | |
| | | LMSSTLLTEANGDRFEDLQAEQIRAYRAAWKEAGHQWTPRV | |
| | | SVSRSIIPVTSEEDMRMFGIGGDEGGIGYIDDGQATFGRTYT | |
| | | DEPDKLVEQLKKDAALTEADTLMITIPSQLGVDANLRILQSFA | |
| | | EHVAPELGWEPNTAGTVTGYPLV | |
| Monooxy- | Coryne- | MYLGVLPSSPWQHQRIWPASPDFTAHSMEPALYTRLARACD | 27 |
| genase | bacterium | RAGIDVLFLPDKQVANASPPDPSVADSWFDPLTMFAYLAAVT | |
| | variabile | DRIGLVPTLSTTWFEPYPLARQILSLDHLSGGRAGWNAVSSH | |
| | | PGLEDANFGHRPVLTREQMKARHAEAVSLVKDLWTSWDSD | |
| | | AVTHDAATGQWFRPGSVHPVDHHGRFFDVTGPLTLCRSPQ | |
| | | DSPVLFMAGASENFLHTAAKDADVVFTALNDVDAARTMART | |
| | | LASFADQEGRQDASPRLMPGFFVSASGFPEYGTDAQSWVPG | |
| | | MHFHSPAGPEPATGAEVAAEMVRIVEESGIDGFIVMPRQIPE | |
| | | DITFLCDEVVPALVELGARPEPSGNPEAAPSTLRANLGFV | |
| Monooxy- | Coryne- | VRELPEIMRLSEDPPTTLPGWRRTFAPGELTLGLSPVTPDGDL | 28 |
| genase | bacterium | ARQVALTQAAEDAGFAAVWCRDIPLNVETFGDVGQIHDPFM | |
| | variabile | YLTWLASQTSTIALGTAALVLPLAHPLLLAKRSAGLDRLSGGR | |
| | | FLMGVASGDRPEEFAAFGMDKGTRGEDFRENLSVLRKAWET | |
| | | RMRPVTWSRGRMGGAEVVPKPTAAGVPVLAVGSCLQTTEFN | |
| | | AAHADGWLTYHRNLHDQKVMVDRWRASCEEQGVGFRPVG | |
| | | ESLWIDLAEDPSYPAEGRDFGFRLGRNALLELLHSQQELGLN | |
| | | HIMISLRHGNRPVEDALAELAEHVVPEFRALG | |
| Monooxy- | Coryne- | MSTAQITDNLQFAYWVPNVSGGLVVSDIGQTTDWGIDYNR | 29 |
| genase | bacterium | RLAQTAEQVGFDYALSQVRYLGSYGAESQHESVSFSLALLEA | |
| | variabile | TEKLKVIAAVHPGFWQPAVLANLATTASELYDGRFALNVVSG | |
| | | WLKDEFRKFGEPWLEHDERYRRSGEFLQVLRAIFAGDHAEF | |
| | | NGDFYRLHDYSISPHPTVAPELFQGGNSSAAQFNGGHFADW | |
| | | YFLNGAPVDELKLQIDQVRRHAEDAGREVKIGVNGFVILEDT | |
| | | EQQAHDKLRDIIAQADQGAVEGFAASVKQAGQSTADGKGM | |
| | | WANSSLEDLVQYNDGFRTGLIGTADQISDRIDELRNIGADLV | |
| | | LTGHLNFQEEVERFGKEVITPLRSDSTAPAVAPAHVNA | |
| Monooxy- | Coryne- | MTRIRFNAFDMNCVVHQSPGLWRHPEDHSREYTDLRYWTD | 30 |
| genase | bacterium | LAQLLETGYFDGLFLADVLGLYDLYGASPDAALRAATQTPVN | |
| | variabile | DPLPLVSAMAAVTDNLGFGLTTGTAFEHPFPFARRISTLDHLT | |
| | | DGRLGWNVVTGYLPSAAENTQSRGQLDTFEHDARYDHADE | |
| | | YLEVLYKLWEGSWEDDAVLADPVSGVYTDPTKVRPVNHTGT | |
| | | HYTVPGIHVSEPSPQRTPVIFQAGASSRGSTFAATHAEAVFV | |
| | | AAPTQEALASTVRTLTDKLADAGRSREDVVIYALLTVITDATE | |
| | | DAARAKAAEYRSYIDHEGALALMSGWMGVDFSTFDLDDPVA | |
| | | GIESNAIQSAVAAFQRSAGEEGREWTVRELAEFGGIGGLGPV | |
| | | VVGSGESVADQLEEWVEATGIDGFNLAYAVTPGTFRDVIDH | |
| | | VVPVLQARGEYPTAYAPGTLREKLFADRTGAGPHVPHNHSAA | |
| | | RYRPALTASPTSVPTGAHP | |
| Monooxy- | Coryne- | MKYSLVELAPVTPGHTKHEALTRALDAAVEAEQLGYHRIWFA | 31 |
| genase | bacterium | EHHNATGYASQVPEQLIALAAERTDRIRVGSGAVLLNHYSPY | |
| | variabile | SVAERFLQLEALFPGRIDLGLGRATGGPVADAALQRDRSSAR | |
| | | RDDYGDQVQEILAYYHHAFGEKHPFATLDPTHGIDSVPEVFT | |
| | | LGSSGSSAGFAGQLGIGYAFAGFINPRAAKAALRAYRENFTA | |
| | | TPFGPGTPQIILALNIVAAPTEEEALTLTWPNRAMWADLRAG | |
| | | RPGPVPLLADAGDHLTTEEKDAPAHVEGLMLPQCLAGTPDSL | |
| | | RDQLRPFVEEFGVTEIMVQDALNDPELRSRSRALIAEALADL | |
| Monooxy- | Coryne- | MHLNLFAYGCGHHSAAWRAPDSAFDRLGDVTWWEDLARTA | 32 |
| genase | bacterium | ERGRFDAVFLADGQSLNPVPGPSWFLEPVTALTALARATTRL | |
| | variabile | GLVSTISSTFWDPFHAARLSASLDHISGGRAGINVVTSMTDA | |
| | | EARNHGMDRLPDHAERYARAAEFISTVTALWGSWPAGSSPA | |
| | | EAVPVDHHGRYFDVDGPLNIPATSQGHPVLFQAGASEPGRD | |
| | | LAARYAEGVYAVAWDLDSARDYRLDLRRRAAGYGRDPDDLV | |
| | | IMPGLVTFVGKTEEEAREKQRELNELLPVEDSLRQLSFFVGQ | |
| | | DTSGWDLDAPVPELPPLAEFSGPAGRYATILRILASSPGGRPT | |
| | | VRDLLGYLAAGGGHATFVGTPERIAGEMERWIVNGAADGFN | |
| | | LMPPTLPGGLDDVVDLVVPVLQERGLFRREYTADTLRGHLVG | |
| Monooxy- | Coryne- | MRFSLFIHMERWDNSISHEEHWNNLVELVQLAEAGGFGTV | 33 |
| genase | bacterium | WTGEHHSMEYTVAPNPMVSLAALAGKTSTIRLGAGTIIAPFW | |
| | variabile | NPVRAAGETALLDVISGGRAEIGVARGAYQFEFDRLAGGLSA | |
| | | KDGGTYLRELIPAMKKLWAGDYAHDGEHWSFPTSTSVPKPV | |
| | | QDDGPTVWVAARTAETHDFAVAEGCNVQVTPLMKDDAEVR | |
| | | DLKDKFDGAVANHPEIGRKPEIMVLRHTFVHSPDEPEAWRP | |
| | | AAEAVSRYYRTFSSWAFGRKEPVNGFLDPQPLETVAERPEFD | |
| | | LDSLHRSAMIGTPEEVTTRLKDYENMGYDEYSYWIDNSMTFE | |
| | | EKKASLQLFIDQVIPNFR | |
| Monooxy- | Coryne- | MTENGEPDNPAQVHLNLFVSGCGHHAAAWRAADSAVDRLG | 34 |
| genase | bacterium | DISWWEGLAQTAERGRFDAIFFPDGQAARTEALTAGPTWFL | |
| | variabile | EPMTSLAAISQVTEHIGLVSSVSSTFWDPFHAARVIASLDHIS | |
| | | GGRAGLNIVTSQLDAEARNHGMDALPNHAVRYARAGEFAET | |
| | | IKELWGSWPAESIVADRGGRYTETSQLKKISHRDRWFRVDG | |
| | | PLNIPTPPQKQPVIFQAGVSEPGRDLAASHAEGVFTVAWDSQ | |
| | | GARGFRKDVRARTAAMGRNPDHVRVMPGLVAYVGSTEEEA | |
| | | RRHQQELNELLPIEAALHDLSAFLGVDATAWDPDAEFPVLPP | |
| | | VSECDAAPGRATLVRHIVEHAGRRGGSSSGQDDLRRPTVRE | |
| | | VLGYLAAGGGHATLVGTPEQVADEIIRWIDCGAADGFNIMPP | |
| | | SMPHGLDTFVDQVVPVLQERGRFRREYEGATLRENLLG | |
| Monooxy- | Coryne- | MNSDRTLDLSVLDLVPVRTGQTSAQAVAATLEVAATADKLG | 35 |
| genase | bacterium | YRRYWFAEHHNMPAVASTTPPVLAAAVAARTGQIRVGSGGV | |
| | variabile | MLPNHSTLIVAEQFAALAAIAPGRIDLGLGRAPGSDPVISQLL | |
| | | HQSGTAPGAESFPQQVREITALLDPDGAGVRLRGGEGYAVR | |
| | | STPVAVAGEIPQVWLLGSSDFSAKLAAELGLPYVFANHFGGP | |
| | | GLQDALTTYRDTYQPSEAFPEPRTILTVNASVAPTAEEAAERM | |
| | | LPQRRTMARLRTGLPMAAQETVEEAQATPLPGPAESYASKTG | |
| | | STDPDRLKEVVDTPDNALEQLTVFAGRHGVDEVMIAPVGGA | |
| | | YDGEPLDRAPGAEQTVRLLGEALG | |
| Monooxy- | Coryne- | MKRTDCSVCFDHREWISGFVTDRVVYSMAMTLPTPSDVTLH | 36 |
| genase | bacterium | WFLPTNGDSRGIVGGGHGADAQLGTRFPDLRYLTQLAQAAE | |
| | variabile | YNGFESVLTPTGRWCQDSWLATAALLSATERLKFLVAYRPSL | |
| | | VPATLLAQQAQTYQELSGNRLLLNVVVGGEDAEQRAYGDYS | |
| | | TKEERYGAADESLDLVQRLWTESEPVDVRGEHISVDGASLA | |
| | | RRPSVTPPVFFGGSSPAGIETAAKRADVYLTWGEHPDDVAEK | |
| | | LETVAARAAAYGRTLDYGIRLHVISRDTEEEAWAVAQKIYDSI | |
| | | DPADVARAQAGLKTSQSVGQRRMSEIHGRGSGFVPGGDAR | |
| | | ALEFSPGLWSGIGLLRGGAGTALVGSHDQVAATIDAFRRSGI | |
| | | RHFILSGYPHIEESFQVGEGTVPALRRLGVTVTNHEAPVGNQ | |
| | | ESARNLA | |
| Monooxy- | Coryne- | MTDHTHRTSYTDRTDQLVLNAFVYPEGHHEAAWRHPATTPE | 37 |
| genase | bacterium | RLLDPEYFVDIAGTAERGRLDAIFFADSPAVTGNVELRPGAGF | |
| | variabile | EPLTLLSAIAARTEHIGLVATASTTYNDPYTLARAFASLDLISG | |
| | | GRAGWNIVTTAADVASANFGLTGHPSAEERYARATEFVEAV | |
| | | VALWDSFEEDALLVDPVAGRWADPSRVHPADYRGRYVSTK | |
| | | GPLNVPRSPQGHPVLVQAGSSNAGRALGGRFAEAIFTAHQR | |
| | | LEDAVDFAADIRARAVAAGRSEKDVKILPGLSPFIAATQKEAK | |
| | | ELEAGFTELINPAFNLPTLNGLFDLDFTEDDLDTVIPLSAVRAT | |
| | | GQTLDNNHSRSQVVAGIIERERPTVRQLLGRLAGARGHRVF | |
| | | TGTPVQVADTIEDWLRAGAADGFNIMPPYYPGGLEVFVDEVV | |
| | | PILQERGLFRTEYPGTTLRSSYGLDVPENRWTVQRAGKAGRV | |
| | | PA | |
| Monooxy- | Coryne- | MIGAMEFGIFTIGDVTTDPTTGRTPTEHERIRSTVRYARKAEE | 38 |
| genase | bacterium | VGLDIFATGEHHNPPFAAPANPPILLSHLAAQTERLRFSTATTL | |
| | variabile | ITTNDPVRLAEDYAYAQHLTEGRLDLMLGRGNTGPVYPWFG | |
| | | ADIRQGIPLAVEKYHLLRRLWREENVSWSGEFRTSLQNFTST | |
| | | PRPLDGTPPFVWHGSIRSPEIAEQAAYYGDGFFHNHIFWNIE | |
| | | HTRKMVRLYRQRYEHYGHGAREEAIVGLGGQVFIGETEAAA | |
| | | KKTFRPYFDNAPVYGHGPSMEDFTQMTPLTVGTVDQVIERYL | |
| | | GYADEVGDYQRQLFLVDHAGLPESAVLEQIEILGTEVVPVLR | |
| | | REFEARRPANVPSDPPRGGLAAVEPATKHNHAATDK | |
| Monooxy- | Coryne- | MSAAESHAPLSLLDFATVYRGETPRDAFRRSVDLAQKAEELG | 39 |
| genase | bacterium | YTRVWYSEHHNMTSIASSSPAVLIAHVAAKTERIRLGAGGVM | |
| | variabile | LPNHAPLVIAEQFGTLAELYPDRIDLGLGRAPGTDARTVAALR | |
| | | RSPQNAENFPEDVLELQGYLAGRSKVQGVEAIPGADTNVPLY | |
| | | ILGSSMFGATLAAQLGLPYSFASHFAPDSLVPAVKAYREYFQP | |
| | | SELCPEPYVIAAVNVTAAATEAEAVRQSEIVRRRRVESMALR | |
| | | GRQVGEEDLDLLMSSPAAEMILSMLRYHAVGTGEQVAEYLE | |
| | | GFTRHADADELMISLQSPTTAESLESMSILADAWGMR | |
| Dioxygenase | Coryne- | MGDVPGIRSGKTECHPIHTGLTAGLTVREPRPQGVTSMSTS | 40 |
| | bacterium | NSPEPTQTPEGPAFEGRLLDRPDEDVVDQGPAFDIRTLMTRR | |
| | variabile | TVLGVGAAGVGAVALAACSDNSSSSAATTSASSSASSSASV | |
| | | TDLPDAEIPDETAGPYPADGSNGPDVLEESGIVRADIRSSIGA | |
| | | DDPVDGVPLEFSITVTDMANDDVPFENVAVYAWHCNAEGLY | |
| | | SMYSEGVEDETWLRGVQVADADGTVSFTSIVPACYTGRWP | |
| | | HIHFEVYPSVDDITDSENAIATSQIAIPEDVCNTVFALDAYEG | |
| | | SSENLSQVTLESDNVFGDDSGVSQLATMSGDVDSGYIASLT | |
| | | ARVDTTTEPTGGAAPEGGPGEGGPGGEGGPGGEGGEPPAG | |
| | | EPPAGSPGAIASTN | |
| Dioxygenase | Coryne- | MIDSDPNGPFRYPVSDIRDQDEATPGIMPSQTVGPYVHIGLT | 41 |
| | bacterium | WPGAENMVEEGTDGAVEVTFQVTDGAGHLIKDAMIEIWQA | |
| | variabile | GSDGVYPSPLDPRAGEDAGREGFRGLGRGMCDSETGLVTFR | |
| | | TVRPGAVPAPDGGTEAPHLKVGVFARGMLERLYTRLYFPEQS | |
| | | EANDADPVLNAVPEERRDLLVASTVDGDADSYRMDIVMQHE | |
| | | DATRETPFFAL | |
| Dioxygenase | Coryne- | MIPISNATVDGSFAPLHFPEYRTTVLRNPSNDLLMVPQRLGEL | 42 |
| | cbaterium | SGPVFGAADLRGEDNDLTKVNGGEAIGQRIFVHGRVTGEDG | |
| | variabile | RPVPETLIEVWQANSAGRYRHKNDSWPAPLDPHFNGVGRTL | |
| | | TDKDGNYSFYTVQPGCYPWGNHHNAWRPAHIHFSLFGRQF | |
| | | TERLVTQMYFPGDPMFFQDPIYNSVPAGARERMISVFDYDET | |
| | | RENYAMGFRFDIALRGRNATPFE | |
| Monooxy- | Coryne- | MILINVRFRPLPEYVENFREHVADYTAACRAEEGCLFFEWYRN | 43 |
| genase | bacterium | TDDSDEYLLVEAYKDGADVAHVQSDHFKASCELFPTLLSETP | |
| | variabile | QIINDHIDGKTEWDRMAEFSVD | |
| Monooxy- | Coryne- | MSVVKINAISVPEGAGPELEKRFAARAHTVDSSPGFEGFQML | 44 |
| genase | bacterium | RPTKGDDRYFIVTTWASEEDFKAWAEGPARAAHSGPHSGEG | |
| | variabile | KKPVATGADLLEFEVVDLDAIAKQQ | |
| Monooxy- | Coryne- | MIILNVYFDVKQEHEAEFIKLLNHMVIESNKEHGCSMYQLFR | 45 |
| genase | bacterium | KSYDPYLYTLIEHWDTQEDLDAHGKTPHWINFNDTVNNYLK | |
| | variabile | SDYEEHHYVEIDF | |
| Peroxidase | Coryne- | MDTNFRVTRRGFLAGLGLVSATAAVGATTACAGDSDPDPVS | 46 |
| | bacterium | NTDTTVPFDGPHQAGIATPLQRHNTTVAFTLRDGVDATGIRR | |
| | variabile | LLRIWTGDARRLTQGEPVLADLEPELASDPGRLTVTCGFGRG | |
| | | LFEKARLTDKSPDWLEPLPGFAGDRLEARWGDRDLVLQICG | |
| | | EDRTTVSHALRVLVRGGADYARPSWTQTGFLDIPQDADGTP | |
| | | GTPRNLFGFKDGTVNPRTDAEFDDQVWISGEAATHPSQIGG | |
| | | TCMIIRRIAFDMPLWESADRPTREVSMGRTIVEGNPLSGEKE | |
| | | HDDPDTAAVGADGLPVIDRNAHIALAGVHDGDTRQRMLRR | |
| | | AYNYDLPVTPSSADALVDADPVALSDTGLIFICFQPDPRTSFI | |
| | | PVQRRLAAGDRLNEWITHVGSAVFLVPAGTTEEEYWGEALL | |
| | | G | |
| Peroxidase | Coryne- | MSVGDAEFGTYFIGYAKDPAVTEQMLRNMFIGVPEGNHDRIL | 47 |
| | bacterium | DFFTAVTGSLYFVPSAAFLNGLGADRVGRP | |
| | variabile | | |
| Peroxidase | Coryne- | MSDRPVSRRHFLTGLGVTGLGAAALGTAGVAGVGTLAACST | 48 |
| | bacterium | DDDSQVVPFRGVHQAGVTTAQQEHLHIVAFTVLTEDRDELR | |
| | variabile | DMLSTWTSMAERLTTGEQTTEGGALTDSDADITDDPDNLLN | |
| | | QVPEDTGEALDLASGNLTVTVGFGPSLFDDRFGLKDRKPEEL | |
| | | EPLPKFPGDQLQDALCDGDIVIQACADDPQVAVHAVRNLTR | |
| | | AGTGVVAVKWSQLGYGAASKTTKEEDTPRNLFGFKDGTRNI | |
| | | TADETDDIEKMVWVSDDGWMTGGTYMCVRRIRMLLEVWD | |
| | | RQILDDQQHTFARYKGSGAPIGTDDENADVPFDLYLGTGGP | |
| | | AIPEDSHVFLAHPDQNDGQRMLRRAYNFIEGSDSMGHLSAG | |
| | | LFFIAYVSAPSVNFTPIQMRLSHSDKMNEYVRYESKAIFACPP | |
| | | GLAEGEDWGTALFG | |
| Dioxygenase | Coryne- | MIPISNATVDGSFAPLHFPEYRTTVLRNPSNDLLMVPQRLGEL | 49 |
| | bacterium | SGPVFGAADLRGEDNDLTKVNGGEAIGQRIFVHGRVTGEDG | |
| | variabile | RPVPETLIEVWQANSAGRYRHKNDSWPAPLDPHFNGVGRTL | |
| | | TDKDGNYSFYTVQPGCYPWGNHHNAWRPAHIHFSLFGRQF | |
| | | TERLVTQMYFPGDPMFFQDPIYNSVPAGARERMISVFDYDET | |
| | | RENYAMGFRFDIALRGRNATPFE | |
| Monooxy- | Staphy- | LKYGLLLPNIKGNEIFTIIENLNSITQDSIDSVWLRDIPVALNE | 50 |
| genase | lococcus | DKDEGNWYDPIILATILNRHLKNPDIFIGTAVINTLYRRKESV | |
| | lentus | LRSAINLQYLCNNKFILGIGNGEKEGIYNILDADWNDKYKYM | |
| | | RNYLEYFSKIKIDTVNRRLINQLENQSFFSIPSNVSLPLIYLAT | |
| | | SNRKVITQYKNHIHGILTWMKSPKDLSSLQKSLSPYNIKISN | |
| | | VINIMFTHENKIYYKEINGLTYIVTNHSNIHSIVDSYDKVGINR | |
| | | LIFNVYKNDYNFLKKLKEQSYD | |
| Monooxy- | Staphy- | MTKNTHIKLGLFLAGYGHHVASWRHENVNEQGPMDLNHLIR | 51 |
| genase | lococcus | TAQLAEKGLFDLVFLADSLFVSESSHPNILSRFEPLTLLSVLST | |
| | lentus | HTTNIGLAATASTTYSEPFHIARQFSSLDHISNGRAAWNIVT | |
| | | SSIPSTAENFNGTKLMEHELRYERANEFVDVTNKLWNSWEK | |
| | | DTLIRNKETGEFIDGKKLHTINHVGKHFKVRGPLNIERSPQG | |
| | | RPLLIQAGSSPTGTDLAAKVADVIFTAQSQLTDAKDFYQKLK | |
| | | NKAINENRNPNDIFIMPGLFPILGETVEEAEQNYQEIQDLILPH | |
| | | VGLNILSPYVGNIDLSQYPLDKKFSELDLTVGDGVQSRFEVIH | |
| | | KEAIAKDLTLEEVYKKVAGSRGHHIFVGTPNQLADKMEKWF | |
| | | NSSGADGFNIMPPILPSQFELFIEKVIPILQKRGLYKTSYNKGT | |
| | | LREKLGLNNE | |
| Monooxy- | Staphy- | MQSHFPISALNLVPLRKGESEQEAIQNMVQLAQHVEKLGYER | 52 |
| genase | lococcus | YWIAEHHNAPNLVSSATALLIQHTLEHTDSIMVGSGGIMLPN | |
| | lentus | HAPLVVAEQFGTMATMFPNRLNLGLGRAPGTDMMTASALRR | |
| | | DSHKGVYTFGDDIKQLLKYFGPEEDQSYVRPYPGVDTNIPIY | |
| | | VLGSSTDPAHLAARLGLPYVFAAHFAPQQMAQAIEIYRDLFEP | |
| | | SEYLDKPRVTVCLNVIIGETDEEATYLSSTMHLMFLGIVRNSR | |
| | | LPLQPPTDQLENIWSPQEKYMAQDKTNTSFIGSEETVKKQFL | |
| | | AFQEKYNVDEIMAVSYIYDLDKQYKSFESFKKVVDEIYSE | |
| Monooxy- | Staphy- | MKFELGLSSFAELSPVDGTDKPFTASERINQIVEEIILADKVG | 53 |
| genase | lococcus | LDIYGLGEHHREDYAVSDPVSVLAAAAPQTNQIRLSSAVTVL | |
| | lentus | SSDDPVRVYQRFATLDALSNGRAEIMAGRGSFIESFPLFGYD | |
| | | LKDYDILYKEKLDLLLNINENKTVNWQGSTRPSINGLDVYPR | |
| | | AVQEKLPIWLATGGNPESSMRAGELGLPITYAIIGGAPSRFKR | |
| | | NVAMYKAIAESKGHDVSKLPIATHSWGYVAESDEIAKQEYYP | |
| | | SSAYVINQLGIERGWPMYSIEKFEQEIVHGALFVGSPETVAA | |
| | | KIIKLHEDLGITRFMLHLPVGSMPHEKVMKSIKLLGEKVKPIV | |
| | | DDYMKNKEEI | |
| Monooxy- | Staphy- | MKLSVLDQAPISKGDTPEETLRKTIELAKWTESLGYHRYWVA | 54 |
| genase | lococcus | EHHNTSGLASSSPEILMTNIAASTNQIRVGSGGILLPQYSPYK | |
| | lentus | IAENAKTLSAFFPNRIDIGFGNSPGGSPSTQKALTDNHIKPID | |
| | | DFPRQVSDLQGFLYNSLPRDHKFRLVKAGPRIDNPPPMWLLG | |
| | | LTENGAKNAANLGIGFVFGHFINPKYGKIAMERYYNDFKSSV | |
| | | SQQSPSSIVCIFVVCAETDEKAEELALSQDKWLINVSKGRGT | |
| | | KVLSSEEINFEDFTDEEQDLIKKNRKRCIIGSPETVVAKLKELE | |
| | | TYYQTDEFMIITNIYNFKDKKKSYKLLAEAITE | |
| Monooxy- | Staphy- | MRLSILDQSPVSSNQTSREALNHSLKLAQIGESLGYTRYWLT | 55 |
| genase | lococcus | EHHDLQHLASSTPEVLLGYIGGHTETIRIGAGAILLPHYRPYK | |
| | lentus | VAEIFNTLATLFPNRIDLGIGRAPGGSAEATNALSTNYLQKVF | |
| | | ALPELLEELLNFLDGSFPDGHEFKSLSALPKPEKSATPWLLGT | |
| | | SEKSAKLAAKNGLPYTFGYFMSDNKGTEIIQTYKDNFVKRYE | |
| | | NQEPEVILTVSVVCAETNKKAEEIALSSLIWSIQKEKLEDENG | |
| | | VPSIEAAKQYKLTDKEKEKIENMKRQMIIGDQKTVKTQLKAL | |
| | | EKEYECDEIMINTVTYSPDDKFNSYCLIAEVLL | |
| Monooxy- | Staphy- | MHNIVEHDFSSDVSNLGDDGLVELSVLDYAVIDEGKSAEEAL | 56 |
| genase | lococcus | QDTVKLAKLADKLNFKRFWLTEHHDVPAFACSSPELMMMHL | |
| | lentus | LSETKRIKLGSGGVMLPHYSPYKIAENFRLLEGLFPNRTDLGI | |
| | | GSNLGTAIVKRALNEGKTDFLDYEQSIKDIRHYITNQDESQR | |
| | | YKGLIAQPHLSHHSDMWLLCTSAESAQIAAEQGIGLTLGTFL | |
| | | LPNQAQIDSAKESVDTYRKAFNRTSLNMSSTVMITTFVIVTD | |
| | | TEQEAEDLLQSLDVWLLGKKQFAEFSRFPSIETAKSYKLSER | |
| | | DQHLIEQHRARVIAGTKEQVKLKIDRLVEDFQANEVLLVPLH | |
| | | PGIKQRCRTLELLSEIYL | |
| Monooxy- | Staphyl- | MKRMKLGYFLTGFGHHVASSRHPESVERGGMNLKKTIEQAK | 57 |
| genase | ococcus | SLEQAKFDFLFVSDSLYVDNKTHPDMVTMFEPISLMSIIAMET | |
| | lentus | KHLGLIITGSTTYSEPFNLSRIFSSLDHYSDGRAGWNIVTSGI | |
| | | NDTAKNFSGVNNVDHDLRYDQANEFVEISKKLWNSWRDVD | |
| | | SQSIHKAGKFLKNQQPEPINYEGDFYNVKGPLNIDQSPQGYP | |
| | | LLVQAGSSKKGTDFASKHAEVIFTAQNDIDAAINFAQKLRRQ | |
| | | VEEKRGPEQEVVIMPGIFPFIGETREEAQANYKELQDLIDPEM | |
| | | GLELLSSYLGDTDLSGYDLNTPFEDVEVDKGNNIQSRVDLIK | |
| | | ETAKRNNSTLEDVMKHVAGARGHHIIVGTPEDVADRMEEWF | |
| | | KRGAADGFNIMPPLNPTQFELFVNKVVPILKERGLVQTDYNE | |
| | | GTLREKLGLSNVKTHS | |
| Dioxygenase | Staphy- | MNGSLHHIEIYVEDIQKSRAFYEWLLNKLGYKLYQEWDLGFS | 58 |
| | lococcus | FKLGETYIVFVEVEEKYKDYGYHRKRIGLNHLAFNVETKAMV | |
| | lentus | DEITNDLINQDIGILYVDRHPFAGGNDHYAVYFEDPDRIKLEI | |
| | | VSNGN | |
| Dioxygenase | Staphy | MSNNELIGIHHVTAITDDAVRNYEFFTEVLGMRLVKKTVNQD | 59 |
| | lococcus | DIYTYHTFFADDQGSPGTDMTFFDFPNSPKGQRGTNSISRA | |
| | lentus | GFRVPNDAALEYYLERFEEFGVKNDGIQELFGKKVLPFEEKD | |
| | | GQRYQLFSDELNKGVEPGLPWKNGPVPEDKAIYGLGPIEITV | |
| | | SYYDDFKSVLKQIYGMKPIIEEEDVTLFEVGEGGNGGQVILR | |
| | | KDDKTPEARQGYGEVHHVSFRVKDHEAIKAWEEKYKELRIG | |
| | | NSGNVNRFYFEALYARIGHILIEISTDGPGFMGDEPYETLGES | |
| | | LALPPFLESQREYIESEIKHFDTTRKHD | |
| Dioxygenase | Staphy- | MKLNHINIAVKDVVTTKEFLEKYFGLKCIASAGNMFTALNDD | 60 |
| | lococcus | DGLLFNLIKDENASYPDTFHIGFPQEDEESVDKIYETLKEDGF | |
| | lentus | EVWEPALAHGSYTFYFKSPGEFTIEIYAQAEEKTKTVVHPY | |
| Dioxygenase | Staphy- | MIQSINHICYSVSDLKNSIRFYKNILCGELLVSGKTTAYFNIG | 61 |
| | lococcus | GLWVALNEEKDIPRNEVQYSYTHVAFTIDESEFNDWYQWFK | |
| | lentus | ENDVNILEGRTRDVRDKQSIYFTDPDGHKLELHTGTLENRLN | |
| | | YYKETKPHMVFYK | |
| Dioxygenase | Staphy- | MVEILRHHHISMLTKDAKLNKDFYVNKLGLRLYLKTVNQDDT | 62 |
| | lococcus | SMYHLFYGDEVGTPGTSLTFFELKPMGQTYKGTNSISRIGLLV | |
| | lentus | PSEESLSYWKERFEEMDVDHDAIGIYNGLMALHFRDHEGLE | |
| | | MVLLPNGDRRTPQDWRNNSYSDVPKEHQIMGMGPIEFKMD | |
| | | QVTDMKNFLENDLNFDVADSESELLYTRDQEGLYSDIVLVEE | |
| | | QGKREKPGKGSIHHLALSVADEEELKKVKELLDSKNVVHSGI | |
| | | IDRDFFKSLYYRHSHILIEFATEGPGVPYDDIDQLGEKLDLPN | |
| | | FLESKREEIESNLEPI | |
| Dioxygenase | Staphy- | MNNFQDDSIKGESVKTDFTEDMTYSEYLGLDKVLSAQHTLT | 63 |
| | lococcus | DSHDEKLFIIVHQVSELWMNLIIHEINSACDDVKNDQFKQAF | |
| | lentus | KKLARVGNIQKQLIQVWEVLSTMTPSDYLTFRDDLGSSSGF | |
| | | QSYQNRMLEYSLGYKTTHALKIYEKDANIYNLLKTQLEKPSIY | |
| | | DETIKAINRAGFKIDESVLNRKVTDNHVSNESVKEAFKEIYLN | |
| | | AETYFELYELLEKLTDVEDRYSQWRFRHMKTVQRIIGFKVGT | |
| | | GGSSGVNYLKRVIDHSFFPELWELRTEL | |
| Dioxygenase | Staphy- | MLDISRGINHIGLTVPNIEDATKFFKEGLDGKIAYDSQKKDES | 64 |
| | lococcus | PRDGEHVEHILGLEEGAKIIKKRMMVFGNGPNIEMFEFQDAK | |
| | lentus | QAKPDSLQDIGFTHISFYVDDFEKAFEQIQKAGGEPISQPHD | |
| | | NTKYEDTAGNKTVYVKAPWGSLIELQTVPEGFYYPSDSEAEV | |
| | | FIPKK | |
| Monooxy- | Brevi- | MEFGIFTIGDVTTDPTDGTTVSENQRIKNTVEIAKKAEEVGLD | 65 |
| genase | bacterium | VFATGQHHNPPFVAPANPPVLLANIAAQTEKLELSTATTLITTT | |
| | epidermidis | DPVRIAEDYSYAQHLSDGRISLIMGRGNTGPVYPWFGKDIRA | |
| | | GIPLAVENYNLLYRLWREKNLDWEGKFRTPLGGFTVTPTPLD | |
| | | EVPPFVWHGSIRSPEIAEQAAYYGDGFFHNNIFWPTSHTARM | |
| | | VQLYRQRYEYYGHGKASQAIVGLGGQVFMRKNSQDAVREFR | |
| | | PYFDNAPVYGHGPSLEDFSTQTPLTVGSPQQVIERTLSFRDW | |
| | | AGDYQRQLFLIDHAGLPQKTVLEQLDLLGEEVIPVLREEFAKG | |
| | | RPADVPDAPTHESLVIRHREGRDPIPGGGEGSRAFEDRQAR | |
| | | AAEAAQNATQEGANRS | |
| Monooxy- | Brevi- | LTVVHLSSHPKDPTTLPVPLNILDLVSIRDGSTAREAIANSMS | 66 |
| genase | bacterium | AAKFADEAGYKRLWFAEHHNTMGLAASATALLISQAATVTK | |
| | epidermidis | RIRVGSGGVMLPNHAPLMVAEQYGTLANIHGERIDLGLGRAP | |
| | | GTDGMTAQALSRSSAEPQSFAQNIYDMQGWFSERGQAHTA | |
| | | PIKSAVSAGMDVPIWVLGSTMNGASIAGQLGLPFSIASHFAP | |
| | | DQIDAAIKVYRDSFTADAPTAQIDKPYVMAGINVMVAETDAE | |
| | | AQREFTPVRQMFADIGRGRNRQLQPPVDPAELAAQGAGENP | |
| | | MLQISAVGSPDTATAQMAEFVERTGADELITVTYAFDPEVGQ | |
| | | RSLRLLADAWF | |
| Monooxy- | Brevi- | MTESAQLHTTPQQHSGAPESQPSQQPNYMHEFGFYHGQGL | 67 |
| genase | bacterium | QFGIYSLGDHLPDPHDGSRVDAGQRIHEFIGYAQAAEAAGL | |
| | epidermidis | DFFSLGESHQEFFASQAHAVILGAIAQATDTIRIGSSSTILST | |
| | | SDPVRVFENFATIDLISGGRAELVAGRASRVGLFELLGYDLRD | |
| | | YEELYEEKLDLLLTINREKQVTWSGQFRAPLNDAEVLPRPTG | |
| | | QALRIWRAVGGAPASAVKAGLAGVPMVMAHLGGTTSVFKG | |
| | | TVDAYRRAAAHAGFDPGTLPIATAGFFHAAPTSQEALAGMYP | |
| | | HINEGMKRTNGQGMPKQHFAQSVHPASIANIGSPQQIVEKI | |
| | | LHQHEVFGHQRYLAQVDFGGMAYADVMKQIEIIGTEILPAVK | |
| | | KYTATAPADSQTESAGSASGPAGSASGSTGSAFDSAEEALA | |
| Monooxy- | Brevi- | MKLSILDLVPVRTGQTTADSFAASKQIIDTADKLGFTRYWVA | 68 |
| genase | bacterium | EHHNMPSIASTMPGPELMHLGQGTQQIRLGSGGVMLPNHAP | |
| | epidermidis | LAVAELFALLSAVFGDRIDLGIGRAPGTDPITSAAMRGHLGE | |
| | | GRMVDREGRAIDPVEQFPRHVIDTLSLMQPEGMRVPLHGGR | |
| | | EHVLKATPAAAPGTQPLPWLLGSSGYSARLAAELGMPYVFAN | |
| | | HFASGATTGMKIYRDNFTPGAYGDKPQTFVTANLVVAPTEEE | |
| | | AQLRSEPFMLQMARMRTGGPMEKLHLAGDDIRSVMTDQER | |
| | | MVGEELSNNWIIGDPKSAAAQLEELAERFDVDEIMIQPIAGA | |
| | | MKGEDVREDPGRIQTIELLAAEFLGGVNV | |
| Monooxy- | Brevi- | MTKPILLNAFDMMTPVHQSPGLWRHPESRVDEFTQLSFWTD | 69 |
| genase | bacterium | LAKTLEDGGFSSLFLADILGVYDVYGGNADVTNRGGVQFPLL | |
| | epidermidis | DPLVAVPAMAAATKTLGFGVTASVTYEKPYLLARTLTTLDHFT | |
| | | NGRVAWNIVTSYVDSAARNLGLKGQIPHDERYDRADEFMEV | |
| | | MYKLFEGSITPDALKADADANVFVDPGEVHDIGHEGKFFNVP | |
| | | GQALAVPGPQGTPLLFQAGASKRGQEFALDHAEAIFFSGPTP | |
| | | EILRSWVDKVRDGLEERGRARDSVKIFALATVIVDDTDEAAE | |
| | | ARLADYRRYVDTESALSLFGGWTGVDLSGASPDDTLEYVST | |
| | | DANQSALASFTTMAGDKPWTIRDLAEFVALGGRGPVITGSPE | |
| | | TIVDEFQRWMDEADIDGFNIAAAVRPADAERFAKYVSPELRR | |
| | | RGLLPEPVDGATVREQLTGSGPRLADDHKGARYRLGEDARV | |
| Monooxy- | Brevi- | MEFGIFTIGDVTTDPTDGTTVSENQRIKNTVEIAKKAEEVGLD | 70 |
| genase | bacterium | VFATGQHHNPPFVAPANPPILLANIAAQTQTLELSTATTLITTT | |
| | epidermidis | DPVRIAEDYSYAQHLSDGRISLIMGRGNTGPVYPWFGKDIRA | |
| | | GIPLAVENYNLLYRLWREKNLDWEGKFRTPLGGFTVTPTPLD | |
| | | EVPPFVWHGSIRSPEIAEQAAYYGDGFFHNNIFWPTSHTARM | |
| | | VQLYRQRYEYYGHGTASQAIVGLGGQVFMRKNSQDAVREFR | |
| | | PYFDNAPVYGHGPSLEDFSTQTPLTVGSPQQVIERTLSFREW | |
| | | AGDYQRQLFLIDHAGLPQKTVLEQLDLLGEEVIPVLREEFAKG | |
| | | RPADVPDAPTHESLVIRHREGRDPIPGGGEGSRAFEDRQAR | |
| | | AAEAAQNATQEGANRS | |
| Monooxy- | Brevi- | MANIHANPIYTGEPEDLKFAYWVPNVSGGLVVSNIEQRTDW | 71 |
| genase | bacterium | GYDYNVKLAQTAEAVGYEYALSQVRYLSSYGAAQQHESTAT | |
| | epidermidis | SLALALATEKLKVIAAIHPGIWEPAVLAKFILTADQFTKGRTAI | |
| | | NVVSGWFRDEYTRLGLPWLEHGERYRRSAEFMDVVRKLFTE | |
| | | ENVEYPGNFYTVDDFTLRPGPYPVEGRPHPEIFQGGNSSAAR | |
| | | INGGKHADWYFSNGKDFDGFREQYDDVTEVARAHNRKVRF | |
| | | GLNGFAIVRDTEAEAREQLREIIAKADEGAVEGFRKSVQQAG | |
| | | ASTHDKKGMWADSSFEDLVQYNDGFRTQLIGTPEQVADRII | |
| | | EYKKIGVDLILTGFLHFQEELEAFGKTVIPIVREKEVELVNRGL | |
| | | LTPAGV | |
| Monooxy- | Brevi- | MTPQPTDTQATGPKLGFFTRLLEDAPAAQRYRFALEQIETAEE | 72 |
| genase | bacterium | FGFHSAWVAQHHFSAAEGGLPSPLVFLSHAAARTSRIDLGTA | |
| | epidermidis | IITLPMENAVRVAEDAAVLDELSAGRLQIGLGSGGNPKSFPAF | |
| | | GTSFDDRREVFADNLATLRTLFSGDRLPTDHSLYPVPDAERP | |
| | | SLERRLWQATFSAGGAGAAGAAGDGLMLSRTQPRPQDNPA | |
| | | ARLDEVQLPVIDTYLSQLPDGVEPRILASRTAVVADAEDLPRL | |
| | | REITEPALRAEADRLVGYDTSGLSLDELLIATDTYLGTPEQVIE | |
| | | RLHHDRVLDRVTDVSFQVHSVPATNETALRSIELLATEVAPAL | |
| | | GFAVTTERVH | |
| Monooxy- | Brevi | MDVVRKLFTEENVEYRGNFYTVDDFMLRPGPYSVESRPHPEI | 73 |
| genase | bacterium | FQGGNSTAARINGGKHADWYFSNGKDFDGFREQYDDVTEV | |
| | epidermidis | ARAHNRKVRFGLNGFAIVRDTEAEAREQLREIIAKADEGAVE | |
| | | GFRKSVQEAGASTADKKGMWADSSFEDLVQYNDGFRTQLI | |
| | | GTPEQVADRIIEYKKLGVDLILTGFLHFQEELEAFGKTVIPIVR | |
| | | EKEAELVDKGLLIPAGV | |
| Dioxygenase | Brevi- | MTELTPTPGQTVGPFYGYALPFDHDNELVPPGSARAVQLTGT | 74 |
| | bacterium | VYDGAGDPVPDAILEIWQPDEHGAVPRETGTLRRNGFTFTGF | |
| | epidermidis | GRAAVDPEGEFSFSTVNPGPTEAGKVPFISVVIFARGLLNRLF | |
| | | TRIYLPEDTAALAADPLLSSLDEDERSRLIATRGADGSLHFDI | |
| | | RLQGEEETPFLRFPSHED | |
| Dioxygenase | Brevi- | MSAQQNSDADELKGPDDAAESQATLSAEIDGIEAQYKQDVA | 75 |
| | bacterium | GGKKPETQPRLDYRPYRSSILRHPTKDPRHTDPETIELFSPAF | |
| | epidermidis | GHRDIGTLESDLTIQADGEPIGERIRVTGRVLDGEGRPVRNQ | |
| | | LVEIWQANSAGRYIHKRDQHPAPIDPNFTGVGRTLTGDDGS | |
| | | YSFTTIKPGPYPWKNHHNAWRPAHIHFSLFGSEFTQRMITQM | |
| | | YFPGDPLFALDPIYQSITDQKARDRLVATYDHNITEHEFLMGY | |
| | | NWDIVLTGANRTWMEEEDDD | |
| Dioxygenase | Brevi- | MARVPEPDQTPEGPAYEGRLLDRPDEEVVDQGASFDLRTLFS | 76 |
| | bacterium | RRGVLGLIGAGVGAAALTACSSGTSGSASSSSGSVTEIPDET | |
| | epidermidis | AGPYPADGSNGPDILEQSGIVRSDIRSNIDGSDTVDGVPLTF | |
| | | TLKVTDMANDNAPFEGVAVYAWHCDAQGRYSMYSEGAEDA | |
| | | TWLRGVQVADSNGEVTFTSIFPGCYTGRWTHIHFEVYPDVD | |
| | | SITDAENAIATSQMALPEDACNAVFELDAYDGSAKNLSAITL | |
| | | DDDNVFGDDGGEHQLATISGDTDSGYVASLDVPVDTETEPS | |
| | | GGAAPAGGGGGEGGEPPEGGGGPEGGTPPDESADQ | |
| Monooxy- | Brevi- | VTIAFVKTTLPIIGAPMAGGTTTPELTEAVDRAGGFPFVAGGY | 77 |
| genase | bacterium | LTAEALAPLITRMRETTSNFGVNLFAPNPVPVDRMAFDDFVTA | |
| | epidermidis | LEPAAAARGITLDPEPVEDDDHFDAKLDWLTEHPVPLVSLTF | |
| | | NLPTAETVDRLHAVGTQVVATVTSVPEARAAAEVGVDGLIVQ | |
| | | GPRAGGHSGTADPTRIIEDRATVDLVRDILAELALPVAAGGG | |
| | | VDGEAMVGDLLGAGASSVVVGTLLLRSDEAGTASTHRAALA | |
| | | ADEFTDTQLTRAFTGRPARALVNDFVRKFDPVAVDAYPAVHH | |
| | | LTKEFRAAAKKADDPHGLHLWAGTGYRSAQDGSAETIVKDL | |
| | | GSRFARE | |
| Monooxy- | Brevi- | MHSSTQGGTVSTFTDLRSQLRLPVVGSPMFIASGPELVKAQC | 78 |
| genase | bacterium | QAGIIGSFPTLNARPASQLTDWLDEISASNAAHTAANPQQPA | |
| | epidermidis | APFAVNLIVHRSNNRLEQDLAEVVRHQVPIVITSLGAREEVNE | |
| | | AVHSYGGIVLHDVINNRFAHKAVEKGADGVIAVAAGAGGHA | |
| | | GAQSPFALVQEIRSWFDGPLLLSGAIAHGRSILAALAAGADL | |
| | | AYVGSAFLSTPEANVVDDYRKMIVESGADDVVYSNYFTGVN | |
| | | GNYLRGSIVASGLDPDNLPESDPSKMSFASDPDSDAKAWKD | |
| | | IWGSGQGIGALGQQRTTAELVETFATQFDEAKQRLLAQLR | |
| Peroxidase | Brevi- | VNNLYRELAPITGAAWAEIEEEARRTFKRNIAGRRIVDVEGPS | 79 |
| | bacterium | GFETSSVTTGHIREVQSYSSGLHIRQRIVQEFVELRAPFTVTR | |
| | epidermid | QAIDDVARGSGDSDWQPVKDAATTMALAEDRVILHGLDSA | |
| | is | GIGGIVPNSSNVAVTLPDSVEDYADAVAQALSSLRTAGVDGP | |
| | | YSLLLSEAEYTKVSESTDHGFPVRDHLSRQLGAGEIVWAPAL | |
| | | EGALLVSTRGGDYELHLGQDLSIGYRGHDGETVDLYLQETFG | |
| | | FLALTDESSVPLHP | |
| Dioxygenase | Brevi | MALTQLPVLDLSLADDPATAEAFRADLRRITHEIGFFYLKGHG | 80 |
| | bacterium- | IPDADFTRIIDVAERFFALPEEEKLAIENTNSPHFRGYTRTGGE | |
| | epidermidis | RTQGRVDWREQIDIGPERLPVAEPVNDFDHLTGPNQYPAALP | |
| | | ELREATESWHTRLSEVGARLLEQWALSLGQTGDHFASAFAE | |
| | | DAESFIKIVRYPEAESESVTQGVGEHRDAGTLTLLYPQPGTTG | |
| | | LQVLTDDGWIDADPIENTFVVNIGKLLEVATNGYLKATVHRV | |
| | | LPTGPGQDRISIPFFFNPALNARLPEVELPAEIAADARGVTQD | |
| | | ERDALHAVYGENAFLSRLRSHPNVAEKFYPELVGAQV | |
| Dioxygenase | Brevi- | MTLTQLPILDLSQADDPATAEQFRADLRRITHEIGFFYLKGHG | 81 |
| | bacterium | IPDADFARIIDVSQRFFELSDEDKLEIENSNSPHFRGYTRTGG | |
| | epidermidis | ERTQGIIDWREQIDLGPEREAVAEPAHDFENLIGPNQYPSAL | |
| | | PELREATEDWHSRLSEVGTRLLREWALSLGQPADHFDSAFA | |
| | | ENADSLMKIIHYPAPDTEVEDITQGVGEHRDPGTLTLLYPQP | |
| | | GTTGLQVQTDDGFIDAEPIENTFIVNIGRLLEVATNGYLKATV | |
| | | HRVLPTAPGEDRISVPFFFNPALDAHLPEVELPADLAAEARGV | |
| | | TEDEREILHTVYGKNIFDARLRSHPNVTEKFYPEFLSAQS | |
| Dioxygenase | C. | MGDVPGIRSGKTECHPIHTGLTAGLTVREPRPQGVTSMSTS | 82 |
| | variabile | NSPEPTQTPMIDSDPNGPFRYPVSDIRDQDEATPGIMPSQTV | |
| | | GPYVHIGLTWPGAENMVEEGTDGAVEVTFQVTDGAGHLIKD | |
| | | AMIEIWQAGSDGVYPSPLDPRAGEDAGREGFRGLGRGMCD | |
| | | SETGLVTFRTVRPGAVPAPDGGTEAPHLKVGVFARGMLERLY | |
| | | TRLYFPEQSEANDADPVLNAVPEERRDLLVASTVDGDADSYR | |
| | | MDIVMQHEDATRETPFFALEGPAFEGRLLDRPDEDVVDQGP | |
| | | AFDIRTLMTRRTVLGVGAAGVGAVALAACSDNSSSSAATTS | |
| | | ASSSASSSASVTDLPDAEIPDETAGPYPADGSNGPDVLEESG | |
| | | IVRADIRSSIGADDPVDGVPLEFSITVTDMANDDVPFENVAV | |
| | | YAWHCNAEGLYSMYSEGVEDETWLRGVQVADADGTVSFTS | |
| | | IVPACYTGRWPHIHFEVYPSVDDITDSENAIATSQIAIPEDVC | |
| | | NTVFALDAYEGSSENLSQVTLESDNVFGDDSGVSQLATMSG | |
| | | DVDSGYIASLTARVDTTTEPTGGAAPEGGPGEGGPGGEGGP | |
| | | GGEGGEPPAGEPPAGSPGAIASTN | |

Protein expression and purification: Proteins were expressed in pET28a vector in E. coli BL21 containing kanamycin resistance. Protein purification was performed via fast protein liquid chromatography (FPLC) using a HisTrap HP column with Binding buffer: 20 mM sodium phosphate, 0.5 M NaCl, 5 mM imidazole, pH 7.4 and Elution buffer: 20 mM sodium phosphate, 0.5 M NaCl, 0.5 M imidazole, pH 7.4, at a flow rate of 1 mL/min.

Enzyme activity assays: Enzyme assays were performed by taking an appropriate volume of enzyme solution and adding the solution atop plastic films every hour for a predetermined number of treatments. Activity was measured analytically via DSC, FTIR, or GPC.

### B. Results

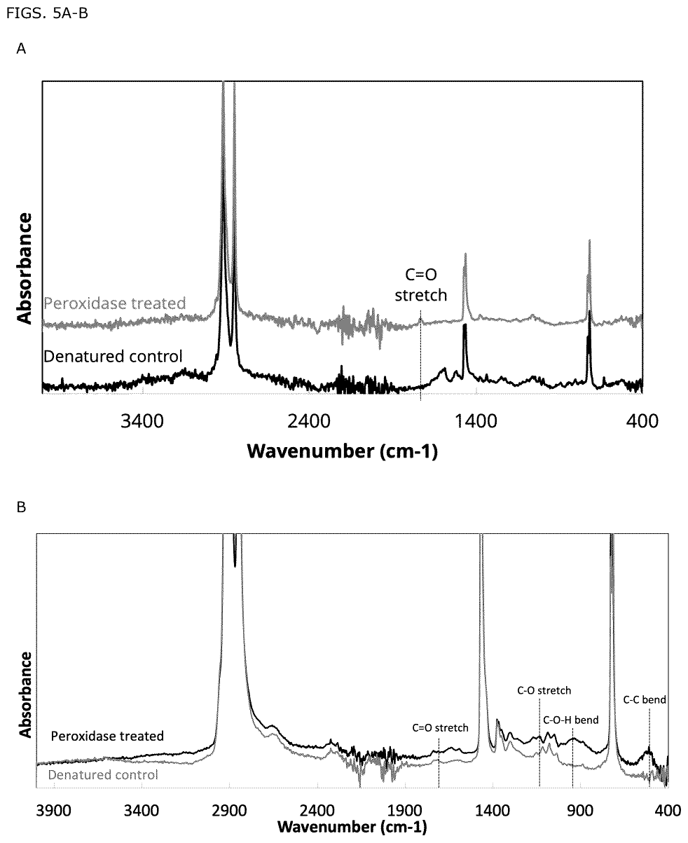

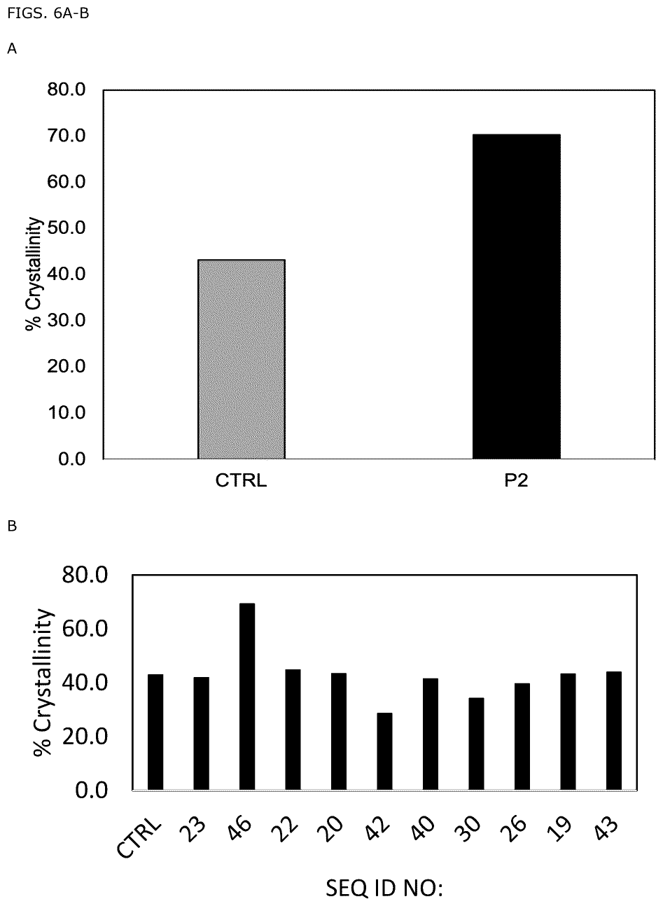

Novel Dyp-type peroxidase from Corynebacterium variabile (SEQ ID NO: 46) degraded the LDPE film by incorporation of C═O bonds and carboxylic acids (FIG. 5A-B). An increase in crystallinity was observed after treating an LDPE film with purified enzyme Dyp-type peroxidase (SEQ ID NO. 46) (FIGS. 6A-B), but not other tested enzymes (SEQ ID NOS: 23, 22, 20, 42, 40, 50, 26, 19 and 43) (FIG. 6B).

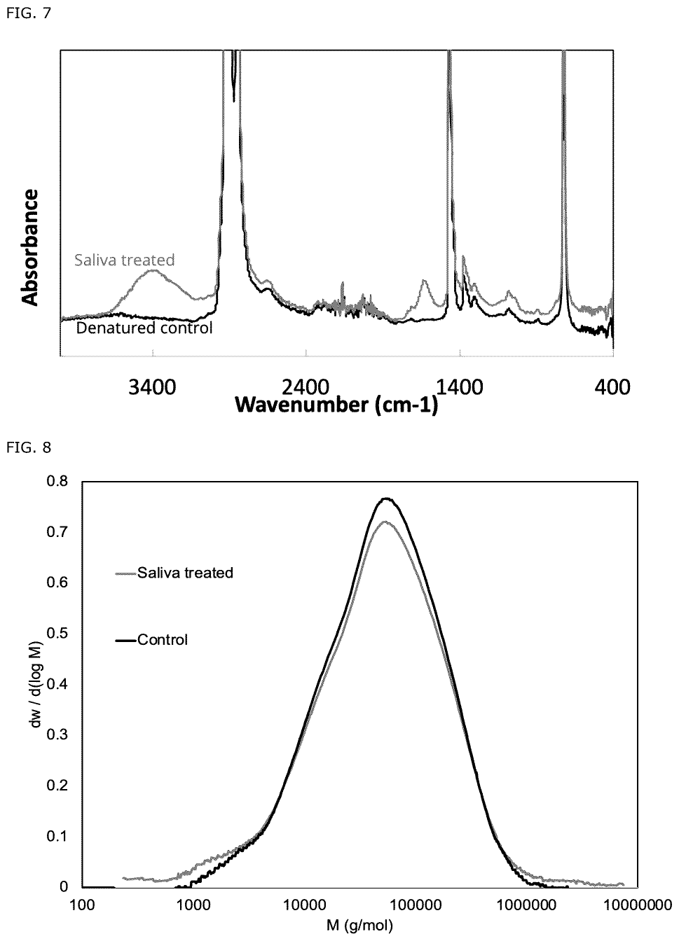

The saliva extracted from the yellow mealworm (Tenebrio molitor) degraded the LDPE film by incorporation of C═O and O-H bonds (FIG. 7). A decrease in molecular weight was observed (FIG. 8).

### C. Conclusion

Recombinant oxygenases, for example, monooxygenases (SEQ ID NOS: 3-13, 17, 19, 24-39, 43-45, 50-57, 65-73, 77 and 78) and dioxygenases (SEQ ID NOS: 1, 2, 14-16, 18, 20, 21, 40-42, 49, 58-64, 74-76, 80 and 81) or peroxidases (SEQ ID NOS: 22, 23, 46-48 and 79) from the mealworm gut or salivary microbiomes are capable of degrading plastic substrates (Tables 1). It is expected that enzymes sharing homology of at least 50%, 60%, 70%, 80%, 90%, 95% or 99% with the amino acid sequences of an oxygenase or peroxidase from the mealworm gut or salivary communities, for example SEQ ID N): 1-81 would fall within the classes of enzymes that can have activity on plastic substrates. After expressing an oxygenase or peroxidase from the mealworm or its salivary or gut microbiome in E. coli and purifying the oxygenase or peroxidase, plastic is expected to be degraded by direct application of the oxygenase or peroxidase to a plastic substrate over multiple 60-minute applications.

All documents, books, manuals, papers, patents, published patent applications, guides, abstracts, and/or other references cited herein are incorporated by reference in their entirety. Other embodiments of the invention will be apparent to those skilled in the art from consideration of the specification and practice of the invention disclosed herein. It is intended that the specification and examples be considered as exemplary only, with the true scope and spirit of the invention being indicated by the following claims.

1. A method for improving degradation of a plastic substrate, comprising treating darkling beetle larvae with a feed supplemented with oats, and exposing a plastic substrate to an effective amount of the darkling beetle larvae, whereby the plastic substrate is degraded by the darkling beetle larvae at a rate higher than that by darkling beetle larvae treated with the feed not supplemented with the oats.

2. The method of claim 1, wherein the darkling beetle larvae are mealworms.

3. The method of claim 2, wherein the mealworms have a gut comprising a microorganism selected from the group consisting of Staphylococcus, Peptoniphilus, Brevibacterium, Helcococcus, Mannheimia, Trueperella, Pseudomonas, Corynebacterium, Mangrovibacterm, Clostridia, Enterococcus, Allobaculum, Romboutsia, Turicibacter, Lactobacillus, Muribaculacear, Pediococcus, Staphylococcus and Pseudomonas.

4. The method of claim 2, wherein the mealworms have a gut comprising a microorganism selected from the group consisting of Kluyvera cryocresens, Staphylococcus lentus, Enterococcus termitis, Listeria fleischmannii, Mangrovibacter yixingensis, Corynebacterium variabile, Enterococcus faecalis, Brachybacterium nesterenkovii, Brevibacterium epidermidis, Lactococcus garvieae, Kocuria halotolerans, Staphylococcus gallinarum, Intestinirhabdus alba, Enterococcus sp. Enterococcaceae, and Enterococcus faecium.

5. The method of claim 1, wherein the plastic substrate is selected from the group consisting of polystyrene (PS), polyethylene (PE), polypropylene (PP) and a combination thereof.

6. The method of claim 1, wherein the darkling beetle larvae are mealworms and the plastic substrate is PS.

7. The method of claim 6, wherein the PS is degraded at 60-80 mg per 100 mealworms per day.

8. The method of claim 6, wherein the mealworms have a gut comprising a microorganism selected from the group consisting of Staphylococcus, Peptoniphilus, Brevibacterium, Helcococcus, Mannheimia, Trueperella, Pseudomonas, Corynebacterium, and Mangrovibacter.

9. The method of claim 1, wherein the darkling beetle larvae are mealworms and the plastic substrate is PE.

10. The method of claim 9, wherein the PE is degraded at 5-25 mg per 100 mealworms per day.

11. The method of claim 9, wherein the mealworms have a gut comprising a microorganism selected from the group consisting of Clostridia, Enterococcus, Allobaculum, Romboutsia, Turicibacter, Lactobacillus, Muribaculacear, Pediococcus, Staphylococcus and Pseudomonas.

12. The method of claim 1, further comprising forming a C═O group, a C—OH group or a O═C—OH group on the plastic substrate.

13. The method of claim 12, wherein the plastic substrate is PE, and the mealworms have a gut comprising a microorganism selected from the group consisting of Staphylococcus lentus, Corynebacterium variable and Kocuria halorolerans.

14. The method of claim 1, further comprising modifying a surface of the plastic substrate.

15. The method of claim 14, wherein the plastic substrate is PE, and the microorganism is selected from the group consisting of Stapyhloccus lentus, Corynebacterium variabile and Kocuria halotolerans.

16. A method for degrading a plastic substrate, comprising exposing a plastic substrate to an effective amount of an isolated microorganism, whereby the plastic substrate is degraded.

17. The method of claim 16, wherein the microorganism is isolated from mealworms treated with a feed supplemented with oats.

18. The method of claim 17, wherein the feed is supplemented with oats at 0.1-10 g per 100 mealworms every 1-10 days.

19. The method of claim 16, wherein the microorganism is selected from the group consisting of Staphylococcus, Peptoniphilus, Brevibacterium, Helcococcus, Mannheimia, Trueperella, Pseudomonas, Corynebacterium, Mangrovibacterm Clostridia, Enterococcus, Allobaculum, Romboutsia, Turicibacter, Lactobacillus, Muribaculacear, Pediococcus, Staphylococcus and Pseudomonas.

20-27. (canceled)

28. A method for degradation of a plastic substrate, comprising treating a plastic substrate with an effective amount of a peroxidase consisting of an amino acid sequence having at least 90% identity to the amino acid sequence of SEQ ID NO: 46, whereby the plastic substrate is degraded.

29-34. (canceled)
